(19) United States
(12) Patent Application Publication
(10) Pub. No.: US 2026/0357058 A1
(43) Pub. Date: Nov. 12, 2026

(54) CURABLE RESIN COMPOSITION AND USE THEREFOR

(71) Applicant: KANEKA CORPORATION, Osaka (JP)

(72) Inventor: Toshihiko Okamoto, Hyogo (JP)

(73) Assignee: KANEKA CORPORATION, Osaka (JP)

(21) Appl. No.: 19/710,998

(22) Filed: Jun. 17, 2026

Related U.S. Application Data
(63) Continuation of application No. PCT/JP2024/045147, filed on Dec. 20, 2024.

(30) Foreign Application Priority Data
Dec. 20, 2023 (JP) 2023-215237
Mar. 26, 2024 (JP) 2024-050342
Mar. 28, 2024 (JP) 2024-054979
May 31, 2024 (JP) 2024-089248

(51) Int. Cl. C08L 63/00; C08G 59/22; C08G 59/24; C08G 59/32; C08G 59/36; C08G 59/42; C08G 59/50; C08K 5/19; C08K 5/3445; C08K 7/06; C08L 9/10

(52) U.S. Cl. CPC C08L 63/00; C08G 59/223; C08G 59/245; C08G 59/3218; C08G 59/3227; C08G 59/36; C08G 59/4215; C08G 59/4223; C08G 59/502; C08G 59/5026; C08G 59/5033; C08G 59/506; C08G 59/5073; C08K 5/19; C08K 5/3445; C08K 7/06; C08L 9/10; C08L 2205/05; C08L 2205/22; C08L 2207/53

(57) ABSTRACT

A curable resin composition capable of providing a cured product with excellent toughness is provided. The curable resin composition contains component (A), a specific epoxy group-containing substance, component (B), polymer particles having a specific structure, and component (C), a specific epoxy curing agent, each in a specific amount, and not containing or containing component (D), a curing accelerator, in a specific amount, with values X or Y within a specific range.

### TECHNICAL FIELD

One or more embodiments of the present invention relate to a curable resin composition and a use thereof.

### BACKGROUND

Curable resin compositions containing epoxy resins are used, for example, in the fields of fiber-reinforced composite material and fiber-reinforced molded product, as described in Patent Literatures 1 to 7.

### PATENT LITERATURE

Patent Literature 1: Japanese Patent Application Publication, Tokukai, No. 2018-35210
Patent Literature 2: Japanese Patent Application Publication (Translation of PCT Application), Tokuhyo, No. 2023-502717
Patent Literature 3: Japanese Patent Application Publication, Tokukai, No. 2023-139383
Patent Literature 4: Japanese Patent Application Publication, Tokukai, No. 2021-116404
Patent Literature 5: Japanese Patent Application Publication, Tokukai, No. 2023-146870
Patent Literature 6: International Publication No. WO 2023/089997
Patent Literature 7: Japanese Patent Application Publication, Tokukaihei, No. 8-183836

However, the conventional technology as described above is not sufficient in terms of toughness of the cured product, and there is room for further improvement.

### SUMMARY

One or more embodiments of the present invention have been made in view of the above, and to provide a novel curable resin composition that can provide a cured product with excellent toughness.

As a result of conducting diligent study in order to attain the above, the present inventors have completed one or more embodiments of the present invention.

That is, the curable resin composition according to one or more embodiments of the present invention is a curable resin composition containing the following component (A) and component (B), and not containing the following component (D) or further containing the following component (D):
component (A): an epoxy group-containing substance containing at least one type selected from the group consisting of a bisphenol A epoxy resin, a bisphenol F epoxy resin, and an alicyclic epoxy resin;
component (B): polymer particles having a core-shell structure that includes a core layer and a shell layer;
component (D): a curing accelerator,
wherein the curable resin composition satisfies at least one of the following (1) to (3):
(1)
the curable resin composition further contains the following component (C):
   component (C): an acid anhydride (c1), an aromatic amine (c2), or an alicyclic amine (c3),
in 100 parts by mass of the component (A), a total contained amount of the bisphenol A epoxy resin, the bisphenol F epoxy resin, and the alicyclic epoxy resin is 60 parts by mass to 100 parts by mass,
a contained amount of the component (B) is 1 part by mass to 100 parts by mass with respect to 100 parts by mass of the component (A),
a contained amount of the component (C) is 5 parts by mass to 200 parts by mass with respect to 100 parts by mass of the component (A),
when the curable resin composition contains the component (D), a contained amount of the component (D) is 0.1 parts by mass to 10.0 parts by mass with respect to 100 parts by mass of the component (A), and
a value X calculated by the following formula is
   1.05 to 5.50 when the component (C) is the acid anhydride (c1), and
   1.30 to 9.00 when the component (C) is the aromatic amine (c2) or the alicyclic amine (c3):

X={[273+Tmin(M)]/[273+Tmin(Meq)]}×[E′(Meq)]/[E′(M)]; formula:
(2)
the curable resin composition further contains the following component (C):
   component (C): an epoxy curing agent containing at least one type selected from the group consisting of an acid anhydride (c1), an aromatic amine (c2), and an alicyclic amine (c3),
in 100 parts by mass of the component (A), a total contained amount of the bisphenol A epoxy resin, the bisphenol F epoxy resin, and the alicyclic epoxy resin is 5 parts by mass to 100 parts by mass,
a contained amount of the component (B) is 1 part by mass to 100 parts by mass with respect to 100 parts by mass of the component (A),
a contained amount of the component (C) is 10 parts by mass to 200 parts by mass with respect to 100 parts by mass of the component (A),
when the curable resin composition contains the component (D), a contained amount of the component (D) is 0.1 parts by mass to 10.0 parts by mass with respect to 100 parts by mass of the component (A),
the component (A) satisfies any of the following (i), (ii), or (iii):
   (i) the component (A) contains a polyfunctional epoxy group-containing substance (a1) having an epoxy equivalent weight of 300 g/eq or more and less than 3000 g/eq, and having two or more epoxy groups per molecule, and a contained amount of the polyfunctional epoxy group-containing substance (a1) in 100 parts by mass of the component (A) is 5 parts by mass to 100 parts by mass;
   (ii) the component (A) contains a monofunctional epoxy group-containing substance (a2) having one epoxy group per molecule, and a contained amount of the monofunctional epoxy group-containing substance (a2) in 100 parts by mass of the component (A) is 5 parts by mass to 95 parts by mass;
   (iii) the component (A) contains the polyfunctional epoxy group-containing substance (a1) and the monofunctional epoxy group-containing substance (a2), and a contained amount of the polyfunctional epoxy group-containing substance (a1) in 100 parts by mass of the component (A) is 5 parts by mass to 95 parts by mass, and a contained amount of the monofunctional epoxy group-containing substance (a2) in 100 parts by mass of the component (A) is 5 parts by mass to 95 parts by mass, and
a value Y calculated by the following formula is 22 to 400:

Y=[273+Tmin(M)]/[E′(M)]; formula:
(3)
the curable resin composition further contains the following component (C):
   component (C): an amine-based epoxy curing agent containing an amine (c4) with 1 or 2 active hydrogen atoms in an amino group per molecule;
in 100 parts by mass of the component (A), a total contained amount of the bisphenol A epoxy resin, the bisphenol F epoxy resin, and the alicyclic epoxy resin is 5 parts by mass to 100 parts by mass,
a contained amount of the component (B) is 1 part by mass to 100 parts by mass with respect to 100 parts by mass of the component (A),
a contained amount of the component (C) is 10 parts by mass to 200 parts by mass with respect to 100 parts by mass of the component (A),
when the curable resin composition contains the component (D), a contained amount of the component (D) is 0.1 parts by mass to 20.0 parts by mass with respect to 100 parts by mass of the component (A),
a contained amount of the amine (c4) in the component (C) is 5% by mass to 100% by mass in 100% by mass of the component (C), and
a value Y calculated by the following formula is 22 to 400:

Y=[273+Tmin(M)]/[E′(M)], formula:
wherein
   in the formulas for the value X and the value Y,
      a temperature at which a loss tangent is maximized, as determined by dynamic viscoelastic measurement under tensile mode and at a frequency of 1 Hz using a cured product (M) of a composition (M) as a sample, is defined as Ttg(M) (°C), and the E′(M) represents a minimum value of a storage modulus (E′) in a temperature range of [Ttg(M) (°C)] to [Ttg(M)+25 (°C)] of the cured product (M), and the Tmin(M) (°C) is a temperature (°C) at which a value of the E′(M) is obtained,
      the composition (M) contains the component (A), the component (C), and the component (D), which are the same as the component (A), the component (C), and the component (D) contained in the curable resin composition,
      respective contained amounts of the component (A), the component (C), and the component (D) in the composition (M) are the same as respective contained amounts of the component (A), the component (C), and the component (D) in the curable resin composition,
      the cured product (M) is a cured product obtained by curing the composition (M) and showing a cure degree of 98% or more as measured by DSC measurement,
   in the formula for the value X,
      a temperature at which a loss tangent is maximized, as determined by dynamic viscoelastic measurement under tensile mode and at a frequency of 1 Hz using a cured product (Meq) of a composition (Meq) as a sample, is defined as Ttg(Meq) (°C), and the E′(Meq) represents a minimum value of a storage modulus (E′) in a temperature range of [Ttg(Meq) (°C)] to [Ttg(Meq)+25 (°C)] of the cured product (Meq), and the Tmin(Meq) (°C) is a temperature (°C) at which a value of the E′(Meq) is obtained,
      the composition (Meq) contains the component (A), the component (C), and the component (D), which are the same as the component (A), the component (C), and the component (D) contained in the curable resin composition,
      respective contained amounts of the component (A) and the component (D) in the composition (Meq) are the same as respective contained amounts of the component (A) and the component (D) in the curable resin composition,
      when the component (C) in the composition (Meq) is the acid anhydride (c1), a contained amount of the component (C) in the composition (Meq) is such that a ratio of a molar mass of an acid anhydride group in the component (C) to a molar mass of an epoxy group in the component (A) contained in the composition (Meq) (molar mass of acid anhydride group in the component (C)/molar mass of the epoxy group in the component (A)) is 1,
      when the component (C) in the composition (Meq) is the aromatic amine (c2) or the alicyclic amine (c3), a contained amount of the component (C) in the composition (Meq) is such that a ratio of a molar mass of active hydrogen atom of an amine in the component (C) to a molar mass of an epoxy group in the component (A) contained in the composition (Meq) (molar mass of active hydrogen atom of the amine in the component (C)/molar mass of the epoxy group in the component (A)) is 1, and
      the cured product (Meq) is a cured product obtained by curing the composition (Meq) and showing a cure degree of 98% or more as measured by DSC measurement.

According to one or more embodiments of the present invention, it is possible to provide a novel curable resin composition that can yield a cured product with excellent toughness.

### DETAILED DESCRIPTION

Hereinafter, one or more embodiments of the present invention will be described, however, the present invention is not limited thereto. The present invention is not limited to the configurations described below and various modifications can be made within the scope indicated in the claims. Furthermore, embodiments or examples obtained by combining the technical means disclosed in different embodiments or examples are also included in the technical scope of one or more embodiments of the present invention. Moreover, by combining the technical means disclosed in each embodiment, it is possible to form new technical features. All academic and patent literatures cited in the present description are incorporated herein by reference. Unless otherwise specified in the present description, the expression “A to B” representing a numerical range intends “A or more (including A and more than A) and B or less (including B and less than B)”.

In the present description, the “curable resin composition” may be referred to as “composition”, and the “curable resin composition according to one or more embodiments of the present invention” may also be referred to as the “present composition”.

In the present description, “X unit” contained in a polymer, copolymer, or resin refers to “structural unit derived from X monomer”. For example, “butadiene unit” refers to “structural unit derived from butadiene monomer”.

### 1. Curable Resin Composition

The curable resin composition according to one or more embodiments of the present invention contains the following component (A) and component (B), and does not contain the following component (D) or further contains the following component (D).
component (A): an epoxy group-containing substance containing at least one type selected from the group consisting of a bisphenol A epoxy resin, a bisphenol F epoxy resin, and an alicyclic epoxy resin;
component (B): polymer particles having a core-shell structure that includes a core layer and a shell layer;
component (D): a curing accelerator.

The curable resin composition according to one or more embodiments of the present invention satisfies at least one of the following (1) to (3).
(1)
The curable resin composition further contains the following component (C):
   component (C): an acid anhydride (c1), an aromatic amine (c2), or an alicyclic amine (c3),
in 100 parts by mass of the component (A), a total contained amount of the bisphenol A epoxy resin, the bisphenol F epoxy resin, and the alicyclic epoxy resin is 60 parts by mass to 100 parts by mass,
a contained amount of the component (B) is 1 part by mass to 100 parts by mass with respect to 100 parts by mass of the component (A),
a contained amount of the component (C) is 5 parts by mass to 200 parts by mass with respect to 100 parts by mass of the component (A),
when the curable resin composition contains the component (D), a contained amount of the component (D) is 0.1 parts by mass to 10.0 parts by mass with respect to 100 parts by mass of the component (A), and
a value X calculated by the following formula is
   1.05 to 5.50 when the component (C) is the acid anhydride (c1), and
   1.30 to 9.00 when the component (C) is the aromatic amine (c2) or the alicyclic amine (c3):

X={[273+Tmin(M)]/[273+Tmin(Meq)]}×[E′(Meq)]/[E′(M)]. formula:
(2)
The curable resin composition further contains the following component (C):
   component (C): an epoxy curing agent containing at least one type selected from the group consisting of an acid anhydride (c1), an aromatic amine (c2), and an alicyclic amine (c3),
in 100 parts by mass of the component (A), a total contained amount of the bisphenol A epoxy resin, the bisphenol F epoxy resin, and the alicyclic epoxy resin is 5 parts by mass to 100 parts by mass,
a contained amount of the component (B) is 1 part by mass to 100 parts by mass with respect to 100 parts by mass of the component (A),
a contained amount of the component (C) is 10 parts by mass to 200 parts by mass with respect to 100 parts by mass of the component (A),
when the curable resin composition contains the component (D), a contained amount of the component (D) is 0.1 parts by mass to 10.0 parts by mass with respect to 100 parts by mass of the component (A),
the component (A) satisfies any of the following (i), (ii), or (iii):
   (i) the component (A) contains a polyfunctional epoxy group-containing substance (a1) having an epoxy equivalent weight of 300 g/eq or more and less than 3000 g/eq, and having two or more epoxy groups per molecule, and a contained amount of the polyfunctional epoxy group-containing substance (a1) in 100 parts by mass of the component (A) is 5 parts by mass to 100 parts by mass;
   (ii) the component (A) contains a monofunctional epoxy group-containing substance (a2) having one epoxy group per molecule, and a contained amount of the monofunctional epoxy group-containing substance (a2) in 100 parts by mass of the component (A) is 5 parts by mass to 95 parts by mass;
   (iii) the component (A) contains the polyfunctional epoxy group-containing substance (a1) and the monofunctional epoxy group-containing substance (a2), and a contained amount of the polyfunctional epoxy group-containing substance (a1) in 100 parts by mass of the component (A) is 5 parts by mass to 95 parts by mass, and a contained amount of the monofunctional epoxy group-containing substance (a2) in 100 parts by mass of the component (A) is 5 parts by mass to 95 parts by mass, and
a value Y calculated by the following formula is 22 to 400:

Y=[273+Tmin(M)]/[E′(M)]. formula:
(3)
The curable resin composition further contains the following component (C):
   component (C): an amine-based epoxy curing agent containing an amine (c4) with 1 or 2 active hydrogen atoms in an amino group per molecule;
in 100 parts by mass of the component (A), a total contained amount of the bisphenol A epoxy resin, the bisphenol F epoxy resin, and the alicyclic epoxy resin is 5 parts by mass to 100 parts by mass,
a contained amount of the component (B) is 1 part by mass to 100 parts by mass with respect to 100 parts by mass of the component (A),
a contained amount of the component (C) is 10 parts by mass to 200 parts by mass with respect to 100 parts by mass of the component (A),
when the curable resin composition contains the component (D), a contained amount of the component (D) is 0.1 parts by mass to 20.0 parts by mass with respect to 100 parts by mass of the component (A),
a contained amount of the amine (c4) in the component (C) is 5% by mass to 100% by mass in 100% by mass of the component (C), and
a value Y calculated by the following formula is 22 to 400:

Y=[273+Tmin(M)]/[E′(M)]. formula:

The cured product obtained by curing the composition (M) is referred to as “cured product (M)”. The cured product (M) can also be referred to as a “cured product (M) of the composition (M)”. Dynamic viscoelastic measurement is performed under tensile mode and at a frequency of 1 Hz using the cured product (M) as a sample. Such dynamic viscoelastic measurement yields the loss tangent and the storage modulus. The temperature at which the loss tangent of the cured product (M) is maximized is defined as Ttg(M) (°C). In the above formula, E′(M) represents the minimum value of the storage modulus (E′) in the temperature range of [Ttg(M) (°C)] to [Ttg(M)+25 (°C)] of the cured product (M), and Tmin(M) (°C) is the temperature (°C) at which the value of E′(M) is obtained.

The composition (M) contains the component (A), the component (C), and the component (D), which are the same as (identical to) the component (A), the component (C), and the component (D) contained in the present composition. Respective contained amounts of the component (A), the component (C), and the component (D) in the composition (M) are the same as respective contained amounts of the component (A), the component (C), and the component (D) in the present composition. The composition (M) does not contain the component (B).

In other words, when calculating value X for a certain curable resin composition containing the component (A), the component (B), the component (C), and the component (D), the composition (M) used for calculating value X (i) contains the same component (A), component (C), and component (D) as the component (A), the component (C), and the component (D) contained in the curable resin composition, and (ii) does not contain the component (B) contained in the curable resin composition, and (iii) respective contained amounts of the component (A), the component (C), and the component (D) in the composition (M) are the same as respective contained amounts of the component (A), the component (C), and the component (D) in the curable resin composition. When calculating value X for a curable resin composition that does not contain the component (D), the composition (M) used for calculating value X does not contain the component (D).

Also, when calculating value Y for a certain curable resin composition containing the component (A), the component (B), the component (C), and the component (D), the composition (M) used for calculating value Y (i) contains the same component (A), component (C), and component (D) as the component (A), the component (C), and the component (D) contained in the curable resin composition, and (ii) does not contain the component (B) contained in the curable resin composition, and (iii) respective contained amounts of the component (A), the component (C), and the component (D) in the composition (M) are the same as respective contained amounts of the component (A), the component (C), and the component (D) in the curable resin composition. When calculating value Y for a curable resin composition that does not contain the component (D), the composition (M) used for calculating value Y does not contain the component (D).

The cured product obtained by curing the composition (Meq) is referred to as “cured product (Meq)”. The cured product (Meq) can also be referred to as a “cured product (Meq) of the composition (Meq)”. Dynamic viscoelastic measurement is performed under tensile mode and at a frequency of 1 Hz using the cured product (Meq) as a sample. Such dynamic viscoelastic measurement yields the loss tangent and the storage modulus. The temperature at which the loss tangent of the cured product (Meq) is maximized is defined as Ttg(Meq) (°C). In the above formula, E′(Meq) represents the minimum value of the storage modulus (E′) in the temperature range of [Ttg(Meq) (°C)] to [Ttg(Meq)+25 (°C)] of the cured product (Meq), and Tmin(Meq) (°C) is the temperature (°C) at which the value of E′(Meq) is obtained.

The composition (Meq) contains the component (A), the component (C), and the component (D), which are the same as (identical to) the component (A), the component (C), and the component (D) contained in the present composition. The composition (Meq) does not contain the component (B). Respective contained amounts of the component (A) and the component (D) in the composition (Meq) are the same as respective contained amounts of the component (A) and the component (D) in the present composition. When the component (C) in the composition (Meq) is the acid anhydride (c1), a contained amount of the component (C) in the composition (Meq) is such that a ratio of a molar mass of an acid anhydride group in the component (C) to a molar mass of an epoxy group in the component (A) contained in the composition (Meq) (molar mass of acid anhydride group in component (C)/molar mass of the epoxy group in component (A)) is 1. When the component (C) in the composition (Meq) is the aromatic amine (c2) or the alicyclic amine (c3), a contained amount of the component (C) in the composition (Meq) is such that a ratio of a molar mass of active hydrogen atom of an amine in the component (C) to a molar mass of an epoxy group in the component (A) contained in the composition (Meq) (molar mass of active hydrogen atom of amine in component (C)/molar mass of epoxy group in component (A)) is 1. The contained amount of the component (D) in the composition (Meq) are the same as the contained amount of the component (D) in the present composition. In other words, when calculating value X for a certain curable resin composition containing the component (A), the component (B), the component (C), and the component (D), the composition (Meq) used for calculating value X (i) contains the same component (A), component (C), and component (D) as the component (A), the component (C), and the component (D) contained in the curable resin composition, (ii) does not contain the component (B) contained in the curable resin composition, and (iii) respective contained amounts of the component (A) and the component (D) in the composition (Meq) are the same as respective contained amounts of the component (A) and the component (D) in the curable resin composition. When calculating value X for a curable resin composition that does not contain the component (D), the composition (Meq) used for calculating value X does not contain the component (D).

The present composition has the advantage of being able to provide a cured product with excellent toughness due to the above configuration. In the present description, the toughness of a cured product can be evaluated by the fracture toughness valued

$$“ K 1 c ( MPa \cdot {m}^{1 / 2} ) ”$$

and “G1c (Kj/m²)”. A higher fracture toughness value of the cured product indicates that the cured product has superior toughness.

In the present description, the “cured product” refers to a cured product obtained by curing a curable resin composition and having a cure degree of 98% or more as measured by DSC. The same applies to the cured product (M) and cured product (Meq) used to calculate the values X and Y. The same applies to the cured product for measuring the fracture toughness values

$${}^{‶} K 1 c {( MPa \cdot {m}^{1 / 2} )}^{″}$$

and “G1c (Kj/m²)”. For example, the “cured product (M)” is intended to mean a cured product obtained by curing the composition (M) and showing a cure degree of 98% or more as measured by DSC. For example, the “cured product (Meq)” is intended to mean a cured product obtained by curing the composition (Meq) and showing a cure degree of 98% or more as measured by DSC.

The values X and Y may be influenced by the cure degree of the cured product (M) and cured product (Meq) as measured by DSC. In the present description, the values X and Y are calculated using the cured product (M) and cured product (Meq) with a cure degree of 98% or more as measured by DSC. The cure degree of the cured product as measured by DSC may be influenced by the curing temperature and curing time of the composition (M). In calculating the values X and Y, the cured product (M) and cured product (Meq) with a cure degree of 98% or more as measured by DSC can be obtained by curing the composition (M) and composition (Meq) under the following curing conditions:
when the component (C) is the acid anhydride (c1), for example, the curing temperature is 175 °C and the curing time is 2 hours;
when the component (C) is the aromatic amine (c2), the curing temperature is 175 °C and the curing time is 2 hours;
when the component (C) is the alicyclic amine (c3), the curing temperature is 120 °C and the curing time is 2 hours;
when the component (C) is an amine (c4) with 1 or 2 active hydrogen atoms in an amino group per molecule, for example, the curing temperature is 120 °C and the curing time is 2 hours.

The cure degree of the cured product is the cure reaction rate calculated from the total heat generation of the uncured curable resin composition measured using DSC (Differential Scanning Calorimetry) and the residual heat generation of the cured product obtained by curing the curable resin composition. The specific measurement method for the cure degree of the cured product will be described in detail in Examples below.

[1-1. Curable Resin Composition that Satisfies at Least (1)]

Hereinafter, this section will describe a curable resin composition that satisfies at least the (1).

<1-1-1. Technical Idea Regarding Curable Resin Composition that Satisfies at Least (1)>

Conventional curable resin compositions have had room for further improvement in terms of toughness. Thus, the present inventors have conducted diligent research with the aim of providing a novel curable resin composition that can provide a cured product with excellent toughness.

In a curable resin composition containing an epoxy group-containing substance (for example, epoxy resin), when the molar mass of a curing agent is equal to the molar mass of an epoxy group in the epoxy group-containing substance, the crosslinking density of the cured product becomes the highest. For example, in a curable resin composition containing an epoxy group-containing substance and an acid anhydride as a curing agent, when the ratio of the molar mass of an acid anhydride group in the acid anhydride to the molar mass of an epoxy group in the epoxy group-containing substance is 1, the crosslinking density of the cured product becomes the highest. For example, in a curable resin composition containing an epoxy group-containing substance and an aromatic amine or alicyclic amine as a curing agent, when the ratio of the molar mass of active hydrogen atom of an amine in the aromatic amine or alicyclic amine to the molar mass of an epoxy group in the epoxy group-containing substance is 1, the crosslinking density of the cured product becomes the highest. The higher the crosslinking density of the cured product, the smaller the molecular weight between crosslinking points of the cured product. Therefore, it can be said that when the crosslinking density of the cured product is the highest, the molecular weight between crosslinking points of the cured product is the smallest.

As a result of diligent research, the present inventors have independently obtained a novel finding that by setting the molecular weight between crosslinking points of the cured product within a specific range and using polymer particles, the toughness of the cured product is remarkably improved.

Here, for example, a curable resin composition (a) containing an epoxy group-containing substance (component (A)), polymer particles (component (B)), a curing agent (component (C)), and a curing accelerator (component (D)) will be taken as an example to explain “setting the molecular weight between crosslinking points of the cured product within a specific range”. First, a composition (a) containing the same component (A), component (C), and component (D) as those in the curable resin composition (a), in the same amounts as those in the curable resin composition (a) is prepared (that is, the composition (a) does not contain the component (B)). Next, a composition (αeq) containing the same component (A), component (C), and component (D) as those in the curable resin composition (a) is prepared (that is, the composition (αeq) does not contain the component (B)). In the composition (αeq), the amounts of the component (A) and component (D) are the same as those in the curable resin composition (a). In the composition (αeq), the amount of the component (C) is such that the molar mass of a functional group in the component (C) which reacts with an epoxy group in the component (A) (for example, when the component (C) is an acid anhydride, the functional group is an acid anhydride group, and when the component (C) is an aromatic amine or alicyclic amine, the functional group is an active hydrogen atom of an amine) is equal to the molar mass of the epoxy group in the component (A). The ratio of the molecular weight between crosslinking points of the cured product (a) obtained by curing the composition (a) to the molecular weight between crosslinking points of the cured product (αeq) obtained by curing the composition (αeq) (molecular weight between crosslinking points of cured product (a)/molecular weight between crosslinking points of cured product (αeq)) is set within a specific range, which is referred to as “setting the molecular weight between crosslinking points of the cured product within a specific range”.

The molecular weight between crosslinking points of the cured product can be determined from the theory of rubber elasticity of crosslinked rubber, for example, by the following formula:

Molecular weight between crosslinking points=2×(1+μ)×ρ×R×T/E=ρ×R×T/G

In the formula, μ represents the Poisson's ratio of the cured product, ρ represents the specific gravity of the cured product, R represents the gas constant, T represents the absolute temperature (K), and E and G represent the Young's modulus and shear modulus of the cured product in the rubbery region. The rubbery region refers to the region observed on the high-temperature side of the transition region near the glass transition temperature when measuring the temperature dependence of elasticity (such as Young's modulus and shear modulus), representing a region where the temperature dependence of elasticity is flat. Crosslinked polymers of epoxy resin cured products and the like do not have a flow region on the high-temperature side of the rubbery region, so that E and G in the formula can be expressed as the minimum values of Young's modulus and shear modulus in the rubbery region. Furthermore, since the Young's modulus in the rubbery region is generally equal to the storage modulus obtained by the convenient dynamic viscoelastic measurement, the molecular weight between crosslinking points can be determined by the following formula:

Molecular weight between crosslinking points=2×(1+μ)×ρ×R×(273+Tmin)/E′min

In the formula, μ represents the Poisson's ratio of the cured product, ρ represents the specific gravity of the cured product, R represents the gas constant, E′min represents the minimum value of the storage modulus of the cured product, and Tmin represents the temperature (°C) at which the storage modulus of the cured product reaches its minimum value.

Therefore, the ratio of the molecular weight between crosslinking points of the cured product (α) obtained by curing the composition (α) to the molecular weight between crosslinking points of the cured product (αeq) obtained by curing the composition (αeq) (molecular weight between crosslinking points of cured product (α)/molecular weight between crosslinking points of cured product (αeq)) can be expressed by the following

Ratio={2×[1+μ(cured product(α))]×ρ(cured product(α))×R×[273+Tmin(cured product(α))]/E′min(cured product(α))}/{2×[1+μ(cured product(αeq))]×ρ(cured product(αeq))×R×[273+Tmin(cured product(αeq))]/E′min(cured product (αeq))}. formula:

Here, the difference between the cured product (α) and the cured product (αeq) is only the contained amount of the component (C). The difference in the contained amount of the component (C) does not significantly affect the Poisson's ratio (μ) and specific gravity (ρ) of the cured product. Therefore, in the above formula, μ (cured product (α)) and p(cured product (αeq)) can be considered to have the same value, and ρ(cured product (α)) and ρ (cured product (αeq)) can also be considered to have the same value. As a result, the ratio of the molecular weight between crosslinking points of the cured product (α) to the molecular weight between crosslinking points of the cured product (αeq) (molecular weight between crosslinking points of cured product (α)/molecular weight between crosslinking points of cured product (αeq)) can be expressed by the following formula:

Ratio={[273+Tmin(cured product(α))]/E′min(cured product(α))}/{[273+Tmin(cured product(αeq))]/E′min(cured product(αeq))}={[273+Tmin(cured product(α))]/[273+Tmin(cured product(αeq))]}×E′min(cured product(αeq))/E′min(cured product(α))

In the present description, the above-mentioned ratio is referred to as “X”. That is, as a result of diligent research, the present inventors have independently obtained a novel finding that by setting X to a value within a predetermined range and using polymer particles, the toughness of the cured product is remarkably improved, leading to the completion of one or more embodiments of the present invention.

The evaluation of the molecular weight between crosslinking points needs to be based on the measurement values of the cured product obtained by curing a composition containing only the component (A), the component (C), and the component (D). This is because the component (A) and the component (C) form a crosslinking structure, and the component (D) can influence the degree of progress of the crosslinking reaction. Conversely, when evaluating the molecular weight between crosslinking points, the component (B) and any components other than the components (A) to (D) (for example, inorganic fillers) cannot be added. These components do not participate in crosslinking formation, yet they affect the Emin or the like of the cured product obtained by curing the composition, making it impossible to accurately evaluate the molecular weight between crosslinking points. It should be noted that the component (D) is a component that is not incorporated into the crosslinking structure, but its amount is small compared to the total amount of the component (A) and the component (C) because it is a curing accelerator, and the influence of the unreacted residual component (D) on the molecular weight between crosslinking points after curing is considered to be small.

Conventionally, mechanical properties such as toughness have been attempted to be controlled by the type of the component (A) in the curable resin composition, as well as the type and amount of other additives. However, the present inventors have focused for the first time on the molecular weight between crosslinking points of the cured product, which has not been previously emphasized, and set the molecular weight between crosslinking points to a value within a predetermined range and using polymer particles, leading to the completion of one or more embodiments of the present invention. It is known that by dispersing polymer particles (B) in the component (A) (for example, epoxy resin), large-scale plastic deformation of the epoxy resin is induced, consuming energy and improving toughness. By setting the molecular weight between crosslinking points to a value within a predetermined range in the presence of polymer particles (B), it is presumed that the cured product becomes easier to undergo plastic deformation, significantly improving toughness. That is, the technical idea of setting the molecular weight between crosslinking points to a value within a predetermined range can be said to be a technical idea that could not be conceived from the conventional technology at all.

### <1-1-2. Component (A)>

Component (A) is an epoxy group-containing substance. In the present description, the “epoxy group-containing substance” refers to a substance that has one or more epoxy groups per molecule.

The epoxy group-containing substance that is the component (A) contains at least one type selected from the group consisting of a bisphenol A epoxy resin, a bisphenol F epoxy resin, and an alicyclic epoxy resin. According to this configuration, the composition has relatively low viscosity and excellent processability, and the cured product obtained by curing the composition has advantages of high strength, elastic modulus, and heat resistance (high Tg).

In the present description, “epoxy group-containing substance having two or more epoxy groups per molecule” may be referred to as “polyfunctional epoxy group-containing substance”, and “epoxy group-containing substance having X epoxy groups per molecule” may be referred to as “X-functional epoxy group-containing substance”.

In the component (A), the bisphenol A epoxy resin and the bisphenol F epoxy resin may be each independently a polyfunctional epoxy group-containing substance, or a difunctional epoxy group-containing substance. According to this configuration, there is an advantage of a high toughness improvement effect due to the control of the molecular weight between crosslinking points. The alicyclic epoxy resin in the component (A) may be a polyfunctional epoxy group-containing substance, or a difunctional epoxy group-containing substance. According to this configuration, the composition has particularly low viscosity, excellent processability, and a high toughness improvement effect due to control of the molecular weight between crosslinking points.

Examples of commercially available bisphenol A epoxy resins include, but are not limited to, those sold under the trademark jER by Mitsubishi Chemical Corporation (for example, jER828, jER825, jER827, jER828EL, jER828US, jER828XA, jER834, jER1001, jER1002, jER1004, jER1007, jER1009, jER1010), those sold under the trademark EPON by Momentive Specialty Chemicals, Inc. (for example, EPON 1510, EPON 1310, EPON 828, EPON 872, EPON 1001, EPON 1004, EPON 2004), those sold under the trademark DER by Olin Epoxy Co. (for example, DER 331, DER 332, DER 336, and DER 439), those sold under the trademark ADEKA RESIN by ADEKA Corporation (for example, EP-4100, EP-4300, EP-4400, EP-4530, EP-4504), and those sold under the trademark EPICLON by DIC Corporation (for example, EPICLON 840, EPICLON 850).

Examples of commercially available bisphenol F epoxy resins include, but are not limited to, those sold under the trademark jER by Mitsubishi Chemical Corporation (for example, jER806, jER806H, jER807, jER4005P, jER4007P, jER4010P), those sold under the trademark DER by Olin Epoxy Co. (for example, DER 334), those sold under the trademark ADEKA RESIN by ADEKA Corporation (for example, EP-4901, EP-4901E), and those sold under the trademark EPICLON by DIC Corporation (for example, EPICLON 830).

Alicyclic epoxy resins are compounds that contain (i) one or more saturated or unsaturated aliphatic hydrocarbon rings and (ii) one or more epoxy groups in a molecule, and include, for example, epoxy resins containing cycloalkane rings. Examples of alicyclic epoxy resins include 3,4-epoxycyclohexylmethyl (3,4-epoxy)cyclohexanecarboxylate, tetrahydroindene diepoxide, vinylcyclohexene oxide, dipentene dioxide, adipic acid bis(3,4-epoxycyclohexylmethyl), dicyclopentadiene dioxide, bis(2,3-epoxycyclopentyl) ether, 1,2-epoxy-4-(2-oxiranil)cyclohexane adduct of 2,2-bis(hydroxymethyl)-1-butanol, epoxidized butanetetracarboxylic acid tetrakis-(3-cyclohexenylmethyl) modified epsilon-caprolactone, bi-7-oxabicyclo[4.1.0]heptane, dodecahydrobisphenol A diglycidyl ether, dodecahydrobisphenol F diglycidyl ether, 1,4-cyclohexanedimethanol diglycidyl ether, hexahydrophthalic acid diglycidyl ester, hexahydroterephthalic acid diglycidyl ester, and diglycidyl ether of 2,2-bis(4-hydroxycyclohexyl)propane (generic name: hydrogenated bisphenol A type liquid epoxy resin). The alicyclic epoxy resin may contain at least one type selected from the group consisting of 3,4-epoxycyclohexylmethyl (3,4-epoxy)cyclohexanecarboxylate, 1,2-epoxy-4-(2-oxiranil) cyclohexane adduct of 2,2-bis(hydroxymethyl)-1-butanol, epoxidized butanetetracarboxylic acid tetrakis-(3-cyclohexenylmethyl) modified epsilon-caprolactone, and diglycidyl ether of 2,2-bis(4-hydroxycyclohexyl)propane, may be composed only of at least one type selected from that group, may include 3,4-epoxycyclohexylmethyl(3,4-epoxy) cyclohexanecarboxylate, or may be composed only of 3,4-epoxycyclohexylmethyl (3,4-epoxy)cyclohexanecarboxylate. According to this configuration, the composition has low viscosity and excellent processability, and the cured product obtained by curing the composition has advantages of high strength, elastic modulus, and heat resistance (high Tg).

In 100 parts by mass of the component (A), the total contained amount of the bisphenol A epoxy resin, the bisphenol F epoxy resin, and the alicyclic epoxy resin may be 60 parts by mass to 100 parts by mass, 65 parts by mass to 100 parts by mass, 70 parts by mass to 100 parts by mass, 71 parts by mass to 100 parts by mass, 80 parts by mass to 100 parts by mass, 90 parts by mass to 100 parts by mass, or 95 parts by mass to 100 parts by mass. The upper limit of the total contained amount of the bisphenol A epoxy resin, the bisphenol F epoxy resin, and the alicyclic epoxy resin in 100 parts by mass of the component (A) may be less than 100 parts by mass. According to this configuration, the composition has low viscosity and excellent processability, and the cured product obtained by curing the composition has advantages of high strength, elastic modulus, and heat resistance (high Tg). In 100 parts by mass of the component (A), the total contained amount of the bisphenol A epoxy resin, the bisphenol F epoxy resin, and the alicyclic epoxy resin may be 100 parts by mass. In other words, the component (A) may be composed only of a bisphenol A epoxy resin, may be composed only of bisphenol F epoxy resin, may be composed only of an alicyclic epoxy resin, may be composed only of a bisphenol A epoxy resin and an alicyclic epoxy resin, may be composed only of a bisphenol F epoxy resin and an alicyclic epoxy resin, may be composed only of a bisphenol A epoxy resin and a bisphenol F epoxy resin, or may be composed only of a bisphenol A epoxy resin, a bisphenol F epoxy resin, and an alicyclic epoxy resin. The component (A) may not contain other epoxy group-containing substances (for example, glycidyl amine type epoxy resin) described later.

The component (A) may contain at least one type selected from the group consisting of a bisphenol A epoxy resin, a bisphenol F epoxy resin, and an alicyclic epoxy resin, and may further contain an epoxy group-containing substance other than bisphenol A epoxy resin, bisphenol F epoxy resin, and alicyclic epoxy resin. In the present description, the “epoxy group-containing substance other than bisphenol A epoxy resin, bisphenol F epoxy resin, and alicyclic epoxy resin” may also be referred to as “other epoxy group-containing substances”. Examples of other epoxy group-containing substances include (i) a polyfunctional epoxy group-containing substance other than bisphenol A epoxy resin, bisphenol F epoxy resin, and alicyclic epoxy resin, and (ii) a monofunctional epoxy group-containing substances other than alicyclic epoxy resin. In the present description, the “polyfunctional epoxy group-containing substance other than bisphenol A epoxy resin, bisphenol F epoxy resin, and alicyclic epoxy resin” may also be referred to as “other polyfunctional epoxy group-containing substances”. In the present description, the “monofunctional epoxy group-containing substance other than alicyclic epoxy resin” may also be referred to as “other monofunctional epoxy group-containing substances”.

The component (A) may be composed only of (i) a bisphenol A epoxy resin and other epoxy group-containing substances, (ii) may be composed only of a bisphenol F epoxy resin and other epoxy group-containing substances, (iii) may be composed only of an alicyclic epoxy resin and other epoxy group-containing substances, (iv) may be composed only of a bisphenol A epoxy resin, an alicyclic epoxy resin, and other epoxy group-containing substances, (v) may be composed only of a bisphenol F epoxy resin, an alicyclic epoxy resin, and other epoxy group-containing substances, (vi) may be composed only of a bisphenol A epoxy resin, a bisphenol F epoxy resin, and other epoxy group-containing substances, or (vii) may be composed of a bisphenol A epoxy resin, a bisphenol F epoxy resin, an alicyclic epoxy resin, and other epoxy group-containing substances.

The other polyfunctional epoxy group-containing substances are not particularly limited. Examples of the other polyfunctional epoxy group-containing substances include commonly used epoxy resins other than bisphenol A epoxy resin, bisphenol F epoxy resin, and alicyclic epoxy resin, as well as substances listed below: bisphenol AD epoxy resin, bisphenol S epoxy resin, glycidyl ester type epoxy resin, glycidyl amine type epoxy resin, novolac type epoxy resin, biphenyl type epoxy resin, oxazolidone type epoxy resin, biphenyl aralkyl type epoxy resin, bisnaphthalenic epoxy resin, glycidyl ether type epoxy resin of bisphenol A propylene oxide adduct, hydrogenated bisphenol A epoxy resin, hydrogenated bisphenol F epoxy resin, fluorinated epoxy resin, flame-retardant epoxy resins such as glycidyl ether of tetrabromo bisphenol A, p-oxybenzoic acid glycidyl ether ester type epoxy resin, m-aminophenol type epoxy resin, diaminodiphenylmethane-based epoxy resin, N,N-diglycidyl aniline, N,N-diglycidyl-o-toluidine, triglycidyl isocyanurate, divinylbenzene dioxide, resorcinol diglycidyl ether, polyalkylene glycol diglycidyl ether, glycol diglycidyl ether, diglycidyl esters of aliphatic polybasic acids, glycidyl ethers of divalent or higher polyaliphatic alcohols such as glycerin, chelate-modified epoxy resin, rubber-modified epoxy resin, urethane-modified epoxy resin, hydantoin-type epoxy resin, epoxidized products of unsaturated polymers such as petroleum resin, and amino-containing glycidyl ether resin.

Epoxy compounds obtained by causing an addition reaction between an epoxy resin such as a bisphenol A epoxy resin and bisphenol A (or F) or a polybasic acid are also included in the other polyfunctional epoxy group-containing substances (i.e., other epoxy group-containing substances).

More specific examples of the glycidyl amine type epoxy resin include N,N,O-triglycidyl-m-aminophenol, N,N,O-triglycidyl-p-aminophenol, N,N,O-triglycidyl-4-amino-3-methylphenol, N,N,N′,N′-tetraglycidyl-4,4′-methylene dianiline, N,N,N′,N′-tetraglycidyl-2,2′-diethyl-4,4′-methylene dianiline, N,N,N′,N′-tetraglycidyl-m-xylylenediamine, N,N-diglycidyl aniline, and N,N-diglycidyl-o-toluidine. More specific examples of the polyalkylene glycol diglycidyl ether include polyethylene glycol diglycidyl ether, and polypropylene glycol diglycidyl ether. More specific examples of the glycol diglycidyl ether include neopentyl glycol diglycidyl ether, 1,4-butanediol diglycidyl ether, 1,6-hexanediol diglycidyl ether, and cyclohexane dimethanol diglycidyl ether. More specific examples of the diglycidyl ester of an aliphatic polybasic acid include dimer acid diglycidyl ester, adipic acid diglycidyl ester, sebacic acid diglycidyl ester, and maleic acid diglycidyl ester. More specific examples of the glycidyl ether of a polyvalent aliphatic alcohol having bivalency or greater valency include trimethylolpropane triglycidyl ether, trimethylolethane triglycidyl ether, castor oil-modified polyglycidyl ether, propoxylated glycerine triglycidyl ether, and sorbitol polyglycidyl ether.

As the chelate-modified epoxy resin, for example, the resins described in paragraphs [0018] to [0019] in the pamphlet of WO 2016/163491 can be used.

The rubber-modified epoxy resin may be a reaction product that has been obtained by reacting rubber with an epoxy group-containing compound and that contains 1.1 or more epoxy groups, or 2 or more epoxy groups, on average per molecule. As the rubber-modified epoxy resin, for example, the resins described in paragraphs [0124] to [0132] in the pamphlet of WO 2016/163491 can be used.

As the urethane-modified epoxy resin, for example, the resins described in paragraphs [0133] to [0135] in the pamphlet of WO 2016/163491 can be used.

Examples of the epoxy compound obtained by causing an addition reaction between an epoxy resin such as a bisphenol A epoxy resin and a polybasic acid or the like include an addition reaction product of (i) a dimer (dimer acid) of a tall oil fatty acid and (ii) a bisphenol A epoxy resin, such as that disclosed in International Publication No. WO 2010/098950.

Examples of the other monofunctional epoxy group-containing substances include: aliphatic glycidyl ethers such as butyl glycidyl ether; aromatic glycidyl ethers such as phenyl glycidyl ether and cresyl glycidyl ether (e.g., o-cresyl glycidyl ether); ethers composed of an alkyl group having 8 to 10 carbon atoms and a glycidyl group, such as 2-ethylhexyl glycidyl ether; ethers composed of a glycidyl group and a phenyl group having 6 to 12 carbon atoms that can be substituted with an alkyl group having 2 to 8 carbon atoms, such as p-tert-buthylphenyl glycidyl ether; ethers composed of an alkyl group having 12 to 14 carbon atoms and a glycidyl group (also referred to as alkyl C12-C14 glycidyl ether), such as dodecyl glycidyl ether; aliphatic glycidyl esters such as glycidyl (meth)acrylate and glycidyl maleate; glycidyl esters of aliphatic carboxylic acids having 8 to 12 carbon atoms, such as versatic acid glycidyl ester, neodecanoic acid glycidyl ester, and lauric acid glycidyl ester; and p-t-butylbenzoic acid glycidyl ester.

As the other epoxy group-containing substances, any one type of the substances described above may be used alone, or two or more may be used in combination.

The component (A) may contain, among other epoxy group-containing substances, at least one type selected from the group consisting of glycidyl amine type epoxy resin, biphenyl type epoxy resin, oxazolidone type epoxy resin, biphenyl aralkyl type epoxy resin, bisnaphthalenic epoxy resin, novolac type epoxy resin, and glycol diglycidyl ether, at least one type selected from the group consisting of glycidyl amine type epoxy resin, biphenyl type epoxy resin, oxazolidone type epoxy resin, biphenyl aralkyl type epoxy resin, bisnaphthalenic epoxy resin, and glycol diglycidyl ether, at least one type selected from the group consisting of glycidyl amine type epoxy resin, biphenyl type epoxy resin, oxazolidone type epoxy resin, and glycol diglycidyl ether, or at least one type selected from the group consisting of glycidyl amine type epoxy resin, biphenyl type epoxy resin, and glycol diglycidyl ether. According to this configuration, the cured product obtained by curing the composition has the advantage of being excellent in strength, elastic modulus, and heat resistance (high Tg).

The case where the component (A) contains at least one type selected from the group consisting of glycidyl amine type epoxy resin, biphenyl type epoxy resin, oxazolidone type epoxy resin, biphenyl aralkyl type epoxy resin, bisnaphthalenic epoxy resin, novolac type epoxy resin, and glycol diglycidyl ether will be described. The total contained amount of glycidyl amine type epoxy resin, biphenyl type epoxy resin, oxazolidone type epoxy resin, biphenyl aralkyl type epoxy resin, bisnaphthalenic epoxy resin, novolac type epoxy resin, and glycol diglycidyl ether in the component (A) may be 29 parts by mass or less, 24 parts by mass or less, or 19 parts by mass or less. According to this configuration, the composition becomes relatively low in viscosity and has excellent processability, and further, the cured product obtained by curing the composition has the advantage of being excellent in strength, elastic modulus, and heat resistance (high Tg). The lower limit of the total contained amount of glycidyl amine type epoxy resin, biphenyl type epoxy resin, oxazolidone type epoxy resin, biphenyl aralkyl type epoxy resin, bisnaphthalenic epoxy resin, novolac type epoxy resin, and glycol diglycidyl ether in the component (A) is not particularly limited, but for example, it may be more than 0 parts by mass, and may be 1 part by mass or more, 2 parts by mass or more, or 3 parts by mass or more. According to this configuration, the cured product obtained by curing the composition has the advantage of being excellent in strength, elastic modulus, and heat resistance (high Tg).

The component (A) may further contain or may not contain glycidyl amine type epoxy resin. The case where the component (A) contains glycidyl amine type epoxy resin will be described. The contained amount of the glycidyl amine type epoxy resin in component (A) may be 29 parts by mass or less, 24 parts by mass or less, 19 parts by mass or less, or 14 parts by mass or less. According to this configuration, the composition becomes relatively low in viscosity and has excellent processability, and further, the cured product obtained by curing the composition has the advantage of being excellent in strength, elastic modulus, and heat resistance (high Tg). The lower limit of the contained amount of glycidyl amine type epoxy resin in the component (A) is not particularly limited, but for example, it may be more than 0 parts by mass, and may be 1 part by mass or more, 2 parts by mass or more, or 3 parts by mass or more. According to this configuration, the cured product obtained by curing the composition has the advantage of being excellent in strength, elastic modulus, and heat resistance (high Tg).

In the present description, among polyfunctional epoxy group-containing substances, “polyfunctional epoxy group-containing substances having an epoxy equivalent weight of 300 g/eq or more and less than 3000 g/eq,” that is, “polyfunctional epoxy group-containing substances having an epoxy equivalent weight of 300 g/eq or more and less than 3000 g/eq, and having two or more epoxy groups per molecule” may be referred to as “polyfunctional epoxy group-containing substance (a1)”.

In the present description, the epoxy equivalent weight is intended to mean a molecular weight per epoxy group that is contained in an epoxy group-containing substance, and is specifically a value obtained by calculation based on the following formula: Epoxy equivalent weight (g/eq)=mass average molecular weight (Mw) of epoxy group-containing substance/number (average number) of epoxy groups per molecule of epoxy group-containing substance.

Note that the epoxy equivalent weight can also be measured in accordance with JIS K7236.

The component (A) may contain or may not contain polyfunctional epoxy group-containing substance (a1). Since the composition has the advantage of being relatively low in viscosity and having excellent processability, the component (A) need not contain polyfunctional epoxy group-containing substance (a1).

Since the cured product obtained by curing the composition has the advantage of being excellent in toughness, component (A) may contain polyfunctional epoxy group-containing substance (a1). It should be noted that (i) a bisphenol A epoxy resin having an epoxy equivalent weight of 300 g/eq or more and less than 3000 g/eq, and having two or more epoxy groups per molecule, (ii) a bisphenol F epoxy resin having an epoxy equivalent weight of 300 g/eq or more and less than 3000 g/eq, and having two or more epoxy groups per molecule, and (iii) an alicyclic epoxy resin having an epoxy equivalent weight of 300 g/eq or more and less than 3000 g/eq and having two or more epoxy groups per molecule, are all polyfunctional epoxy group-containing substances (a1). The contained amount of the polyfunctional epoxy group-containing substance (a1) in 100 parts by mass of the component (A) may be 5 parts by mass to 100 parts by mass, 6 parts by mass to 50 parts by mass, 7 parts by mass to 30 parts by mass, or 8 parts by mass to 20 parts by mass. According to this configuration, the composition becomes relatively low in viscosity and has excellent processability, and further, the cured product obtained by curing the composition has the advantage of being excellent in toughness. The upper limit of the contained amount of polyfunctional epoxy group-containing substance (a1) in 100 parts by mass of the component (A) may be less than 100 parts by mass.

In the present description, the “monofunctional epoxy group-containing substance” may be referred to as “monofunctional epoxy group-containing substance (a2)”. Also, the “monofunctional epoxy group-containing substance” may sometimes be referred to as “monoepoxide”.

The component (A) may contain or may not contain monofunctional epoxy group-containing substance (a2). Since the cured product obtained by curing the composition has the advantage of excellent strength and heat resistance (high Tg), the component (A) need not contain monofunctional epoxy group-containing substance (a2).

The component (A) may contain monofunctional epoxy group-containing substance (a2). According to this configuration, the composition becomes low in viscosity and has excellent processability, and the cured product obtained by curing the composition has the advantage of excellent toughness. In 100 parts by mass of the component (A), the contained amount of the monofunctional epoxy group-containing substance (a2) may be 5 parts by mass to 40 parts by mass, 5 parts by mass to 35 parts by mass, 5 parts by mass to 33 parts by mass, or 5 parts by mass to 30 parts by mass. According to this configuration, the composition becomes low in viscosity and has excellent processability, and the cured product obtained by curing the composition has the advantage of excellent strength and/or toughness. The upper limit of the contained amount of the monofunctional epoxy group-containing substance (a2) in 100 parts by mass of the component (A) may be less than 40 parts by mass.

Since the cured product obtained by curing the composition has the advantage of being more excellent in toughness, the component (A) may contain a polyfunctional epoxy group-containing substance (a1) and a monofunctional epoxy group-containing substance (a2). A case where the component (A) contains the polyfunctional epoxy group-containing substance (a1) and the monofunctional epoxy group-containing substance (a2) will be described. In this case, in 100 parts by mass of the component (A), (i) the contained amount of the polyfunctional epoxy group-containing substance (a1) may be 5 parts by mass to 95 parts by mass, and the contained amount of the monofunctional epoxy group-containing substance (a2) may be 5 parts by mass to 40 parts by mass, (ii) the contained amount of the polyfunctional epoxy group-containing substance (a1) may be 6 parts by mass to 50 parts by mass, and the contained amount of the monofunctional epoxy group-containing substance (a2) may be 5 parts by mass to 35 parts by mass, (iii) the contained amount of the polyfunctional epoxy group-containing substance (a1) may be 7 parts by mass to 30 parts by mass, and the contained amount of the monofunctional epoxy group-containing substance (a2) may be 5 parts by mass to 33 parts by mass, or (iv) the contained amount of the polyfunctional epoxy group-containing substance (a1) may be 8 parts by mass to 20 parts by mass, and the contained amount of the monofunctional epoxy group-containing substance (a2) may be 5 parts by mass to 30 parts by mass. According to this configuration, the composition becomes low in viscosity and has excellent processability, and the cured product obtained by curing the composition has the advantage of excellent strength and/or toughness. When the component (A) contains polyfunctional epoxy group-containing substance (a1) and monofunctional epoxy group-containing substance (a2), in 100 parts by mass of the component (A), (i) the contained amount of the polyfunctional epoxy group-containing substance (a1) may be less than 95 parts by mass, and/or (ii) the contained amount of the monofunctional epoxy group-containing substance (a2) may be less than 40 parts by mass.

Polyalkylene glycol diglycidyl ether, glycol diglycidyl ether, diglycidyl ester of aliphatic polybasic acid, and glycidyl ether of a polyvalent aliphatic alcohol having bivalency or greater valency can be said to be epoxy resins with relatively low viscosity. These “epoxy resins with relatively low viscosity” may be referred to as “polyepoxides” in the present description. When a polyepoxide is used in combination with an epoxy resin other than polyepoxides (for example, bisphenol A epoxy resin and/or bisphenol F epoxy resin), the polyepoxide functions as a reactive diluent in the composition, improving the balance between the viscosity of the composition and the properties of the cured product. Also, when an epoxy resin other than polyepoxides (for example, bisphenol A epoxy resin and/or bisphenol F epoxy resin) is used in combination with a monofunctional epoxy group-containing substance (a2), the monofunctional epoxy group-containing substance (a2) functions as a reactive diluent in the composition, improving the balance between the viscosity of the composition and the properties of the cured product.

The component (A) may contain monofunctional epoxy group-containing substance (a2) and/or polyepoxide as a reactive diluent. The total contained amount of the monofunctional epoxy group-containing substance (a2) and the polyepoxide in the component (A) may be 0.5 parts by mass to 30.0 parts by mass, 2.0 parts by mass to 20.0 parts by mass, or 5.0 parts by mass to 15.0 parts by mass in 100 parts by mass of the component (A).

The epoxy group-containing substance that is the component (A) may contain an epoxy group-containing substance with an epoxy equivalent weight of less than 220 g/eq, or may be composed only of an epoxy group-containing substance with an epoxy equivalent weight of less than 220 g/eq. It may also contain an epoxy group-containing substance with an epoxy equivalent weight of 90 g/eq or more and less than 210 g/eq, or may be composed only of an epoxy group-containing substance with an epoxy equivalent weight of 90 g/eq or more and less than 210 g/eq. It may also be composed only of an epoxy group-containing substance with an epoxy equivalent weight of 135 g/eq or more and less than 200 g/eq. According to this configuration, there is an advantage of making it possible to obtain a cured product having a high elastic modulus and high heat resistance.

Among the epoxy group-containing substances, bisphenol A epoxy resin and bisphenol F epoxy resin are relatively inexpensive and make it possible to obtain a cured product which has a high elastic modulus, excellent heat resistance, and excellent adhesiveness. Thus, the component (A) may contain a bisphenol A epoxy resin and/or a bisphenol F epoxy resin, or the component (A) may be composed only of a bisphenol A epoxy resin and/or a bisphenol F epoxy resin. In addition, the component (A) may contain a bisphenol A epoxy resin, or the component (A) may be composed only of a bisphenol A epoxy resin, because a curable resin composition that makes it possible to provide a cured product with excellent heat resistance can be obtained at a low cost.

In 100 parts by mass of the component (A), the total contained amount of the bisphenol A epoxy resin and the bisphenol F epoxy resin may be 60 parts by mass or more, 80 parts by mass or more, or 90 parts by mass or more. According to this configuration, the obtained cured product has the advantage of being superior in toughness, impact resistance, heat resistance, and strength. The total contained amount of the bisphenol A epoxy resin and the bisphenol F epoxy resin in 100 parts by mass of the component (A) may be 100 parts by mass. In other words, the component (A) may be (i) composed only of a bisphenol A epoxy resin, or may be (ii) composed only of a mixture of a bisphenol A epoxy resin and a bisphenol F epoxy resin.

Both bisphenol A epoxy resin having an epoxy equivalent weight of less than 220 g/eq and bisphenol F epoxy resin having an epoxy equivalent weight of less than 220 g/eq are liquid at normal temperature and excellent in handling properties. Therefore, from the perspective of excellent handling properties and storage stability of the composition, the component (A) may contain a bisphenol A epoxy resin with an epoxy equivalent weight of less than 220 g/eq and/or a bisphenol F epoxy resin with an epoxy equivalent weight of less than 220 g/eq, or the component (A) may contain a mixture of a bisphenol A epoxy resin with an epoxy equivalent weight of less than 220 g/eq and a bisphenol F epoxy resin with an epoxy equivalent weight of less than 220 g/eq.

In 100 parts by mass of the component (A), a total contained amount of the bisphenol A epoxy resin having an epoxy equivalent weight of less than 220 g/eq and the bisphenol F epoxy resin having an epoxy equivalent weight of less than 220 g/eq may be 60 parts by mass or more, 80 parts by mass or more, or 90 parts by mass or more. According to this configuration, the composition has the advantage of further excellent handling properties and storage stability, and the cured product obtained by curing the composition has further excellent toughness, impact resistance, heat resistance, and strength. In 100 parts by mass of the component (A), the total contained amount of the bisphenol A epoxy resin with an epoxy equivalent weight of less than 220 g/eq and the bisphenol F epoxy resin with an epoxy equivalent weight of less than 220 may be 100 parts by mass. In other words, the component (A) may be (i) composed only of a bisphenol A epoxy resin with an epoxy equivalent weight of less than 220 g/eq, or may be (ii) composed only of a mixture of a bisphenol A epoxy resin with an epoxy equivalent weight of less than 220 g/eq and a bisphenol F epoxy resin with an epoxy equivalent weight of less than 220 g/eq.

The contained amount of the component (A) in the composition may be 20 parts by mass or more, 25 parts by mass or more, 30 parts by mass or more, or 35 parts by mass or more in 100 parts by mass of the composition. According to this configuration, the cured product obtained by curing the composition has the advantage of excellent strength and/or toughness.

When the component (C) in the composition is an acid anhydride (c1), the composition may contain, as the component (A), (i) an alicyclic epoxy resin, the composition may contain (ii) a polyfunctional alicyclic epoxy resin having two or more epoxy groups per molecule, or the composition may contain (iii) a polyfunctional alicyclic epoxy resin having an epoxy equivalent weight of less than 220 g/eq (or 90 g/eq or more and less than 220 g/eq) and having two or more epoxy groups per molecule. When the component (C) in the composition is an acid anhydride (c1), in the composition, in 100 parts by mass of the component (A), (i) the contained amount of the alicyclic epoxy resin may be 60 parts by mass to 100 parts by mass (or 60 parts by mass or more and less than 100 parts by mass), (ii) the contained amount of the polyfunctional alicyclic epoxy resin having two or more epoxy groups per molecule may be 60 parts by mass to 100 parts by mass (or 60 parts by mass or more and less than 100 parts by mass), or (iii) the contained amount of the polyfunctional alicyclic epoxy resin having an epoxy equivalent weight of less than 220 g/eq (or 90 g/eq or more and less than 220 g/eq) and having two or more epoxy groups per molecule may be 60 parts by mass to 100 parts by mass (or 60 parts by mass or more and less than 100 parts by mass).

An aspect of one or more embodiments of the present invention may have the following configuration:
A curable resin composition containing:
the following component (A), component (B), and component (C),
and not containing the following component (D) or further containing the following component (D):
   component (A): an epoxy group-containing substance containing an alicyclic epoxy resin (which may be a polyfunctional alicyclic epoxy resin having two or more epoxy groups per molecule, or a polyfunctional alicyclic epoxy resin having an epoxy equivalent weight of less than 220 g/eq (or 90 g/eq or more and less than 220 g/eq) and having two or more epoxy groups per molecule);
   component (B): polymer particles having a core-shell structure that includes a core layer and a shell layer;
   component (C): an acid anhydride (c1);
   component (D): a curing accelerator,
in 100 parts by mass of the component (A), a contained amount of the alicyclic epoxy resin may be 60 parts by mass to 100 parts by mass (or 60 parts by mass or more and less than 100 parts by mass),
a contained amount of the component (B) is 1 part by mass to 100 parts by mass with respect to 100 parts by mass of the component (A),
a contained amount of the component (C) is 10 parts by mass to 200 parts by mass with respect to 100 parts by mass of the component (A),
when the curable resin composition contains the component (D), a contained amount of the component (D) is 0.1 parts by mass to 10.0 parts by mass with respect to 100 parts by mass of the component (A), and
the value X calculated by the above formula is 1.05 to 5.50.

When the component (C) in the composition is an aromatic amine (c2) or an alicyclic amine (c3), the composition may contain, as the component (A), (i) a bisphenol A epoxy resin, (ii) a polyfunctional bisphenol A epoxy resin having two or more epoxy groups per molecule, or (iii) a polyfunctional bisphenol A epoxy resin having an epoxy equivalent weight of less than 220 g/eq (or 90 g/eq or more and less than 220 g/eq) and having two or more epoxy groups per molecule. When the component (C) in the composition is an aromatic amine (c2) or an alicyclic amine (c3), in the composition, in 100 parts by mass of the component (A), (i) the contained amount of the bisphenol A epoxy resin may be 60 parts by mass to 100 parts by mass (or 60 parts by mass or more and less than 100 parts by mass), (ii) the contained amount of the polyfunctional bisphenol A epoxy resin having two or more epoxy groups per molecule may be 60 parts by mass to 100 parts by mass (or 60 parts by mass or more and less than 100 parts by mass), or (iii) the contained amount of the polyfunctional bisphenol A epoxy resin having an epoxy equivalent weight of less than 220 g/eq (or 90 g/eq or more and less than 220 g/eq) and having two or more epoxy groups per molecule may be 60 parts by mass to 100 parts by mass (or 60 parts by mass or more and less than 100 parts by mass).

An aspect of one or more embodiments of the present invention may have the following configuration:
A curable resin composition containing:
the following component (A), component (B), and component (C),
and not containing the following component (D) or further containing the following component (D):
   component (A): an epoxy group-containing substance containing bisphenol A epoxy resin (which may be a polyfunctional bisphenol A epoxy resin having two or more epoxy groups per molecule, or a polyfunctional bisphenol A epoxy resin having an epoxy equivalent weight of less than 220 g/eq (or 90 g/eq or more and less than 220 g/eq) and having two or more epoxy groups per molecule);
   component (B): polymer particles having a core-shell structure that includes a core layer and a shell layer;
   component (C): an aromatic amine (c2);
   component (D): a curing accelerator,
in 100 parts by mass of the component (A), a contained amount of the bisphenol A epoxy resin may be 60 parts by mass to 100 parts by mass (or 60 parts by mass or more and less than 100 parts by mass),
a contained amount of the component (B) is 1 part by mass to 100 parts by mass with respect to 100 parts by mass of the component (A),
a contained amount of the component (C) is 10 parts by mass to 200 parts by mass with respect to 100 parts by mass of the component (A),
when the curable resin composition contains the component (D), a contained amount of the component (D) is 0.1 parts by mass to 10.0 parts by mass with respect to 100 parts by mass of the component (A), and
a value X calculated by the above formula is 1.30 to 9.00.

An aspect of one or more embodiments of the present invention may have the following configuration:
A curable resin composition containing:
the following component (A), component (B), and component (C),
and not containing the following component (D) or further containing the following component (D):
   component (A): an epoxy group-containing substance containing bisphenol A epoxy resin (which may be a polyfunctional bisphenol A epoxy resin having two or more epoxy groups per molecule, or a polyfunctional bisphenol A epoxy resin having an epoxy equivalent weight of less than 220 g/eq (or 90 g/eq or more and less than 220 g/eq) and having two or more epoxy groups per molecule);
   component (B): polymer particles having a core-shell structure that includes a core layer and a shell layer;
   component (C): alicyclic amine (c3);
   component (D): a curing accelerator,
in 100 parts by mass of the component (A), a contained amount of the bisphenol A epoxy resin may be 60 parts by mass to 100 parts by mass (or 60 parts by mass or more and less than 100 parts by mass),
a contained amount of the component (B) is 1 part by mass to 100 parts by mass with respect to 100 parts by mass of the component (A),
a contained amount of the component (C) is 5 parts by mass to 200 parts by mass with respect to 100 parts by mass of the component (A),
when the curable resin composition contains the component (D), a contained amount of the component (D) is 0.1 parts by mass to 10.0 parts by mass with respect to 100 parts by mass of the component (A), and
a value X calculated by the above formula is 1.30 to 9.00.

### <1-1-3. Component (B)>

The component (B) is polymer particles having a core-shell structure that includes a core layer and a shell layer. In the present description, the “polymer particles having a core-shell structure that includes a core layer and a shell layer” refers to particles in which a core layer consisting of core polymer and a shell layer consisting of shell polymer form a layered structure. In the present description, the “polymer particles having a core-shell structure that includes a core layer and a shell layer” may also be referred to as “core-shell polymer particles” or simply “polymer particles”.

The component (B) (polymer particles) can exhibit a toughness improvement effect in the composition. In other words, the composition has the advantage of being able to provide a cured product with excellent toughness by containing the component (B). In addition, by containing the component (B), a cured product obtained from the composition tends to have excellent strength.

The polymer particles can be obtained by graft polymerizing a graft copolymerizable monomer (monomer for shell layer formation) in the presence of a core layer to form a shell layer. More specifically, this polymerization operation can be carried out by adding a monomer for shell layer (shell polymer) formation to core polymer latex that is prepared and exists in the form of an aqueous polymer latex, and then carrying out polymerization. In the polymer particles, a core polymer and a shell polymer may be substantially chemically bonded to each other. Note that in the polymer particles, the core layer and the shell layer may not form a complete layered structure. The shell layer (shell polymer) only needs to cover at least part of the core layer (core polymer) and may not cover the entire core layer. In addition, part of the shell layer may penetrate into the core layer.

The following description will specifically discuss each layer of the polymer particles.

### <<Core Layer>>

The core layer may be an elastic core layer that has properties as rubber, in order to increase the toughness of a cured product of a composition.

Due to the high toughness improvement effect of the resulting cured product, the high impact resistance improvement effect of the resulting cured product, and the low affinity with component (A) which makes it difficult for the core layer to swell and cause an increase in viscosity over time, the core layer may contain diene-based rubber, or may be diene-based rubber (for example, composed only of diene-based rubber).

The core layer may contain (meth)acrylate-based rubber in that such a core layer enables design of polymers of a wide variety of compositions by combination of a plurality of monomers. In a case where it is desirable to enhance impact resistance at low temperatures without decreasing the heat resistance of the cured product, the core layer may contain organosiloxane-based rubber. In other words, the core layer may contain at least one type selected from the group consisting of diene-based rubber, (meth)acrylate-based rubber, and organosiloxane-based rubber.

### (Diene-Based Rubber)

The diene-based rubber may be a polymer that includes conjugated diene-based units in an amount of 50% by mass to 100% by mass and a structural unit derived from a vinyl-based monomer which is different from conjugated diene-based monomers and which is copolymerizable with conjugated diene-based monomers in an amount of 0% by mass to 50% by mass.

Examples of the conjugated diene-based monomer that gives rise to the conjugated diene-based unit include 1,3-butadiene, isoprene (2-methyl-1,3-butadiene), and 2-chloro-1,3-butadiene.

One type of these conjugated diene-based monomers may be used alone, or two or more types of these conjugated diene-based monomers may be used in combination.

A contained amount of the conjugated diene-based unit in the core layer may be 50% by mass to 100% by mass, 70% by mass to 100% by mass, or 90% by mass to 100% by mass, in 100% by mass of all of the structural units that constitute the core layer. Setting the contained amount of the conjugated diene-based unit in the core layer to be 50% by mass or more makes it possible for a resulting cured product to have more favorable toughness.

Examples of the vinyl-based monomer which differs from conjugated diene-based monomers and which is copolymerizable with conjugated diene-based monomers include: vinyl arenes such as styrene, a-methylstyrene, monochlorostyrene, and dichlorostyrene; vinyl carboxylic acids such as acrylic acid and methacrylic acid; vinyl cyanides such as acrylonitrile and methacrylonitrile; halogenated vinyls such as vinyl chloride, vinyl bromide, and chloroprene; vinyl acetate; alkenes such as ethylene, propylene, butylene, and isobutylene; and polyfunctional monomers such as diallyl phthalate, triallyl cyanurate, triallyl isocyanurate, and divinylbenzene.

One type of these vinyl-based monomers may be used alone, or two or more types of these vinyl-based monomers may be used in combination. As the vinyl-based monomer which differs from conjugated diene-based monomers and which is copolymerizable with conjugated diene-based monomers, styrene is particularly preferable.

Due to a high toughness improvement effect of a resulting cured product, a high impact resistance improvement effect of a resulting cured product, and a low affinity with the epoxy resin (A) (component (A)), which makes it more difficult for the core layer to swell and cause an increase in viscosity over time, the core layer may contain, among diene-based rubbers, butadiene rubber, which is a homopolymer of 1,3-butadiene, and/or butadiene-styrene rubber, which is a copolymer of 1,3-butadiene and styrene, the core layer is butadiene rubber and/or butadiene-styrene rubber (for example, composed only of butadiene rubber and/or butadiene-styrene rubber), the core layer contains butadiene rubber, or the core layer is butadiene rubber (for example, composed only of butadiene rubber). Butadiene-styrene rubber is preferable in that butadiene-styrene rubber makes it possible to increase the transparency of the resulting cured product by adjustment of a refractive index.

### ((Meth)Acrylate-Based Rubber)

The (meth)acrylate-based rubber may be a polymer obtained by polymerizing a monomer mixture that contains (meth)acrylate-based units in an amount of 50% by mass to 100% by mass and a structural unit derived from a vinyl-based monomer which differs from (meth)acrylate-based monomers and which is copolymerizable with (meth)acrylate-based monomers in an amount of 0% by mass to 50% by mass. Note that, in the present description, “(meth)acrylate” means acrylate and/or methacrylate.

Examples of the (meth)acrylate-based monomer that gives rise to the (meth)acrylate-based unit include: (i) alkyl (meth)acrylates such as methyl (meth)acrylate, ethyl (meth)acrylate, butyl (meth)acrylate, 2-ethylhexyl (meth)acrylate, octyl (meth)acrylate, dodecyl (meth)acrylate, stearyl (meth)acrylate, and behenyl (meth)acrylate; (ii) aromatic ring-containing (meth)acrylates such as phenoxyethyl (meth)acrylate and benzyl (meth)acrylate; (iii) hydroxyalkyl (meth)acrylates; (iv) glycidyl (meth)acrylates such as glycidyl (meth)acrylate and glycidyl alkyl (meth)acrylate; (v) alkoxy alkyl (meth)acrylates; (vi) allyl alkyl (meth)acrylates such as allyl (meth)acrylate and allyl alkyl (meth)acrylate; and (vii) polyfunctional (meth)acrylates such as monoethylene glycol di(meth)acrylate, triethylene glycol di(meth)acrylate, and tetraethylene glycol di(meth)acrylate.

Examples of the hydroxyalkyl (meth)acrylates include: hydroxy straight-chain alkyl (meth)acrylates (particularly, hydroxy straight chain C1-6 alkyl (meth)acrylates) such as 2-hydroxyethyl (meth)acrylates, hydroxypropyl (meth)acrylates, and 4-hydroxybutyl (meth)acrylates; caprolactone-modified hydroxy (meth)acrylates; hydroxy branching alkyl (meth)acrylates such as α-(hydroxymethyl) methyl acrylates and α-(hydroxymethyl) ethyl acrylates; and hydroxyl-group-containing (meth)acrylates such as mono (meth)acrylates of a polyester diol (particularly, saturated polyester diol) obtained from a dicarboxylic acid (e.g., phthalic acid) and a dihydric alcohol (e.g., propylene glycol).

These (meth)acrylate-based monomers may be used alone or in combination of two or more. As the (meth)acrylate-based unit, it is preferable to select at least one type selected from the group consisting of ethyl (meth)acrylate units, butyl (meth)acrylate units, and 2-ethylhexyl (meth)acrylate units.

Examples of the vinyl-based monomer which differs from the (meth)acrylate-based monomers and which is copolymerizable with the (meth)acrylate-based monomers include: (i) vinyl arenes such as styrene, α-methylstyrene, monochlorostyrene, and dichlorostyrene; (ii) vinyl carboxylic acids such as acrylic acid and methacrylic acid; (iii) vinyl cyanides such as acrylonitrile and methacrylonitrile; (iv) halogenated vinyls such as vinyl chloride, vinyl bromide, and chloroprene; (v) vinyl acetate; (vi) alkenes such as ethylene, propylene, butylene, and isobutylene; and (vii) polyfunctional monomers such as diallyl phthalate, triallyl cyanurate, triallyl isocyanurate, and divinylbenzene.

One type of the examples of the vinyl-based monomer that differs from the (meth)acrylate-based monomers and is copolymerizable with the (meth)acrylate-based monomers may be used alone, or two or more types of the examples of the vinyl-based monomer which differs from the (meth)acrylate-based monomers and which is copolymerizable with the (meth)acrylate-based monomers may be used in combination. As the vinyl-based monomer which differs from the (meth)acrylate-based monomers and which is copolymerizable with the (meth)acrylate-based monomers, styrene is particularly preferable in that styrene makes it possible to easily increase a refractive index.

### (Organosiloxane-Based Rubber)

Examples of the organosiloxane-based rubber include: (i) polysiloxane-based polymers composed of alkyl or aryl disubstituted silyloxy units, such as dimethylsilyloxy, diethylsilyloxy, methylphenylsilyloxy, diphenylsilyloxy, and dimethylsilyloxy-diphenylsilyloxy; and (ii) polysiloxane-based polymers composed of alkyl or aryl monosubstituted silyloxy units, such as organohydrogensilyloxy in which some of sidechain alkyls have been substituted with hydrogen atoms.

One type of these polysiloxane-based polymers may be used alone, or two or more types of these polysiloxane-based polymers may be used in combination. Among these, dimethylsilyloxy, methylphenylsilyloxy, and dimethylsilyloxy-diphenylsilyloxy are preferable because they can provide heat resistance to a cured product, and dimethylsilyloxy is most preferable because it is easily available.

A case where the core layer of the polymer particles contains diene-based rubber or is composed only of diene-based rubber (hereinafter referred to as “Case A”) will be described. In Case A, the diene-based rubber may contain butadiene rubber and/or butadiene-styrene rubber. According to this configuration, there are advantages of (i) the cured product obtained by curing the composition being excellent in toughness, (ii) the cured product being excellent in impact resistance, and (iii) the low affinity with component (A) making it less likely for the core layer to swell and cause an increase in viscosity over time. From the viewpoints of such advantages, in Case A, the diene-based rubber may contain 60 parts by mass or more, 70 parts by mass or more, 80 parts by mass or more, or 90 parts by mass or more of butadiene rubber, butadiene-styrene rubber, or a mixture of butadiene rubber and butadiene-styrene rubber in 100 parts by mass of the diene-based rubber. In Case A, the diene-based rubber may be composed only of butadiene rubber and/or butadiene-styrene rubber. The core layer of the polymer particles may be composed only of butadiene rubber and/or butadiene-styrene rubber.

In order to increase the toughness of a resulting cured product, the core layer may have a glass transition temperature (hereinafter may also be referred to simply as “Tg”) of 0 °C or less, −20 °C or less, −40 °C or less, or −60 °C or less. The glass transition temperature of the core layer can be measured by differential scanning calorimetry (DSC).

The volume-average particle size of the core layer is not particularly limited, but may be 0.03 μm to 2.00 μm, 0.05 μm to 1.00 μm, 0.12 μm to 0.50 μm, 0.12 μm to 0.28 μm, or 0.14 μm to 0.25 μm. In a case where the volume-average particle size of the core layer is within this range, it is possible to produce the core layer stably, a cured product can have favorable heat resistance and favorable toughness. A method of measuring the volume-average particle size of the core layer will be described in detail in Examples later.

The core layer may have a single-layer structure. Alternatively, the core layer may have a multilayer structure (for example, multilayer structure consisting of layers having rubber elasticity). Further, in a case where the core layer has a multilayer structure, the layers may have differing polymer compositions within the scope of the disclosure.

The composition of the structural units of the core layer depends on the composition of the monomer mixture used for forming the core layer (monomer mixture for core layer formation). When the polymerization conversion rate is 100%, the resulting core layer contains structural units derived from all the monomers included in the monomer mixture for core layer formation.

In one or more embodiments of the present invention, for example, an intermediate layer described in paragraphs [0046] to [0049] in the pamphlet of WO 2016/163491 can be provided between the core layer and the shell layer.

### <<Shell Layer>>

The shell layer is a polymer obtained by polymerizing a monomer for shell layer formation. The polymer (shell polymer) constituting the shell layer serves to improve compatibility between the polymer particles and the component (A) and enable the polymer particles to be dispersed in the form of primary particles in the composition and/or in a cured product of the composition.

The type and proportion of structural unit included in the shell layer are not particularly limited. In terms of compatibility and dispersibility of the polymer particles in the composition, the shell layer may contain at least one type of structural unit selected from the group consisting of an aromatic vinyl-based unit, a vinyl cyanide-based unit, and a (meth)acrylate-based unit, or may contain a (meth)acrylate-based unit. The shell layer may contain methyl methacrylate units.

The composition of the structural units of the shell layer depends on the composition of the monomer for shell layer formation. When the polymerization conversion rate is 100%, the resulting shell layer contains structural units derived from all the monomers included in the monomer for shell layer formation.

A total contained amount of at least one type of structural unit selected from the group consisting of an aromatic vinyl-based unit, a vinyl cyanide-based unit, and a (meth)acrylate-based unit in the shell layer may be 10.0% by mass to 99.5% by mass, 50.0% by mass to 99.0% by mass, 65.0% by mass to 98.0% by mass, 67.0% by mass to 80.0% by mass, or 67.0% by mass to 85.0% by mass, in 100% by mass of the shell layer (shell polymer).

Specific examples of the aromatic vinyl-based monomer that gives rise to the aromatic vinyl-base unit include vinylbenzenes such as styrene, a-methylstyrene, p-methylstyrene, and divinylbenzene.

Specific examples of the vinyl cyanide-based monomer that gives rise to the vinyl cyanide-based unit include acrylonitrile and methacrylonitrile.

Specific examples of the (meth)acrylate-based monomer that gives rise to the (meth)acrylate-based unit are the same as those described in the section under <<Core Layer>> above. Therefore, the description is incorporated herein by reference and omitted here.

To maintain a good dispersion state of the polymer particles in the cured product and composition without aggregation, it is preferable to chemically bond the polymer particles with the component (A). To chemically bond the polymer particles with the component (A), the shell layer may have structural units derived from reactive group-containing monomers. In other words, the shell layer may contain a reactive group.

For example, the reactive group may be at least one type selected from the group consisting of an epoxy group, an oxetane group, a hydroxy group, an amino group, an imide group, a carboxylic acid group, a carboxylic anhydride group, a cyclic ester, a cyclic amide, a benzoxazine group, and a cyanate ester group.

The reactive group may be an epoxy group. In other words, the shell layer may have a structural unit derived from a monomer having an epoxy group, that is, the shell layer may have an epoxy group. When the shell layer of the polymer particles has an epoxy group, the cured product obtained by curing the composition has the advantage of excellent toughness.

Specific examples of the monomer having an epoxy group include glycidyl-group-containing vinyl monomers such as glycidyl (meth)acrylates, 4-hydroxybutyl (meth)acrylate glycidyl ethers, and allyl glycidyl ethers.

When the shell layer of the polymer particles has an epoxy group, the contained amount of the epoxy group in the shell layer with respect to the total mass of the shell layer of the polymer particles may be more than 0.0 mmol/g and 5.0 mmol/g or less, 0.1 mmol/g or more and 5.0 mmol/g or less, 0.2 mmol/g or more and 5.0 mmol/g or less, 0.2 mmol/g or more and 4.0 mmol/g or less, 0.2 mmol/g or more and 3.0 mmol/g or less, 0.2 mmol/g or more and 2.0 mmol/g or less, or 0.3 mmol/g or more and 1.5 mmol/g or less. According to this configuration, the aggregation of the polymer particles is suppressed, allowing the polymer particles to be dispersed in the form of primary particles in the cured product, resulting in the advantage that the cured product obtained by curing the composition has excellent toughness.

The monomer having an epoxy group may be used in the formation of the shell layer, or may be used only to form the shell layer. In other words, the core layer and the intermediate layer need not have an epoxy group.

From the viewpoints of storage stability of the composition, the shell layer of the polymer particles need not have an epoxy group.

Specific examples of a monomer having a hydroxyl group as the reactive group-containing monomer include the above-described hydroxyalkyl (meth)acrylates.

The shell layer may contain a structural unit derived from a polyfunctional monomer having two or more radical polymerizable double bonds, because such a shell layer prevents swelling of the polymer particles in a composition and allows the composition to tend to have a low viscosity and favorable handleability. However, from the viewpoints of the toughness improvement effect of a resulting cured product and the impact resistance improvement effect of the resulting cured product, the shell layer need not contain a structural unit derived from a polyfunctional monomer having two or more radical polymerizable double bonds.

Specific examples of the polyfunctional monomer do not include conjugated diene-based monomers such as butadiene and include: allyl alkyl (meth)acrylates such as allyl (meth)acrylate and allyl alkyl (meth)acrylate; allyl oxyalkyl (meth)acrylates; polyfunctional (meth)acrylates that have two or more (meth)acrylic groups such as (poly)ethylene glycol di(meth)acrylate, butanediol di(meth)acrylate, ethylene glycol di(meth)acrylate, triethylene glycol di(meth)acrylate, and tetraethylene glycol di(meth)acrylate; and diallyl phthalate, triallyl cyanurate, triallyl isocyanurate, and divinylbenzene.

Among these polyfunctional monomers, allyl methacrylate and triallyl isocyanurate are preferable.

For example, the shell layer may be a polymer that is composed only of the following structural units: (a) 0% by mass to 50% by mass (0% by mass to 35% by mass, or 0% by mass to 20% by mass) of an aromatic vinyl-based unit (or styrene unit); (b) 0% by mass to 50% by mass (0% by mass to 30% by mass, or 0% by mass to 20% by mass) of a vinyl cyanide-based unit (or acrylonitrile unit); (c) 0% by mass to 100% by mass (5% by mass to 100% by mass, or 70% by mass to 95% by mass) of a structural unit derived from a (meth)acrylate-based unit ((i) at least one type of structural unit selected from the group consisting of methyl acrylate unit, butyl acrylate unit, and methyl methacrylate unit, or (ii) methyl methacrylate unit); and (d) 0% by mass to 50% by mass (1% by mass to 35% by mass, or 3% by mass to 20% by mass) of a structural unit derived from a monomer having an epoxy group (particularly, glycidyl methacrylate unit). Note, however, that (i) a total of the aromatic vinyl-based unit, the vinyl cyanide-based unit, the (meth)acrylate-based unit, and the structural unit derived from a monomer having an epoxy group is 100% by mass, and that (ii) 0% by mass is intended to mean that a structural unit concerned may not be included.

One type of the above-described monomer components may be used alone, or two or more types of the above-described monomer components may be used in combination. The shell layer may contain a structural unit derived from a monomer which differs from the above-described monomers.

The shell layer may have a single-layer structure. Alternatively, the shell layer may have a multilayer structure. Further, in a case where the shell layer has a multilayer structure, layers of the multilayer structure may have differing polymer compositions within the scope of the disclosure.

The component (B) may contain at least one type of polymer particle selected from the group consisting of the following polymer particles (B-1), polymer particles (B-2), and polymer particles (B-3):

### Polymer Particles (B-1):

polymer particles in which the shell layer has an epoxy group, and a contained amount of the epoxy group in the shell layer with respect to a total mass of the shell layer is 0.2 mmol/g to 5.0 mmol/g,

### Polymer Particles (B-2):

polymer particles in which the core layer is diene-based rubber obtained by polymerizing a monomer mixture (monomer mixture for core layer formation) (for example, composed only of diene-based rubber obtained by polymerizing the monomer mixture) containing (b1) a conjugated diene-based monomer in an amount of 50.00% by mass to 99.99% by mass, (b2) a vinyl-based monomer that is copolymerizable with the conjugated diene-based monomer, in an amount of 0.00% by mass to 49.99% by mass, and (b3) a chain transfer agent in an amount of 0.01% by mass to 3.00% by mass, where a total of the conjugated diene-based monomer (b1), the vinyl-based monomer (b2) that is copolymerizable with the conjugated diene-based monomer, and the chain transfer agent (b3) is 100% by mass; Polymer particles (B-3):
polymer particles in which the core layer is diene-based rubber obtained by polymerizing a monomer mixture (monomer mixture for core layer formation) (for example, composed only of diene-based rubber obtained by polymerizing the monomer mixture) containing (b1) a conjugated diene-based monomer in an amount of 50.00% by mass to 99.99% by mass, (b2) a vinyl-based monomer that is copolymerizable with the conjugated diene-based monomer, in an amount of 0.00% by mass to 49.99% by mass, and (b3) a chain transfer agent in an amount of 0.01% by mass to 3.00% by mass, and a total of the conjugated diene-based monomer (b1), the vinyl-based monomer (b2) that is copolymerizable with the conjugated diene-based monomer, and the chain transfer agent (b3) is 100% by mass, and the shell layer has an epoxy group, and the contained amount of the epoxy group in the shell layer is 0.2 mmol/g to 5.0 mmol/g with respect to the total mass of the shell layer.

The polymer particles (B-1) are polymer particles with a shell layer having a specific configuration, the polymer particles (B-2) are polymer particles with a core layer having a specific configuration, and the polymer particles (B-3) are polymer particles with both the shell layer and core layer having specific configurations. The specific configuration of the shell layer of the polymer particles (B-3) is the same as the specific configuration of the shell layer of the polymer particles (B-1). The specific configuration of the core layer of the polymer particles (B-3) is the same as the specific configuration of the core layer of the polymer particles (B-2). In the present description, the polymer particles corresponding to the polymer particles (B-3) are excluded from the ranges of polymer particles (B-1) and polymer particles (B-2), and does not fall under either polymer particles (B-1) or polymer particles (B-2).

When the component (B) contains at least one type of polymer particle selected from the group consisting of the polymer particles (B-1), the polymer particles (B-2), and the polymer particles (B-3), it has the advantage that the cured product obtained by curing the composition has excellent toughness.

The core layer of the polymer particles (B-1) may contain at least one type selected from the group consisting of diene-based rubber, (meth)acrylate-based rubber, and organosiloxane-based rubber, may contain at least one type selected from the group consisting of diene-based rubber and (meth)acrylate-based rubber, or may contain diene-based rubber. According to this configuration, it has the advantage that the cured product obtained by curing the composition has excellent toughness.

The core layer of polymer particles (B-1) may contain 60 parts by mass or more, 70 parts by mass or more, 80 part by mass or more, or 90 parts by mass or more of at least one type selected from the group consisting of diene-based rubber, (meth)acrylate-based rubber, and organosiloxane-based rubber in 100 parts by mass of the core layer. According to this configuration, it has the advantage that the cured product obtained by curing the composition has more excellent toughness. The core layer of the polymer particles (B-1) may be composed of at least one type selected from the group consisting of diene-based rubber, (meth)acrylate-based rubber, and organosiloxane-based rubber, and may be composed only of at least one type selected from that group.

In the polymer particles (B-2) and polymer particles (B-3), the monomer mixture used for forming the core layer (monomer mixture for core layer formation) contains a chain transfer agent. The core layer obtained by polymerizing the monomer mixture for core layer formation containing a chain transfer agent has the advantage that the cured product obtained by curing the composition has excellent toughness.

As the chain transfer agent, any known chain transfer agent can be used without particular limitation. Specific examples of chain transfer agents include t-dodecyl mercaptan, n-dodecyl mercaptan, normal octyl mercaptan, and thioglycolic acid 2-ethylhexyl.

In the polymer particles (B-2) and polymer particles (B-3), the amount of the chain transfer agent in the monomer mixture for core layer formation may be 0.01% by mass to 3.00% by mass, 0.10% by mass to 2.00% by mass, 0.20% by mass to 1.00% by mass, 0.25% by mass to 0.70% by mass, or 0.30% by mass to 0.50% by mass in 100% by mass of the monomer mixture for core layer formation. According to this configuration, it has the advantage that the cured product obtained by curing the composition has excellent toughness.

The diene-based rubber obtained by polymerizing a monomer mixture containing (bi) a conjugated diene-based monomer, (b2) a vinyl-based monomer copolymerizable with conjugated diene-based monomer, and (b3) a chain transfer agent contains a structural unit derived from the conjugated diene-based monomer, a structural unit derived from the vinyl-based monomer copolymerizable with conjugated diene-based monomer, and a structural unit derived from the decomposition products of the chain transfer agent, in other words, a structural unit derived from the chain transfer agent. When the polymerization conversion rate is 100%, the contained amount of the structural unit derived from the conjugated diene-based monomer, the structural unit derived from the vinyl-based monomer copolymerizable with conjugated diene-based monomer, and the structural unit derived from the chain transfer agent in the diene-based rubber obtained by polymerizing the monomer mixture containing (b1) the conjugated diene-based monomer, (b2) the vinyl-based monomer copolymerizable with conjugated diene-based monomer, and (b3) the chain transfer agent can be regarded as the same as the contained amount of (b1) the conjugated diene-based monomer, (b2) the vinyl-based monomer copolymerizable with conjugated diene-based monomer, and (b3) the chain transfer agent contained in the monomer mixture. Therefore, the core layer in polymer particles (B-2) and polymer particles (B-3) can be said to be diene-based rubber containing structural units derived from (b1′) conjugated diene-based monomer in an amount of 50.00% by mass to 99.99% by mass, structural units derived from (b2′) vinyl-based monomer copolymerizable with conjugated diene-based monomer in an amount of 0.00% by mass to 49.99% by mass, and structural units derived from (b3) chain transfer agent in an amount of 0.01% by mass to 3.00% by mass.

The contained amount of the polymer particles (B-1) in the component (B) is not particularly limited. The contained amount of the polymer particles (B-1) in the component (B) may be 60 parts by mass or more, 70 parts by mass or more, 80 parts by mass or more, 90 parts by mass or more, or 95 parts by mass or more in 100 parts by mass of the component (B). The contained amount of the polymer particles (B-1) in the component (B) may be 100 parts by mass in 100 parts by mass of the component (B). In other words, the component (B) may be composed only of the polymer particles (B-1).

The contained amount of the polymer particles (B-2) in the component (B) is not particularly limited. The contained amount of the polymer particles (B-2) in the component (B) may be 60 parts by mass or more, 70 parts by mass or more, 80 parts by mass or more, 90 parts by mass or more, or 95 parts by mass or more in 100 parts by mass of the component (B). The contained amount of the polymer particles (B-2) in the component (B) may be 100 parts by mass in 100 parts by mass of the component (B). In other words, the component (B) may be composed only of polymer particles (B-2).

The contained amount of the polymer particles (B-3) in the component (B) is not particularly limited. The contained amount of the polymer particles (B-3) in the component (B) may be 60 parts by mass or more, 70 parts by mass or more, 80 parts by mass or more, 90 parts by mass or more, or 95 parts by mass or more in 100 parts by mass of the component (B). The contained amount of the polymer particles (B-3) in the component (B) may be 100 parts by mass in 100 parts by mass of the component (B). In other words, component (B) may be composed only of polymer particles (B-3).

### <<Volume-Average Particle Size (Mv) of Polymer Particles>>

The volume average particle diameter (Mv) of the polymer particles is not particularly limited. From the viewpoints of industrial productivity and workability of a curable resin composition, the volume-average particle size (Mv) of the polymer particles may be 0.01 μm or more and 2.00 μm or less, 0.03 μm or more and 0.60 μm or less, 0.05 μm or more and 0.40 μm or less, 0.10 μm or more and 0.30 μm or less, 0.15 μm or more and 0.30 μm or less, 0.16 μm or more and 0.28 μm or less, 0.17 μm or more and 0.27 μm or less, or 0.18 μm or more and 0.25 μm or less. In a case (a) where the volume-average particle size (Mv) of the polymer particles is 0.01 μm or more, a composition has a low viscosity, and thus favorable workability is achieved. In a case (b) where the volume-average particle size (Mv) of the polymer particles is 2.00 μm or less, a polymerization time of the polymer particles becomes short, and high industrial productivity is achieved. A method of measuring the volume-average particle size (Mv) of the polymer particles will be described in detail in Examples later.

In the composition, the polymer particles which are component (B) may be dispersed in the form of primary particles. In the present description, the “polymer particles are dispersed in a primary particle state” (hereinafter referred to as primary dispersion) means that the polymer particles are substantially independent from each other and are dispersed without adhering (or fusing) to each other. The dispersion state of the polymer particles in the composition can be confirmed, for example, by dissolving a portion of the composition in a solvent such as methyl ethyl ketone, subjecting the resulting solution to a particle size measurement device using laser light scattering, and measuring the particle size of the polymer particles in the solution.

Further, the “stable dispersion” of the polymer particles means a state in which the polymer particles are, under normal conditions, in a steady state of dispersion over a long period without aggregating, separating, or precipitating in a continuous layer. In addition, the distribution of the polymer particles in a continuous layer may remain substantially unchanged, and the “stable dispersion” of the polymer particles be maintained even when the composition containing the polymer particles is heated to a non-dangerous degree so as to lower the viscosity of the composition, and the composition is stirred.

One type of polymer particles may be used alone, or two or more types of polymer particles may be used in combination.

### <<Method for Producing Polymer Particles>>

### (Method for Producing Core Layer)

The core layer included in the polymer particles can be formed by, for example, a method such as an emulsion polymerization method, a suspension polymerization method, or a microsuspension polymerization method. As the method such as an emulsion polymerization method, a suspension polymerization method, or a microsuspension polymerization method, for example, the methods described in International Publication No. WO 2005/028546 and International Publication No. WO 2006/070664 can be utilized as appropriate.

w(Method for Forming Shell Layer and Intermediate Layer)

When the polymer particles include an intermediate layer, the intermediate layer can be formed by polymerizing a monomer for intermediate layer formation by known radical polymerization. In a case where a rubber elastic body to be included in the core layer is obtained as an emulsion, the monomer for intermediate layer formation may be polymerized by an emulsion polymerization method.

The shell layer can be formed by polymerizing, by known radical polymerization, a monomer for shell layer formation. In a case where the core layer or a polymer particle precursor in which the core layer is covered with the intermediate layer is obtained as an emulsion, the monomer for shell layer formation may be polymerized by an emulsion polymerization method. As the emulsion polymerization method, for example, the method described in International Publication No. WO 2005/028546 can be utilized as appropriate.

In the emulsion polymerization, an emulsifying agent (dispersion agent) is used.

Examples of the emulsifying agent include (i) anionic emulsifying agents (dispersion agents) such as (i-1) various acids including: alkyl or aryl sulfonic acids typified by dioctylsulfosuccinic acid, dodecylbenzenesulfonic acid, and the like; alkyl or arylether sulfonic acids; alkyl or arylsulfuric acids typified by dodecylsulfuric acids; alkyl or arylether sulfuric acids; alkyl or aryl-substituted phosphoric acids; alkyl or arylether-substituted phosphoric acids; N-alkyl or arylsarcosinic acids typified by dodecylsarcosinic acid; alkyl or arylcarboxylic acids typified by oleic acid, stearic acid, and the like; and alkyl or arylether carboxylic acids and (i-2) alkali metal salts or ammonium salts of these acids, (ii) nonionic emulsifying agents (dispersion agents) such as alkyl or aryl-substituted polyethylene glycols, and (iii) dispersion agents such as polyvinyl alcohols, alkyl-substituted celluloses, polyvinylpyrrolidone, and polyacrylic acid derivatives.

One type of these emulsifying agents (dispersion agents) may be used alone, or two or more types of these emulsifying agents (dispersion agents) may be used in combination.

A smaller used amount of the emulsifying agent (dispersion agent) is more preferable, as long as there is no negative effect on dispersion stability of an aqueous latex of the polymer particles. A higher water solubility of the emulsifying agent (dispersion agent) is more preferable. A high water solubility facilitates removal of the emulsifying agent (dispersion agent) by washing and makes it possible to easily prevent adverse effects on a cured product that is ultimately obtained.

In a case where the emulsion polymerization method is employed, for example, a peroxide (for example, an organic peroxide), a chain transfer agent, and a surfactant can be used as necessary.

As conditions of polymerization such as polymerization temperature, pressure, and deoxygenation, conditions within known ranges can be employed.

Since the cured product obtained by curing the composition has an excellent balance between toughness improvement effect and impact resistance, the composition may contain at least polymer particles as the component (B).

The contained amount of the component (B) in the composition may be 1 part by mass to 100 parts by mass, 3 parts by mass to 90 parts by mass, 5 parts by mass to 80 parts by mass, 10 parts by mass to 75 parts by mass, or 15 parts by mass to 70 parts by mass with respect to 100 parts by mass of the component (A). According to this configuration, the cured product obtained by curing the composition has the advantage of being excellent in the balance between toughness improvement effect and impact resistance.

### <1-1-4. Component (C)>

The component (C) is an acid anhydride (c1), an aromatic amine (c2), or an alicyclic amine (c3). In the composition, the component (C) can function as a curing agent. In other words, the composition contains an acid anhydride (c1), an aromatic amine (c2), or an alicyclic amine (c3) as a curing agent.

<<Acid Anhydride (c1)>>

A case where the component (C) is an acid anhydride (c1) (hereinafter referred to as case B) will be described. In case B, the viscosity of the resulting composition can be low and the pot life can be long. As a result, in case B, the composition has the advantage of excellent processability. In addition, in case B, there is the advantage that the composition cures even at relatively low temperatures due to the addition of a curing accelerator, the resulting cured product has relatively good balance in terms of electrical, chemical, and mechanical properties, and further, the amount of heat generated during curing is small, making it easier to create large molded products.

When the component (C) is an acid anhydride (c1), the component (C) need not contain aromatic amine (c2) and alicyclic amine (c3), and may be composed only of the acid anhydride (c1).

The acid anhydride (c1) is not particularly limited. Examples of the acid anhydride (c1) include the following substituted or unsubstituted compounds: 4-methylcyclohexane-1,2-dicarboxylic anhydride, polysebacic acid polyanhydride, polyazelaic acid polyanhydride, succinic anhydride, citraconic anhydride, itaconic anhydride, alkenyl-substituted succinic anhydride, octenyl succinic anhydride, dodecenyl succinic anhydride, maleic anhydride, tricarballylic anhydride, nadic anhydride, methyl nadic anhydride, hydrogenated methyl nadic anhydride, linoleic acid adducts of maleic anhydride, alkylated terminal alkylenetetrahydrophthalic anhydride, methyl tetrahydrophthalic anhydride, tetrahydrophthalic anhydride, hexahydrophthalic anhydride, methyl hexahydrophthalic anhydride, trialkyl tetrahydrophthalic anhydride, pyromellitic dianhydride, trimellitic anhydride, phthalic anhydride, tetrachlorophthalic anhydride, tetrabromophthalic anhydride, dichloromaleic anhydride, chloronadic anhydride, chlorendic anhydride, and maleic anhydride-grafted polybutadiene.

The acid anhydride (c1) (i) may contain at least one type selected from the group consisting of substituted or unsubstituted methyl nadic anhydride, substituted or unsubstituted hydrogenated methyl nadic anhydride, substituted or unsubstituted methyl tetrahydrophthalic anhydride, and substituted or unsubstituted methyl hexahydrophthalic anhydride, or may be composed only of at least one type selected from that group, (ii) may contain at least one type selected from the group consisting of substituted or unsubstituted methyl nadic anhydride, substituted or unsubstituted methyl tetrahydrophthalic anhydride, and substituted or unsubstituted methyl hexahydrophthalic anhydride, or may be composed only of at least one type selected from that group, (iii) may contain at least one type selected from the group consisting of substituted or unsubstituted methyl tetrahydrophthalic anhydride and substituted or unsubstituted methyl hexahydrophthalic anhydride, or may be composed only of at least one type selected from that group, or (iv) may contain substituted or unsubstituted methyl tetrahydrophthalic anhydride, or may be composed only of substituted or unsubstituted methyl tetrahydrophthalic anhydride. According to this configuration, the viscosity of the resulting composition is reduced, resulting in good impregnation into the fibers. As a result, there is the advantage of obtaining a cured product that is superior in toughness. The substituents are not particularly limited, and examples include hydrocarbon groups and alkoxy groups.

Moreover, since the viscosity of the resulting composition becomes particularly low, and the cured product obtained by curing the composition has excellent heat resistance, the acid anhydride (c1) may contain 4-methylcyclohexane-1,2-dicarboxylic anhydride, or is composed only of 4-methylcyclohexane-1,2-dicarboxylic anhydride.

### <<Aromatic Amine (c2)

When the component (C) is an aromatic amine (c2), there is the advantage that the cured product obtained by curing the composition has excellent heat resistance and high strength and/or toughness.

When the component (C) is an aromatic amine (c2), the component (C) need not contain acid anhydride (c1) and alicyclic amine (c3), and may be composed only of the aromatic amine (c2).

The aromatic amine (c2) is not particularly limited. Examples of the aromatic amine (c2) include 3,3′-dichloro-4,4′-diaminodiphenylmethane, 4,4′-diamino-3,3′-diethyl-5,5′-dimethyldiphenylmethane, trimethylene-bis(4-aminobenzoate), 2,4-diamino-3,5-diethyl toluene, 2,6-diamino-3,5-diethyl toluene, dimethylthiotoluenediamine, diamino diphenylmethane, diethyltoluenediamine, 4,4′-methylene-bis[N-(1-methylpropyl)aniline], 4,4′-diaminodiphenylsulfone, 3,3′-diaminodiphenylsulfone, 4,4′-diaminodiphenyl ether, 1,3-bis(3-amino phenoxy)benzene, aminobenzylamine, and meta-phenylenediamine.

The aromatic amine (c2) (i) may contain at least one type selected from the group consisting of diethyltoluenediamine, meta-phenylenediamine, diamino diphenylmethane, 2,4-diamino-3,5-diethyl toluene, 2,6-diamino-3,5-diethyl toluene, 3,3′-diaminodiphenylsulfone, and 4,4′-diaminodiphenylsulfone, or may be composed only of at least one type selected from that group, (ii) may contain at least one type selected from the group consisting of diethyltoluenediamine, meta-phenylenediamine, diamino diphenylmethane, 3,3′-diaminodiphenylsulfone, and 4,4′-diaminodiphenylsulfone, or may be composed only of at least one type selected from that group, (iii) may contain at least one type selected from the group consisting of diethyltoluenediamine, diamino diphenylmethane, and 4,4′-diaminodiphenylsulfone, or may be composed only of at least one type selected from that group, or (iv) may contain diethyltoluenediamine, or may be composed only of diethyltoluenediamine. According to this configuration, the viscosity of the composition becomes relatively low, the composition has excellent processability, and further, the cured product obtained by curing the composition has excellent toughness.

<<Alicyclic Amine (c3)>>

A case where alicyclic amine (c3) is used as a curing agent, in other words, a case where the component (C) is an alicyclic amine (c3) will be described. In this case, the curing speed of the composition increases, and curing can progress even at relatively low temperatures, and/or the curing can be completed in a relatively short time. Therefore, when the component (C) is an alicyclic amine (c3), it has the advantage of a short molding cycle for the cured product and excellent productivity. The alicyclic amine (c3) is a curing agent with a fast curing speed. On the other hand, the cured product obtained by curing a composition containing an alicyclic amine (c3) as the component (C) has the advantage of being relatively excellent heat-resistant and having high strength and/or toughness.

When the component (C) is an alicyclic amine (c3), the component (C) need not contain acid anhydride (c1) and aromatic amine (c2), and may be composed only of the alicyclic amine (c3).

Examples of the alicyclic amine (c3) are not particularly limited. Examples of the alicyclic amine (c3) include isophoronediamine, 1,3-bis(amino methyl)cyclohexane, 4,4′-methylene bis(cyclohexylamine), 4,4′-methylene bis(2-methylcyclohexylamine), aminoethylpiperazine, piperazine, and mensendiamine.

The alicyclic amine (c3) (i) may contain at least one type selected from the group consisting of isophoronediamine, 1,3-bis(amino methyl)cyclohexane, 4,4′-methylene bis(cyclohexylamine), 4,4′-methylene bis(2-methylcyclohexylamine), aminoethylpiperazine, piperazine, and mensendiamine, or may be composed only of at least one type selected from that group, (ii) may contain at least one type selected from the group consisting of isophoronediamine, 1,3-bis(amino methyl)cyclohexane, 4,4′-methylene bis(cyclohexylamine), 4,4′-methylene bis(2-methylcyclohexylamine), and aminoethylpiperazine, or may be composed only of at least one type selected from that group, (iii) may contain at least one type selected from the group consisting of isophoronediamine, 1,3-bis(amino methyl)cyclohexane, and 4,4′-methylene bis(cyclohexylamine), or may be composed only of at least one type selected from that group, or (iv) may contain at least one type selected from the group consisting of isophoronediamine and 4,4′-methylene bis(cyclohexylamine), or may be composed only of at least one type selected from that group. According to this configuration, it has the advantages of (i) low viscosity of the composition, making it excellent in processability, (ii) fast curing speed of the composition, leading to excellent productivity of the cured product, and (iii) toughness of the cured product obtained by curing the composition.

The contained amount of the component (C) in the composition may be 5 parts by mass to 200 parts by mass, 10 parts by mass to 200 parts by mass, 11 parts by mass to 170 parts by mass, 12 parts by mass to 150 parts by mass, 13 parts by mass to 130 parts by mass, or 15 parts by mass to 115 parts by mass with respect to 100 parts by mass of the component (A). According to this configuration, the cured product obtained by curing the composition has the advantage of excellent strength and toughness.

A case where the component (C) is an acid anhydride (c1) will be described. In this case, the contained amount of the component (C) in the composition may be 40 parts by mass to 200 parts by mass, 50 parts by mass to 170 parts by mass, 55 parts by mass to 150 parts by mass, 60 parts by mass to 130 parts by mass, or 65 parts by mass to 115 parts by mass with respect to 100 parts by mass of the component (A). According to this configuration, the cured product obtained by curing the composition has the advantage of excellent strength and toughness.

A case where the component (C) is an acid anhydride (c1) will be described. In this case, the contained amount of the component (C) in the composition may be set appropriately with respect to the molar mass of the epoxy group in the component (A) contained in the composition. In other words, when the component (C) is an acid anhydride (c1), a ratio of a molar mass of an acid anhydride group in the component (C) to a molar mass of an epoxy group in the component (A) contained in the composition (molar mass of acid anhydride group in component (C)/molar mass of epoxy group in component (A)) may be within a specific range. When the component (C) is an acid anhydride (c1), the ratio (molar mass of acid anhydride group in component (C)/molar mass of epoxy group in component (A)) may be 0.35 to 0.87, 0.40 to 0.87, 0.45 to 0.87, or 0.50 to 0.87. When the component (C) is an acid anhydride (c1) and the ratio (molar mass of acid anhydride group in component (C)/molar mass of epoxy group in component (A)) is 0.87 or less, it has the advantage that the value X of the composition tends to be 1.05 to 5.50. As a result, the obtained composition has the advantage of being able to provide a cured product that is superior in toughness. When the component (C) is an acid anhydride (c1) and the ratio (molar mass of acid anhydride group in component (C)/molar mass of epoxy group in component (A)) is 0.35 or more, the composition has the advantage of being able to provide a heat-resistant cured product, that is, a cured product with a high Tg.

A case where the component (C) is an aromatic amine (c2) will be described. In this case, the contained amount of the component (C) in the composition may be 10 parts by mass to 70 parts by mass, 11 parts by mass to 60 parts by mass, 12 parts by mass to 50 parts by mass, 13 parts by mass to 45 parts by mass, or 15 parts by mass to 40 parts by mass with respect to 100 parts by mass of the component (A). According to this configuration, the cured product obtained by curing the composition has the advantage of excellent strength and toughness.

A case where the component (C) is an aromatic amine (c2) will be described. In this case, the contained amount of the component (C) in the composition may be set appropriately with respect to the molar mass of the epoxy group in the component (A) contained in the composition. In other words, when the component (C) is an aromatic amine (c2), the ratio of the molar mass of active hydrogen atom of an amine in the component (C) to the molar mass of the epoxy group in the component (A) contained in the composition (molar mass of active hydrogen atom of amine in component (C)/molar mass of epoxy group in component (A)) may be within a specific range. When the component (C) is an aromatic amine (c2), the ratio (molar mass of active hydrogen atom of amine in component (C)/molar mass of epoxy group in component (A)) may be 0.67 to 0.87, 0.67 to 0.85, 0.67 to 0.83, or 0.68 to 0.82. Alternatively, when the component (C) is an aromatic amine (c2), the ratio (molar mass of active hydrogen atom of amine in component (C)/molar mass of epoxy group in component (A)) may be 1.10 to 2.40, 1.25 to 2.30, 1.45 to 2.20, 1.55 to 2.15, or 1.85 to 2.10. According to this configuration, it has the advantage that the value X of the composition tends to be 1.30 to 9.00. As a result, the obtained composition has the advantage of being able to provide a cured product that is superior in toughness. Moreover, according to this configuration, the composition also has the advantage of being able to provide a cured product that excels in heat resistance, namely a cured product with a high Tg.

A case where the component (C) is an alicyclic amine (c3) will be described. In this case, the contained amount of the component (C) in the composition may be 5 parts by mass to 200 parts by mass, 5 parts by mass to 70 parts by mass, 7 parts by mass to 60 parts by mass, 9 parts by mass to 50 parts by mass, 11 parts by mass to 45 parts by mass, 13 parts by mass to 40 parts by mass, or 15 parts by mass to 35 parts by mass with respect to 100 parts by mass of the component (A). According to this configuration, the cured product obtained by curing the composition has the advantage of excellent strength and toughness.

A case where the component (C) is an alicyclic amine (c3) will be described. In this case, the contained amount of the component (C) in the composition may be set appropriately with respect to the molar mass of the epoxy group in the component (A) contained in the composition. In other words, when the component (C) is an alicyclic amine (c3), the ratio of the molar mass of active hydrogen atom of an amine in the component (C) to the molar mass of the epoxy group in the component (A) contained in the composition (molar mass of active hydrogen atom of amine in component (C)/molar mass of epoxy group in component (A)) may be within a specific range. When the component (C) is an alicyclic amine (c3), the ratio (molar mass of active hydrogen atom of amine in component (C)/molar mass of epoxy group in component (A)) may be 0.67 to 0.87, 0.67 to 0.85, 0.67 to 0.83, or 0.68 to 0.82. Alternatively, when the component (C) is an alicyclic amine (c3), the ratio (molar mass of active hydrogen atom of amine in component (C)/molar mass of epoxy group in component (A)) may be 1.10 to 2.40, 1.25 to 2.30, 1.45 to 2.20, 1.55 to 2.15, or 1.85 to 2.10. According to this configuration, it has the advantage that the value X of the composition tends to be 1.30 to 9.00. As a result, the obtained composition has the advantage of being able to provide a cured product that is superior in toughness. Moreover, according to this configuration, the composition also has the advantage of being able to provide a cured product that excels in heat resistance, namely a cured product with a high Tg.

### <1-1-5. Component (D)>

The component (D) is a curing accelerator. In the present description, the “curing accelerator” refers to a substance that can promote the curing of the composition. The curing accelerator can, for example, function as a catalyst to promote the reaction between epoxy groups contained in the component (A) or the reaction between an epoxy group contained in the component (A) and an epoxy group contained in the component (C) or other components.

The component (D) is not particularly limited. Examples of the component (D) include, (a) ureas such as 3-(3,4-dichlorophenyl)-1,1-dimethylurea, p-chlorophenyl-N,N-dimethylurea (trade name: Monuron), 3-phenyl-1,1-dimethylurea (trade name: Fenuron), 3,4-dichlorophenyl-N,N-dimethylurea (trade name: Diuron), N-(3-chloro-4-methylphenyl)-N′,N′-dimethylurea (trade name: Chlortoluron), and 1,1-dimethylphenylurea (trade name: Dyhard); (b) tertiary amines such as benzyl dimethyl amine, 2,4,6-tris(dimetylaminomethyl)phenol, 2-(dimethylaminomethyl)phenol, 2,4,6-tris(dimetylaminomethyl)phenol incorporated into a poly(p-vinylphenol) matrix, triethylene diamine, and N,N-dimethylpiperazine; (c) imidazoles such as alkylene imidazoles with 1 to 12 carbon atoms (C1-C12), N-aryl imidazoles, 2-methylimidazole, 1,2-dimethylimidazole, 2-ethyl-4-methylimidazole, N-butyl imidazole, 2-undecyl imidazole, 1-(2-cyanoethyl)-2-ethyl-4-methylimidazole, 1-cyanoethyl-2-undecylimidazolium trimellitate, and addition products of epoxy resins and imidazoles; (d) Lewis acid amine complexes such as boron trifluoride amine complexes and boron trichloride amine complexes; and (e) 6-caprolactam. The component (D) may be encapsulated in microcapsules or may be a substance that can function as a latent catalyst that becomes active only when the temperature is raised. A latent curing accelerator obtained by microencapsulating imidazoles or tertiary amines can also be used as the component (D). As such a latent curing accelerator, commercially available products (for example, Novacure HX-3722, Novacure HX-3742, Novacure HX-3088, or the like manufactured by Asahi Kasei Corporation) can be used. The component (D) may be used alone or in combination with two or more types.

Among the above, the component (D) (i) may contain at least one type selected from the group consisting of (b) tertiary amines such as 2,4,6-tris(dimetylaminomethyl)phenol, triethylene diamine, N,N-dimethylpiperazine, and (c) imidazoles such as 1,2-dimethylimidazole, 2-ethyl-4-methylimidazole, 2-undecylimidazole, 1-(2-cyanoethyl)-2-ethyl-4-methylimidazole, or may be composed only of at least one type selected from that group, (ii) may contain at least one type selected from the group consisting of 2,4,6-tris(dimetylaminomethyl)phenol and 2-ethyl-4-methylimidazole, or may be composed only of at least one type selected from that group.

When the component (C) is an acid anhydride (c1), the composition may contain the component (D). When the component (C) is an aromatic amine (c2) or an alicyclic amine (c3), the composition may contain or may not contain the component (D).

When the composition contains the component (D), the contained amount of the component (D) in the composition may be 0.1 parts by mass to 20.0 parts by mass, 0.2 parts by mass to 16.0 parts by mass, 0.5 parts by mass to 13.0 parts by mass, 1.0 part by mass to 10.0 parts by mass, or 2.0 parts by mass to 8.0 parts by mass with respect to 100 parts by mass of the component (A). According to this configuration, there is the advantage of being able to sufficiently promote the curing of the composition.

### <1-1-6. Other Formulation Components>

The composition may contain other components as necessary. Other components include, but are not limited to, reinforcing agents such as epoxy unmodified rubber-based polymers, inorganic fillers such as silicates and/or silicate salts, calcium oxide, radically curable resins, photopolymerization initiators, expanding agents such as azo-type chemical foaming agents and/or thermally expandable microballoons, coloring agents such as pigments and/or dyes, extenders, ultraviolet absorbers, antioxidants, stabilizers (antigelling agents), plasticizers, leveling agents, defoaming agents, silane coupling agents, antistatic agents, flame retardants, lubricants, viscosity reducers, shrinkage reducing agents, organic fillers, thermoplastic resins, desiccants, and dispersion agents.

### <1-1-7. Value X>

The value X of the composition varies depending on the component (C). When the component (C) is an acid anhydride (c1), the value X is 1.05 to 5.50. According to this configuration, the composition can provide a cured product with excellent toughness. Since the cured product excels in toughness, when the component (C) is an acid anhydride (c1), the value X may be 1.05 to 5.00, 1.05 to 4.50, 1.06 to 4.25, or 1.07 to 4.00.

When the component (C) is an aromatic amine (c2) or an alicyclic amine (c3), the value X is 1.30 to 9.00. According to this configuration, the composition can provide a cured product with excellent toughness. Since the cured product excels in toughness, when the component (C) is an aromatic amine (c2) or an alicyclic amine (c3), the value X may be 1.35 to 8.75, 1.40 to 8.50, 1.45 to 8.25, or 1.50 to 8.00.

The value X of the composition can be adjusted by changing the factors such as (i) the ratio of a molar mass of an acid anhydride group in the component (C) to a molar mass of an epoxy group in the component (A) contained in the composition (molar mass of acid anhydride group in component (C)/molar mass of epoxy group in component (A)), (ii) the ratio of a molar mass of active hydrogen atom of an amine in the component (C) to a molar mass of an epoxy group in the component (A) contained in the composition (molar mass of active hydrogen atom of amine in component (C)/molar mass of epoxy group in component (A)), (iii) the average epoxy equivalent weight of the epoxy group-containing substance (A) contained in the composition, (iv) the average acid anhydride equivalent weight of the acid anhydride (c1) contained in the composition, the average active hydrogen atom equivalent weight of amine in the aromatic amine (c2) contained in the composition, or the average active hydrogen atom equivalent weight of amine in the alicyclic amine (c3) contained in the composition, (v) the amount of polyfunctional epoxy group-containing substance (a1) having an epoxy equivalent weight of 300 g/eq or more and less than 3000 g/eq, and having two or more epoxy groups per molecule contained in the composition, (vi) the amount of monofunctional epoxy group-containing substance (a2) having one epoxy group per molecule contained in the composition, (vii) the average number of epoxy groups per molecule of the epoxy group-containing substance (A) contained in the composition, (viii) the average number of acid anhydride groups per molecule of the acid anhydride (c1) contained in the composition, the average number of active hydrogen atom of amine per molecule of the aromatic amine (c2) contained in the composition, or the average number of active hydrogen atom of amine per molecule of the alicyclic amine (c3) contained in the composition, and (ix) the type and amount of curing accelerator (D) contained in the composition.

In calculating the value X, the curing conditions (for example, curing temperature, curing time, and the thickness of the composition before curing) of the composition (M) to obtain the cured product (M) by curing the composition (M) and the curing conditions of the composition (Meq) to obtain the cured product (Meq) by curing the composition (Meq) should be the same.

### <1-1-8. Value Y>

The value Y of the composition can reflect the molecular weight between crosslinking points of the composition. The value Y of the composition may be 22 to 400, 25 to 360, 30 to 320, 35 to 280, or 40 to 200. The larger the value Y, the resulting cured product has the advantage of superior elongation properties. The smaller the value Y, the resulting cured product has the advantage of superior strength and heat resistance.

The value Y of the composition can be adjusted by changing the factors such as (i) the average epoxy equivalent weight of the epoxy group-containing substance (A) contained in the composition, (ii) the average acid anhydride equivalent weight of the acid anhydride (c1) contained in the composition, the average active hydrogen atom equivalent weight of amine in the aromatic amine (c2) contained in the composition, or the average active hydrogen atom equivalent weight of amine in the alicyclic amine (c3) contained in the composition, (iii) the amount of polyfunctional epoxy group-containing substance (a1) having an epoxy equivalent weight of 300 g/eq or more and less than 3000 g/eq, and having two or more epoxy groups per molecule contained in the composition, (iv) the amount of monofunctional epoxy group-containing substance (a2) having one epoxy group per molecule contained in the composition, (v) the average number of epoxy groups per molecule of the epoxy group-containing substance (A) contained in the composition, (vi) the average number of acid anhydride groups per molecule of the acid anhydride (c1) contained in the composition, the average number of active hydrogen atoms of amine per molecule of the aromatic amine (c2) contained in the composition, or the average number of active hydrogen atoms of amine per molecule of the alicyclic amine (c3) contained in the composition, (vii) the type and amount of curing accelerator (D) contained in the composition, and (viii) the amount of acid anhydride (c1) contained in the composition, the amount of aromatic amine (c2) contained in the composition, or the amount of alicyclic amine (c3) contained in the composition.

### <1-1-9. Viscosity of Curable Resin Composition>

Since the composition excels in impregnation into fibers, the composition may have a viscosity at 25 °C of 5000 mPa-s or less, 4000 mPa-s or less, 3000 mPa-s or less, 2500 mPa-s or less, 2000 mPa-s or less, 1000 mPa-s or less, or 800 mPa-s or less. Similarly, since the composition excels in impregnation into fibers, the composition may have a viscosity at 50 °C of 1000 mPa-s or less, 800 mPa-s or less, 500 mPa-s or less, 300 mPa-s or less, or 200 mPa-s or less.

The composition can also be used after being heated to, for example, a temperature of 40 °C to 100 °C, 40 °C to 90 °C, or 50 °C to 80 °C, within a range where a balance between sufficient viscosity reduction (such as 200 mPa-s or less) and sufficient working time until curing is achieved.

### [1-2. Curable Resin Composition Satisfying at Least (2)]

The following describes the curable resin composition satisfying at least the (2).

### <1-2-1. Technical Idea Regarding Curable Resin Composition Satisfying at Least (2)>

Conventional curable resin compositions have had room for further improvement in terms of toughness. Thus, the present inventors have conducted diligent research with the aim of providing a novel curable resin composition that can provide a cured product with excellent toughness.

In a curable resin composition containing an epoxy group-containing substance (for example, epoxy resin), the higher the number of epoxy groups contained per molecule of the epoxy group-containing substance, the higher the crosslink density of the cured product. Furthermore, when comparing substances with the same number of epoxy groups contained per molecule of the epoxy group-containing substance, the lower the molecular weight of the epoxy group-containing substance, the higher the crosslink density of the cured product, and the higher the molecular weight of the epoxy group-containing substance, the lower the crosslink density of the cured product. The higher the crosslink density of the cured product, the smaller the molecular weight between crosslinking points of the cured product. For example, a curable resin composition containing a large amount of polyfunctional epoxy group-containing substances as the epoxy group-containing substance has a high crosslink density of the cured product, or in other words, it can be said that the molecular weight between crosslinking points of the cured product is small.

As a result of diligent research, the present inventors have independently obtained a novel finding that by setting the molecular weight between crosslinking points of the cured product within a specific range and using polymer particles, the toughness of the cured product is remarkably improved.

The molecular weight between crosslinking points of the cured product can be determined from the theory of rubber elasticity of crosslinked rubber, for example, by the following formula:

Molecular weight between crosslinking points=2×(1+μ)×ρ×R×T/E=ρ×R×T/G

In the formula, μ represents the Poisson's ratio of the cured product, ρ represents the specific gravity of the cured product, R represents the gas constant, T represents the absolute temperature (K), and E and G represent the Young's modulus and shear modulus of the cured product in the rubbery region. The rubbery region refers to the region observed on the high-temperature side of the transition region near the glass transition temperature when measuring the temperature dependence of elasticity (such as Young's modulus and shear modulus), representing a region where the temperature dependence of elasticity is flat. Crosslinked polymers such as epoxy resin cured products do not have a flow region on the high-temperature side of the rubbery region, so that E and G in the formula can be expressed as the minimum values of Young's modulus and shear modulus in the rubbery region. Furthermore, since the Young's modulus in the rubbery region is generally equal to the storage modulus obtained by the convenient dynamic viscoelastic measurement, the molecular weight between crosslinking points can be determined by the following formula:

Molecular weight between crosslinking points=2×(1+μ)×ρ×R×(273+Tmin)/E′min

In the formula, μ represents the Poisson's ratio of the cured product, ρ represents the specific gravity of the cured product, R represents the gas constant, E′min represents the minimum value of the storage modulus of the cured product, and Tmin represents the temperature (°C) at which the storage modulus of the cured product reaches its minimum value.

The molecular weight between crosslinking points of the cured product (α) obtained by curing a curable resin composition (a) containing an epoxy group-containing substance (component (A)), polymer particles (component (B)), a curing agent (component (C)), and a curing accelerator (component (D)) can be expressed by the following formula:

Molecular weight between crosslinking points of the cured product(α)={2×[1+μ(cured product(α))]×ρ(cured product(α))×R×[273+Tmin(cured product(α))]/E′min(cured product(α))}.

Here, the Poisson's ratio (p) and specific gravity (p) of the cured product depend on the type of resin component of the curable resin composition, that is, the type of the component (A), but as long as the component (A) is an epoxy group-containing substance, it is hardly affected by the type and amount of the epoxy group-containing substance. Therefore, in the cured product of the epoxy group-containing substance, the Poisson's ratio (μ) and specific gravity (ρ) of the cured product can be regarded as “constants”. Moreover, R is a constant (gas constant). Therefore, expressing only the variable part of the molecular weight between crosslinking points of the cured product (α) in a formula results in the following:

Variable part of molecular weight between crosslinking points of cured product(α)=[273+Tmin(M)]/[E′(M)]

In the present description, the “variable part of the molecular weight between crosslinking points of the cured product (α)” is referred to as “value Y”. That is, as a result of diligent research, the present inventors have independently obtained a novel finding that by setting Y to a value within a predetermined range and using polymer particles, the toughness of the cured product is remarkably improved, leading to the completion of one or more embodiments of the present invention.

The evaluation of the molecular weight between crosslinking points needs to be based on the measurement values of the cured product obtained by curing a composition containing only component (A), component (C), and component (D). This is because the component (A) and the component (C) form a crosslinking structure, and the component (D) can influence the degree of progress of the crosslinking reaction. Conversely, when evaluating the molecular weight between crosslinking points, component (B) and any components other than components (A) to (D) (for example, inorganic fillers) cannot be added. These components do not participate in crosslinking formation, yet they affect the E′min or the like of the cured product obtained by curing the composition, making it impossible to accurately evaluate the molecular weight between crosslinking points. It should be noted that the component (D) is a component that is not incorporated into the crosslinking structure, but its amount is small compared to the total amount of the component (A) and the component (C) because it is a curing accelerator, and the influence of the unreacted residual component (D) on the molecular weight between crosslinking points after curing is considered to be small.

Conventionally, due to reasons such as the obtained cured product having excellent heat resistance and/or strength, the composition being low in viscosity and excellent in workability, and being inexpensive and economically advantageous, it has been common to use a large amount of polyfunctional epoxy group-containing substances with a small epoxy equivalent weight as the epoxy group-containing substance in curable resin compositions containing epoxy group-containing substances. Even in rare cases where monofunctional epoxy group-containing substances and epoxy group-containing substances with a large epoxy equivalent weight are used, their total usage amount was minimal (less than 5 parts by mass in 100 parts by mass of the epoxy group-containing substance). However, the present inventors have focused for the first time on the use of monofunctional epoxy group-containing substances and/or epoxy group-containing substances with a large epoxy equivalent weight, which have hardly been used conventionally, and by setting their usage amount to a certain level or more, setting the molecular weight between crosslinking points to a value within a predetermined range, and further using polymer particles, completed one or more embodiments of the present invention. It is known that by dispersing polymer particles (B) in component (A) (for example, epoxy resin), large-scale plastic deformation of the epoxy resin is induced, consuming energy and improving toughness. By setting the molecular weight between crosslinking points to a value within a predetermined range in the presence of polymer particles (B), it is presumed that the cured product becomes easier to undergo plastic deformation, significantly improving toughness. That is, the technical idea of setting the molecular weight between crosslinking points to a value within a predetermined range can be said to be a technical idea that could not be conceived from the conventional technology at all.

### <1-2-2. Component (A)>

In a curable resin composition that satisfies at least the (2), the total contained amount of the bisphenol A epoxy resin, the bisphenol F epoxy resin, and the alicyclic epoxy resin in 100 parts by mass of the component (A) may be 5 parts by mass to 100 parts by mass, 10 parts by mass to 95 parts by mass, 10 parts by mass to 94 parts by mass, 15 parts by mass to 93 parts by mass, 20 parts by mass to 93 parts by mass, 25 parts by mass to 93 parts by mass, 30 parts by mass to 93 parts by mass, 35 parts by mass to 93 parts by mass, 40 parts by mass to 93 parts by mass, 45 parts by mass to 93 parts by mass, 50 parts by mass to 93 parts by mass, 50 parts by mass to 92 parts by mass, 50 parts by mass to 90 parts by mass, 45 parts by mass to 85 parts by mass, 50 parts by mass to 85 parts by mass, 50 parts by mass to 80 parts by mass, 55 parts by mass to 80 parts by mass, or 60 parts by mass to 80 parts by mass. According to this configuration, the composition has low viscosity and excellent processability, and the cured product obtained by curing the composition has advantages of high strength, elastic modulus, and heat resistance (high Tg). In a curable resin composition that satisfies at least the (2), the component (A) may not contain other epoxy group-containing substances (for example, glycidyl amine type epoxy resin) described later.

In a curable resin composition that satisfies at least the (2), the component (A) satisfies any of the following (i), (ii), or (iii):
(i) the component (A) contains polyfunctional epoxy group-containing substance (a1), and a contained amount of polyfunctional epoxy group-containing substance (a1) in 100 parts by mass of the component (A) is 5 to 100 parts by mass;
(ii) the component (A) contains monofunctional epoxy group-containing substance (a2), and a contained amount of monofunctional epoxy group-containing substance (a2) in 100 parts by mass of the component (A) is 5 to 95 parts by mass;
(iii) the component (A) contains the polyfunctional epoxy group-containing substance (a1) and the monofunctional epoxy group-containing substance (a2), and a contained amount of the polyfunctional epoxy group-containing substance (a1) in 100 parts by mass of the component (A) is 5 parts by mass to 95 parts by mass, and a contained amount of the monofunctional epoxy group-containing substance (a2) in 100 parts by mass of the component (A) is 5 parts by mass to 95 parts by mass.

In the curable resin composition satisfying at least the (2), the component (A) (i) may contain a polyfunctional epoxy group-containing substance (a1) and may not contain a monofunctional epoxy group-containing substance (a2), (ii) may contain a monofunctional epoxy group-containing substance (a2) and may not contain a polyfunctional epoxy group-containing substance (a1), or (iii) may contain both a polyfunctional epoxy group-containing substance (a1) and a monofunctional epoxy group-containing substance (a2). In the curable resin composition satisfying at least the (2), when the component (A) contains a polyfunctional epoxy group-containing substance (a1), the cured product obtained by curing the composition has the advantage of excellent toughness. On the other hand, in the curable resin composition satisfying at least the (2), when the component (A) does not contain a polyfunctional epoxy group-containing substance (a1), the composition has the advantage of being relatively low in viscosity and excellent in processability. In the curable resin composition satisfying at least the (2), when the component (A) contains a monofunctional epoxy group-containing substance (a2), the composition becomes low in viscosity and excellent in processability, and furthermore, the cured product obtained by curing the composition has the advantage of excellent toughness. On the other hand, in the curable resin composition satisfying at least the (2), when the component (A) does not contain a monofunctional epoxy group-containing substance (a2), the cured product obtained by curing the composition has the advantage of excellent strength and heat resistance (high Tg).

In the curable resin composition satisfying at least the (2), in 100 parts by mass of the component (A), the contained amount of the polyfunctional epoxy group-containing substance (a1) may be 5 parts by mass to 100 parts by mass, 7 parts by mass to 50 parts by mass, 10 parts by mass to 50 parts by mass, 10 parts by mass to 40 parts by mass, 15 parts by mass to 40 parts by mass, or 15 parts by mass to 30 parts by mass. According to this configuration, the composition has relatively low viscosity and excellent processability, and further, the cured product obtained by curing the composition has the advantage of excellent toughness. In the curable resin composition satisfying at least the (2), the upper limit of the contained amount of the polyfunctional epoxy group-containing substance (a1) in 100 parts by mass of the component (A) may be less than 100 parts by mass.

In the curable resin composition satisfying at least the (2), in 100 parts by mass of the component (A), the contained amount of the monofunctional epoxy group-containing substance (a2) may be 5 parts by mass to 95 parts by mass, 7 parts by mass to 58 parts by mass, 8 parts by mass to 50 parts by mass, 10 parts by mass to 50 parts by mass, 15 parts by mass to 45 parts by mass, 15 parts by mass to 40 parts by mass, 15 parts by mass to 35 parts by mass, or 20 parts by mass to 30 parts by mass. According to this configuration, the composition has low viscosity and excellent processability, and further, the cured product obtained by curing the composition has the advantage of excellent strength and/or toughness. In the curable resin composition satisfying at least the (2), the upper limit of the contained amount of the monofunctional epoxy group-containing substance (a2) in 100 parts by mass of the component (A) may be less than 95 parts by mass.

Since the cured product obtained by curing the composition has the advantage of being more excellent in toughness, in the curable resin composition satisfying at least the (2), the component (A) contains a polyfunctional epoxy group-containing substance (a1) and a monofunctional epoxy group-containing substance (a2). In the curable resin composition satisfying at least the (2), a case where the component (A) contains a polyfunctional epoxy group-containing substance (a1) and a monofunctional epoxy group-containing substance (a2) (hereinafter referred to as “case C”) will be described. In case C, in 100 parts by mass of the component (A), (i) the contained amount of the polyfunctional epoxy group-containing substance (a1) may be 5 parts by mass to 95 parts by mass, and the contained amount of the monofunctional epoxy group-containing substance (a2) may be 5 parts by mass to 95 parts by mass, (ii) the contained amount of the polyfunctional epoxy group-containing substance (a1) may be 5 parts by mass to 50 parts by mass, and the contained amount of the monofunctional epoxy group-containing substance (a2) may be 5 parts by mass to 50 parts by mass, (iii) the contained amount of the polyfunctional epoxy group-containing substance (a1) may be 10 parts by mass to 40 parts by mass, and the contained amount of the monofunctional epoxy group-containing substance (a2) may be 7 parts by mass to 40 parts by mass, or (iv) the contained amount of the polyfunctional epoxy group-containing substance (a1) may be 15 parts by mass to 30 parts by mass, and the contained amount of the monofunctional epoxy group-containing substance (a2) may be 8 parts by mass to 30 parts by mass. According to this configuration, the composition has low viscosity and excellent processability, and further, the cured product obtained by curing the composition has the advantage of excellent strength and/or toughness. In case C, in 100 parts by mass of the component (A), (i) the contained amount of the polyfunctional epoxy group-containing substance (a1) may be less than 95 parts by mass, and/or (ii) the contained amount of the monofunctional epoxy group-containing substance (a2) may be less than 95 parts by mass.

In the curable resin composition satisfying at least the (2), the polyfunctional epoxy group-containing substance (a1) may be at least one type of epoxy group-containing substance selected from the group consisting of a bisphenol A epoxy resin, a bisphenol F epoxy resin, and an alicyclic epoxy resin, or may be an epoxy group-containing substance other than bisphenol A epoxy resin, bisphenol F epoxy resin, and alicyclic epoxy resin. In the curable resin composition satisfying at least the (2), the monofunctional epoxy group-containing substance (a2) may be an alicyclic epoxy resin or may be an epoxy group-containing substance other than alicyclic epoxy resin. In other words, in the curable resin composition satisfying at least the (2), the component (A) may further contain an epoxy group-containing substance other than bisphenol A epoxy resin, bisphenol F epoxy resin, and alicyclic epoxy resin, that is, other epoxy group-containing substances.

In the curable resin composition satisfying at least the (2), when the composition contains an alicyclic epoxy resin as the component (A), the composition may contain an acid anhydride (c1) as the component (C).

In the curable resin composition satisfying at least the (2), regarding the specific aspects other than those mentioned above concerning the component (A), they are the same as those described in the section <1-1-2. Component (A)>, and therefore the description is incorporated herein by reference and omitted here. Regarding the aspects other than those mentioned above concerning the component (A), the aspects in the curable resin composition satisfying at least the (1) may be also aspects in the curable resin composition satisfying at least the (2).

### <1-2-3. Component (B)>

Regarding the specific aspects concerning the component (B), they are the same as those described in the section <1-1-3. Component (B)>, and therefore the description is incorporated herein by reference and omitted here. In the curable resin composition satisfying at least the (1), the aspect as the component (B) may be also an aspect as the component (B) in the curable resin composition satisfying at least the (2).

### <1-2-4. Component (C)>

In the curable resin composition satisfying at least the (2), the component (C) is an epoxy curing agent. In the curable resin composition satisfying at least the (2), the epoxy curing agent as the component (C) contains at least one type selected from the group consisting of an acid anhydride (c1), an aromatic amine (c2), and an alicyclic amine (c3).

<<Acid Anhydride (c1)>>

In the curable resin composition satisfying at least the (2), a case where the component (C) contains an acid anhydride (c1) or is an acid anhydride (c1) (hereinafter referred to as “case D”) will be described. In case D, the viscosity of the resulting composition can be low and the pot life can be long. As a result, in case D, the composition has the advantage of excellent processability. In addition, in case D, there is the advantage that the composition cures even at relatively low temperatures due to the addition of a curing accelerator, the resulting cured product has relatively good balance in terms of electrical, chemical, and mechanical properties, and further, the amount of heat generated during curing is small, making it easier to create large molded products.

In the curable resin composition satisfying at least the (2), when the component (C) contains an acid anhydride (c1), component (C) need not contain aromatic amine (c2) and alicyclic amine (c3), and may be composed only of the acid anhydride (c1).

For specific examples of the acid anhydride (c1), it is the same as described in the item <<Acid Anhydride (c1)>> under the section <1-1-4. Component (C)>, and therefore the description is incorporated herein by reference and omitted here. In the curable resin composition satisfying at least the (1), the aspect as the acid anhydride (c1) may be also an aspect as the acid anhydride (c1) in the curable resin composition satisfying at least the (2).

### <<Aromatic Amine (c2)

In the curable resin composition satisfying at least the (2), when the component (C) contains an aromatic amine (c2) or is an aromatic amine (c2), the cured product obtained by curing the composition has the advantage of excellent heat resistance and high strength and/or toughness.

In the curable resin composition satisfying at least the (2), when the component (C) contains aromatic amine (c2), component (C) need not contain acid anhydride (c1) and alicyclic amine (c3), and may be composed only of aromatic amine (c2).

For specific examples of the aromatic amine (c2), it is the same as described in the item <<Aromatic Amine (c2)>> under the section <1-1-4. Component (C)>, and therefore the description is incorporated herein by reference and omitted here. In the curable resin composition satisfying at least the (1), the aspect as the aromatic amine (c2) may be also an aspect as the aromatic amine (c2) in the curable resin composition satisfying at least the (2).

<<Alicyclic Amine (c3)>>

In the curable resin composition satisfying at least the (2), when the component (C) contains an alicyclic amine (c3) or is an alicyclic amine (c3), the curing speed of the composition becomes faster, and curing can progress even at relatively low temperatures, and/or curing can be completed in a relatively short time. Therefore, in the curable resin composition satisfying at least the (2), when the component (C) is an alicyclic amine (c3), it has the advantage of a short molding cycle for the cured product and excellent productivity. The alicyclic amine (c3) is a curing agent with a fast curing speed. On the other hand, in the curable resin composition satisfying at least the (2), the cured product obtained by curing a composition containing an alicyclic amine (c3) as the component (C) also has the advantage of being relatively excellent heat-resistant and having high strength and/or toughness.

In the curable resin composition satisfying at least the (2), when the component (C) contains an alicyclic amine (c3), component (C) need not contain acid anhydride (c1) and aromatic amine (c2), and may be composed only of the alicyclic amine (c3).

For specific examples of the alicyclic amine (c3), it is the same as described in the item <<Alicyclic Amine (c3)>> under the section <1-1-4. Component (C)>, and therefore the description is incorporated herein by reference and omitted here. In the curable resin composition satisfying at least the (1), the aspect as the alicyclic amine (c3) may be also an aspect as the alicyclic amine (c3) in the curable resin composition satisfying at least the (2).

In the curable resin composition satisfying at least the (2), the contained amount of the component (C) in the composition may be 10 parts by mass to 200 parts by mass, 11 parts by mass to 170 parts by mass, 12 parts by mass to 150 parts by mass, 13 parts by mass to 130 parts by mass, or 15 parts by mass to 115 parts by mass with respect to 100 parts by mass of the component (A). According to this configuration, the cured product obtained by curing the composition has the advantage of excellent strength and toughness.

In the curable resin composition satisfying at least the (2), a case where the component (C) contains an acid anhydride (c1) or is an acid anhydride (c1) will be described. In this case, the contained amount of the component (C) in the composition may be 40 parts by mass to 200 parts by mass, 50 parts by mass to 170 parts by mass, 55 parts by mass to 150 parts by mass, 60 parts by mass to 130 parts by mass, or 65 parts by mass to 115 parts by mass with respect to 100 parts by mass of the component (A). According to this configuration, the cured product obtained by curing the composition has the advantage of excellent strength and toughness.

In the curable resin composition satisfying at least the (2), a case where the component (C) contains an aromatic amine (c2) or is an aromatic amine (c2) will be described. In this case, the contained amount of the component (C) in the composition may be 10 parts by mass to 70 parts by mass, 11 parts by mass to 60 parts by mass, 12 parts by mass to 50 parts by mass, 13 parts by mass to 45 parts by mass, or 15 parts by mass to 40 parts by mass with respect to 100 parts by mass of the component (A). According to this configuration, the cured product obtained by curing the composition has the advantage of excellent strength and toughness.

A case where the component (C) contains an alicyclic amine (c3) or is an alicyclic amine (c3) will be described. In this case, the contained amount of the component (C) in the composition may be 5 parts by mass to 70 parts by mass, 7 parts by mass to 60 parts by mass, 9 parts by mass to 50 parts by mass, 11 parts by mass to 45 parts by mass, 13 parts by mass to 40 parts by mass, or 15 parts by mass to 35 parts by mass with respect to 100 parts by mass of the component (A). According to this configuration, the cured product obtained by curing the composition has the advantage of excellent strength and toughness.

### <1-2-5. Component (D)>

Regarding the specific aspects concerning the component (D), they are the same as those described in the section <1-1-5. Component (D)>, and therefore the description is incorporated herein by reference and omitted here. In the curable resin composition satisfying at least the (1), the aspect as the component (D) may be also an aspect as the component (D) in the curable resin composition satisfying at least the (2).

### <1-2-6. Other Formulation Components>

Regarding the specific aspects concerning the other formulation components, they are the same as those described in the section <1-1-6. Other Formulation Components>, and therefore the description is incorporated herein by reference and omitted here.

### <1-2-7. Value Y>

Regarding the specific aspects concerning value Y, they are the same as those described in the section <1-1-8. Value Y>, and therefore the description is incorporated herein by reference and omitted here. In the curable resin composition satisfying at least the (1), the aspect as the value Y may be also an aspect as the value Y in the curable resin composition satisfying at least the (2).

### <1-2-8. Viscosity of Curable Resin Composition>

Regarding the specific aspects concerning the viscosity of the curable resin composition, they are the same as those described in the section <1-1-9. Viscosity of Curable Resin Composition>, and therefore the description is incorporated herein by reference and omitted here. In the curable resin composition satisfying at least the (1), the aspect as the viscosity of the curable resin composition may be also an aspect as the viscosity of the curable resin composition in the curable resin composition satisfying at least the (2).

### [1-3. Curable Resin Composition Satisfying at Least (3)]

The following section describes a curable resin composition that satisfies at least the (3).

### <1-3-1. Technical Idea Regarding Curable Resin Composition Satisfying at Least (3)>

Conventional curable resin compositions have had room for further improvement in terms of toughness. Thus, the present inventors have conducted diligent research with the aim of providing a novel curable resin composition that can provide a cured product with excellent toughness.

In a curable resin composition containing an epoxy group-containing substance (for example, epoxy resin), the higher the number of active hydrogen atoms in an amino group of the epoxy curing agent per molecule, the higher the crosslink density of the cured product. The higher the crosslink density of the cured product, the smaller the molecular weight between crosslinking points of the cured product.

As a result of diligent research, the present inventors have independently obtained a novel finding that by setting the molecular weight between crosslinking points of the cured product within a specific range and using polymer particles, the toughness of the cured product is remarkably improved.

The molecular weight between crosslinking points of the cured product can be determined from the theory of rubber elasticity of crosslinked rubber, for example, by the following formula:

Molecular weight between crosslinking points=2×(1+μ)×ρ×R×T/E=ρ×R×T/G

In the formula, μ represents the Poisson's ratio of the cured product, ρ represents the specific gravity of the cured product, R represents the gas constant, T represents the absolute temperature (K), and E and G represent the Young's modulus and shear modulus of the cured product in the rubbery region. The rubbery region refers to the region observed on the high-temperature side of the transition region near the glass transition temperature when measuring the temperature dependence of elasticity (such as Young's modulus and shear modulus), representing a region where the temperature dependence of elasticity is flat. Crosslinked polymers such as epoxy resin cured products do not have a flow region on the high-temperature side of the rubbery region, so that E and G in the formula can be expressed as the minimum values of Young's modulus and shear modulus in the rubbery region. Furthermore, since the Young's modulus in the rubbery region is generally equal to the storage modulus obtained by the convenient dynamic viscoelastic measurement, the molecular weight between crosslinking points can be determined by the following formula:

Molecular weight between crosslinking points=2×(1+μ)×ρ×R×(273+Tmin)/E′min

In the formula, μ represents the Poisson's ratio of the cured product, ρ represents the specific gravity of the cured product, R represents the gas constant, E′min represents the minimum value of the storage modulus of the cured product, and Tmin represents the temperature (°C) at which the storage modulus of the cured product reaches its minimum value.

The molecular weight between crosslinking points of the cured product (α) obtained by curing a curable resin composition (a) containing an epoxy group-containing substance (component (A)), polymer particles (component (B)), a curing agent (component (C)), and a curing accelerator (component (D)) can be expressed by the following formula:

Molecular weight between crosslinking points of the cured product(α)={2×[1+μ(cured product(α))]×ρ(cured product(α))×R×[273+Tmin(cured product(α))]/E′min(cured product(α))}.

Here, the Poisson's ratio (p) and specific gravity (p) of the cured product depend on the type of resin component of the curable resin composition, that is, the type of the component (A), but as long as the component (A) is an epoxy group-containing substance, it is hardly affected by the type and amount of the epoxy group-containing substance. Therefore, in the cured product of the epoxy group-containing substance, the Poisson's ratio (μ) and specific gravity (ρ) of the cured product can be regarded as “constants”. Moreover, R is a constant (gas constant). Therefore, expressing only the variable part of the molecular weight between crosslinking points of the cured product (α) in a formula results in the following:

Variable part of molecular weight between crosslinking points of cured product(α)=[273+Tmin(M)]/[E′(M)].

In the present description, the “variable part of the molecular weight between crosslinking points of the cured product (α)” is referred to as “value Y”. That is, as a result of diligent research, the present inventors have independently obtained a novel finding that by setting Y to a value within a predetermined range and using polymer particles, the toughness of the cured product is remarkably improved, leading to the completion of one or more embodiments of the present invention.

The evaluation of the molecular weight between crosslinking points needs to be based on the measurement values of the cured product obtained by curing a composition containing only component (A), component (C), and component (D). This is because the component (A) and the component (C) form a crosslinking structure, and the component (D) can influence the degree of progress of the crosslinking reaction. Conversely, when evaluating the molecular weight between crosslinking points, the component (B) as well as components other than the component (A), the component (C), and the component (D) (for example, inorganic fillers) cannot be added. These components do not participate in crosslinking formation, yet they affect the E′min or the like of the cured product obtained by curing the composition, making it impossible to accurately evaluate the molecular weight between crosslinking points. It should be noted that the component (D) is a component that is not incorporated into the crosslinking structure, but its amount is small compared to the total amount of the component (A) and the component (C) because it is a curing accelerator, and the influence of the unreacted residual component (D) on the molecular weight between crosslinking points after curing is considered to be small.

Conventionally, from the viewpoint of the speed of curing of the composition and the strength of the resulting cured product, it has been common to use an epoxy curing agent with a high number of (for example, 4 or more) active hydrogen atoms in an amino group per molecule as the epoxy curing agent in curable resin compositions. Even in rare cases where an epoxy curing agent with a low number of active hydrogen atoms in an amino group per molecule is used, it has been common to use it in combination with an epoxy curing agent with a high number of active hydrogen atoms in an amino group per molecule, and the average number of active hydrogen atoms in an amino group per molecule for the entire epoxy curing agent is usually large. However, the present inventors have focused for the first time on the large use of epoxy curing agent with a low number of active hydrogen atoms in an amino group per molecule, which has hardly been used conventionally, and set the molecular weight between crosslinking points to a value within a predetermined range and further using polymer particles, leading to the completion of one or more embodiments of the present invention. It is known that by dispersing polymer particles (B) in component (A) (for example, epoxy resin), large-scale plastic deformation of the epoxy resin is induced, consuming energy and improving toughness. By setting the molecular weight between crosslinking points to a value within a predetermined range in the presence of polymer particles (B), it is presumed that the cured product becomes easier to undergo plastic deformation, significantly improving toughness. That is, the technical idea of setting the molecular weight between crosslinking points to a value within a predetermined range can be said to be a technical idea that could not be conceived from the conventional technology at all.

### <1-3-2. Component (A)>

In a curable resin composition that satisfies at least the (3), the total contained amount of the bisphenol A epoxy resin, the bisphenol F epoxy resin, and the alicyclic epoxy resin may be 5 parts by mass to 100 parts by mass, 10 parts by mass to 100 parts by mass, 20 parts by mass to 100 parts by mass, 30 parts by mass to 100 parts by mass, 40 parts by mass to 100 parts by mass, 50 parts by mass to 100 parts by mass, 60 parts by mass to 100 parts by mass, 70 parts by mass to 100 parts by mass, 80 parts by mass to 100 parts by mass, 90 parts by mass to 100 parts by mass, or 95 parts by mass to 100 parts by mass. In a curable resin composition that satisfies at least the (3), the upper limit of the total contained amount of the bisphenol A epoxy resin, the bisphenol F epoxy resin, and the alicyclic epoxy resin in 100 parts by mass of the component (A) may be less than 100 parts by mass. According to this configuration, the composition has low viscosity and excellent processability, and the cured product obtained by curing the composition has advantages of high strength, elastic modulus, and heat resistance (high Tg). In a curable resin composition that satisfies at least the (3), the total contained amount of the bisphenol A epoxy resin, the bisphenol F epoxy resin, and the alicyclic epoxy resin in 100 parts by mass of the component (A) may be 100 parts by mass. In other words, in a curable resin composition that satisfies at least the (3), the component (A) may be composed only of a bisphenol A epoxy resin, may be composed only of a bisphenol F epoxy resin, may be composed only of an alicyclic epoxy resin, may be composed only of a bisphenol A epoxy resin and an alicyclic epoxy resin, may be composed only of a bisphenol F epoxy resin and an alicyclic epoxy resin, may be composed only of a bisphenol A epoxy resin and a bisphenol F epoxy resin, or may be composed only of a bisphenol A epoxy resin, a bisphenol F epoxy resin, and an alicyclic epoxy resin. In a curable resin composition that satisfies at least the (3), the component (A) may not contain other epoxy group-containing substances (for example, glycidyl amine type epoxy resin) described later.

Since the cured product obtained by curing the composition has the advantage of being more excellent in toughness, in the curable resin composition satisfying at least the (3), the component (A) may contain a polyfunctional epoxy group-containing substance (a1) and a monofunctional epoxy group-containing substance (a2). In the curable resin composition satisfying at least the (3), a case where the component (A) contains a polyfunctional epoxy group-containing substance (a1) and a monofunctional epoxy group-containing substance (a2) (hereinafter referred to as “case E”) will be described. In case E, in 100 parts by mass of the component (A), (i) the contained amount of polyfunctional epoxy group-containing substance (a1) may be 5 parts by mass to 95 parts by mass, and the contained amount of monofunctional epoxy group-containing substance (a2) may be 5 parts by mass to 95 parts by mass, (ii) the contained amount of polyfunctional epoxy group-containing substance (a1) may be 6 parts by mass to 50 parts by mass, and the contained amount of monofunctional epoxy group-containing substance (a2) may be 6 parts by mass to 50 parts by mass, (iii) the contained amount of polyfunctional epoxy group-containing substance (a1) may be 7 parts by mass to 40 parts by mass, and the contained amount of monofunctional epoxy group-containing substance (a2) may be 7 parts by mass to 40 parts by mass, (iv) the contained amount of polyfunctional epoxy group-containing substance (a1) may be 7 parts by mass to 35 parts by mass, and the contained amount of monofunctional epoxy group-containing substance (a2) may be 7 parts by mass to 35 parts by mass, (v) the contained amount of polyfunctional epoxy group-containing substance (a1) may be 8 parts by mass to 33 parts by mass, and the contained amount of monofunctional epoxy group-containing substance (a2) may be 7 parts by mass to 33 parts by mass, (vi) the contained amount of polyfunctional epoxy group-containing substance (a1) may be 9 parts by mass to 30 parts by mass, and the contained amount of monofunctional epoxy group-containing substance (a2) may be 7 parts by mass to 30 parts by mass, (vii) the contained amount of polyfunctional epoxy group-containing substance (a1) may be 10 parts by mass to 25 parts by mass, and the contained amount of monofunctional epoxy group-containing substance (a2) may be 7 parts by mass to 30 parts by mass, or(viii) the contained amount of polyfunctional epoxy group-containing substance (a1) may be 15 parts by mass to 20 parts by mass, and the contained amount of monofunctional epoxy group-containing substance (a2) may be 8 parts by mass to 30 parts by mass. According to this configuration, the composition has low viscosity and excellent processability, and further, the cured product obtained by curing the composition has the advantage of excellent strength and/or toughness. In case E, in 100 parts by mass of the component (A), (i) the contained amount of the polyfunctional epoxy group-containing substance (a1) may be less than 95 parts by mass, and/or (ii) the contained amount of the monofunctional epoxy group-containing substance (a2) may be less than 95 parts by mass or less than 40 parts by mass.

In the curable resin composition satisfying at least the (3), regarding the specific aspects other than those mentioned above concerning the component (A), they are the same as those described in the section <1-1-2. Component (A)>, and therefore the description is incorporated herein by reference and omitted here. Regarding the aspects other than those mentioned above concerning the component (A), the aspects in the curable resin composition satisfying at least the (1) may be also aspects in the curable resin composition satisfying at least the (3).

### <1-3-3. Component (B)>

Regarding the specific aspects concerning the component (B), they are the same as those described in the section <1-1-3. Component (B)>, and therefore the description is incorporated herein by reference and omitted here. In the curable resin composition satisfying at least the (1), the aspect as the component (B) may be also an aspect as the component (B) in the curable resin composition satisfying at least the (3).

### <1-3-4. Component (C)>

In the curable resin composition satisfying at least the (3), the component (C) is an amine-based epoxy curing agent. In the curable resin composition satisfying at least the (3), the component (C) can function as a curing agent for the component (A). The amine-based epoxy curing agent as component (C) contains at least an amine (c4) with 1 or 2 active hydrogen atoms in an amino group per molecule. In the present description, the term “amine (c4) with 1 or 2 active hydrogen atoms in an amino group per molecule” may be referred to as “amine (c4)”.

<<Amine (c4) with 1 or 2 Active Hydrogen Atoms in Amino Group Per Molecule>>

In the curable resin composition satisfying at least the (3), by containing at least amine (c4) as component (C), it has the advantage of being able to obtain (i) a cured product with excellent toughness and elongation properties, as well as (ii) a composition with excellent handling properties at low viscosity.

The amine (c4) is not particularly limited as long as the number of active hydrogen atoms in an amino group is 1 or 2 per molecule. Examples of the amine (c4) include aliphatic amines with 2 active hydrogen atoms in an amino group per molecule, such as 3-diethylaminopropylamine, 3-dimethylaminopropylamine, 2-diethylaminoethylamine, 2-dimethylaminoethylamine, piperazine, 2-methylpiperazine, N,N′-dimethylethylenediamine, ethanolamine, n-octylamine, 2-ethylhexylamine, n-dodecylamine, hexylamine, and cyclohexylamine; aromatic amines with 2 active hydrogen atoms in an amino group per molecule, such as aniline, o-toluidine, 4-chloro-o-toluidine, 2,4-xylidine, p-cresidine, o-anisidine, 2,4,6-trimethylaniline, 2-naphthylamine, and 4-aminobiphenyl; aliphatic amines with 1 active hydrogen atom in an amino group per molecule, such as 1-(2-hydroxyethyl)piperazine, 1-methylpiperazine, piperidine, 4-methylpiperidine, diethanolamine, di-n-octylamine, di(2-ethylhexyl)amine, di-n-dodecylamine, dihexylamine, dicyclohexylamine, N-methylcyclohexylamine, N-methyl-n-octylamine, and diallylamine; and aromatic amines with 1 active hydrogen atom in an amino group per molecule, such as N-methylaniline, diphenylamine, N-methyl-p-toluidine, N-phenyl-p-toluidine, N-methyl-m-toluidine, N-methyl-2-naphthylamine, N-phenyl-2-naphthylamine, and N-methyl-1-naphthylamine.

Among the amine (c4), from the viewpoints of having a fast curing speed of the composition and excellent productivity of the cured product, aliphatic amines with 1 or 2 active hydrogen atoms in an amino group per molecule are preferred, and aliphatic amines with 2 active hydrogen atoms in an amino group per molecule are more preferred. Also, among the amine (c4), from the viewpoints of having a high glass transition temperature and excellent heat resistance of the obtained cured product, aromatic amines with 1 or 2 active hydrogen atoms in an amino group per molecule are preferred, and aromatic amines with 2 active hydrogen atoms in an amino group per molecule are more preferred.

In the amine (c4), among the aliphatic amines with 1 or 2 active hydrogen atoms in an amino group per molecule, from the viewpoints of having a faster curing speed of the composition and better productivity of the cured product, aliphatic amines having an ethylenediamine or propylene diamine skeleton, such as 3-diethylaminopropylamine, 3-dimethylaminopropylamine, 2-diethylaminoethylamine, 2-dimethylaminoethylamine, piperazine, 2-methylpiperazine, N,N′-dimethylethylenediamine, 1-(2-hydroxyethyl)piperazine, and 1-methylpiperazine are more preferred. Among these, from the viewpoints of high boiling point and low volatility, 3-diethylaminopropylamine, 2-diethylaminoethylamine, piperazine, 2-methylpiperazine, and 1-(2-hydroxyethyl)piperazine are further preferred, and 3-diethylaminopropylamine and 1-(2-hydroxyethyl)piperazine are particularly preferred.

From the viewpoints, in the curable resin composition satisfying at least the (3), component (C) may contain at least one type selected from the group consisting of 3-diethylaminopropylamine, 3-dimethylaminopropylamine, 2-diethylaminoethylamine, 2-dimethylaminoethylamine, piperazine, 2-methylpiperazine, N,N′-dimethylethylenediamine, 1-(2-hydroxyethyl)piperazine, and 1-methylpiperazine as amine (c4). In the curable resin composition satisfying at least the (3), component (C) may contain, as amine (c4), at least one type selected from the group consisting of 3-diethylaminopropylamine, 3-dimethylaminopropylamine, 2-diethylaminoethylamine, 2-dimethylaminoethylamine, piperazine, 2-methylpiperazine, N,N′-dimethylethylenediamine, 1-(2-hydroxyethyl)piperazine, and 1-methylpiperazine, in an amount of 20% by mass or more, 30% by mass or more, 50% by mass or more, 70% by mass or more, or 100% by mass in 100% by mass of the component (C). In other words, in the curable resin composition satisfying at least the (3), the component (C) may be composed only of at least one type selected from the group consisting of 3-diethylaminopropylamine, 3-dimethylaminopropylamine, 2-diethylaminoethylamine, 2-dimethylaminoethylamine, piperazine, 2-methylpiperazine, N,N′-dimethylethylenediamine, 1-(2-hydroxyethyl)piperazine, and 1-methylpiperazine. According to this configuration, it has the advantage of being able to obtain a cured product with excellent toughness.

In the curable resin composition satisfying at least the (3), the contained amount of amine (c4) in the component (C) may be 5% by mass to 100% by mass, 20% by mass to 100% by mass, 30% by mass to 90% by mass, 40% by mass to 80% by mass, or 50% by mass to 75% by mass in 100% by mass of the component (C). According to this configuration, it has the advantage of being able to obtain a cured product with an excellent balance of toughness and heat resistance.

<<KAlicyclic Amine (c5) with 4 Active Hydrogen Atoms in Amino Group Per Molecule>>

In the curable resin composition satisfying at least the (3), the component (C) may further contain an alicyclic amine (c5) with 4 active hydrogen atoms in an amino group per molecule. In the present description, the “alicyclic amine (c5) with 4 active hydrogen atoms in an amino group per molecule” may be referred to as “amine (c5)”. In the curable resin composition satisfying at least the (3), when the component (C) further contains the amine (c5), it has the advantage of being able to obtain a cured product with an excellent balance of toughness and heat resistance. The alicyclic amine can also be referred to as “cyclic aliphatic polyamine”.

As the amine (c5), it is not particularly limited as long as it is an alicyclic amine (cyclic aliphatic polyamine) with 4 active hydrogen atoms in an amino group per molecule. Examples of the amine (c5) include isophoronediamine, 1,3-bis(amino methyl)cyclohexane, 4,4′-methylene bis(cyclohexylamine), 4,4′-methylene bis(2-methylcyclohexylamine), mensendiamine, 3,9-bis(3-aminopropyl)-2,4,8,10-tetraoxaspiro[5.5]undecane, which is a type of spiroacetal diamine, norbornanediamine, and bis(aminomethyl)tricyclodecane.

In a curable resin composition satisfying at least the (3), the component (C) (i) may contain, as amine (c5), at least one type selected from the group consisting of isophoronediamine, 1,3-bis(amino methyl)cyclohexane, 4,4′-methylene bis(cyclohexylamine), 4,4′-methylene bis(2-methylcyclohexylamine), and mensendiamine, or may be composed only of at least one type selected from that group, (ii) may contain at least one type selected from the group consisting of isophoronediamine, 1,3-bis(amino methyl)cyclohexane, 4,4′-methylene bis(cyclohexylamine), and 4,4′-methylene bis(2-methylcyclohexylamine), or may be composed only of at least one type selected from that group, (iii) may contain at least one type selected from the group consisting of isophoronediamine, 1,3-bis(amino methyl)cyclohexane, and 4,4′-methylene bis(cyclohexylamine), or may be composed only of at least one type selected from that group, or (iv) may contain at least one type selected from the group consisting of isophoronediamine and 4,4′-methylene bis(cyclohexylamine), or may be composed only of at least one type selected from that group. According to this configuration, it has the advantage of being able to obtain a cured product with excellent toughness.

In the curable resin composition satisfying at least the (3), a case where the component (C) contains amine (c5) will be described. In this case, the contained amount of the amine (c5) in the component (C) may be 0% by mass to 95% by mass, 5% by mass to 85% by mass, 15% by mass to 75% by mass, or 25% by mass to 65% by mass in 100% by mass of the component (C). According to this configuration, it has the advantage of being able to obtain a cured product with an excellent balance of toughness and heat resistance.

In a curable resin composition satisfying at least the (3), the component (C) may (i) further contain an amine-based epoxy curing agent other than amine (c4) and amine (c5) in addition to amine (c4), and may (ii) further contain an amine-based epoxy curing agent other than amine (c4) and amine (c5) in addition to amine (c4) and amine (c5).

As the amine-based epoxy curing agent other than amine (c4) and amine (c5), examples include an aliphatic amine with 3 or more active hydrogen atoms in an amino group per molecule (excluding alicyclic amines with 4 active hydrogen atoms in an amino group per molecule) and an aromatic amine with 3 or more active hydrogen atoms in an amino group per molecule.

As the aliphatic amine with 3 or more active hydrogen atoms in an amino group per molecule other than alicyclic amines with 4 active hydrogen atoms in an amino group per molecule, examples include (i) a linear aliphatic polyamine with 3 or more active hydrogen atoms in an amino group per molecule, such as triethylenetetraamine, diethylenetriamine, tetraethylenepentamine, dipropylenetriamine, and hexamethylenediamine, (ii) an aliphatic aromatic amine with 3 or more active hydrogen atoms in an amino group per molecule, such as m-xylylenediamine, and (iii) an alicyclic amine with 3 or 5 or more active hydrogen atoms in an amino group per molecule. Also, amidoamine, amine-terminated polyether, amine-terminated butadiene nitrile rubber, modified aliphatic amine, modified alicyclic amine, modified amidoamine, modified amine-terminated polyether, and modified amine-terminated butadiene nitrile rubber, each having 3 or more active hydrogen atoms in an amino group per molecule, can also be listed as the aliphatic amine with 3 or more active hydrogen atoms in an amino group per molecule. Among these, amidoamine with 3 or more active hydrogen atoms in an amino group per molecule are preferred because they have the advantage of being able to provide a cured product with an excellent balance of toughness and heat resistance.

The amidoamine is a compound produced by the condensation of a dicarboxylic acid such as dimer acid of tall oil fatty acid and/or a monocarboxylic acid such as neodecanoic acid with polyamine such as triethylenetetramine and tetraethylenepentamine. Examples of commercially available amidoamine include Ancamide 910, Ancamide 350A, Versamid 140, and Versamid 115.

The amine-terminated polyether may contain a polyether main chain and may have an average of 1.5 to 4 (or 2 to 3) amino groups and/or imino groups per molecule. Examples of the amine-terminated polyether include poly(oxypropylene)diamine, poly(oxypropylene)triamine, and poly(oxypropylene)tetraamine. Examples of commercially available amine-terminated polyether include Jeffamine D-230 (poly(oxypropylene) diamine), Jeffamine D-400 (poly(oxypropylene) diamine), Jeffamine D-2000 (poly(oxypropylene) diamine), Jeffamine D-4000 (poly(oxypropylene) diamine), and Jeffamine T-5000 (poly(oxypropylene) triamine), all of which are manufactured by Huntsman Corporation.

The amine-terminated butadiene nitrile rubber may be a poly(butadiene/acrylonitrile)copolymer having an average of 1.5 to 4 (or 2 to 3) amino groups and/or imino groups per molecule and a contained amount of acrylonitrile monomer in the main chain of 5% by mass to 40% by mass (10% by mass to 35% by mass, or 15% by mass to 30% by mass). Examples of commercially available amine-terminated rubbers include Hypro 1300X16 ATBN manufactured by CVC Thermoset Specialties, Inc.

Examples of modified amine-based curing agents include polyamine epoxy resin adducts, which are reaction products of various polyamines such as the aliphatic amines and alicyclic amines with less than an equivalent amount of epoxy resin.

Examples of the alicyclic amines (cyclic aliphatic polyamines) with 3 or 5 or more active hydrogen atoms in an amino group per molecule include N-aminoethylpiperazine.

In the curable resin composition satisfying at least the (3), the contained amount of the component (C) may be 10 parts by mass to 200 parts by mass, 11 parts by mass to 170 parts by mass, 12 parts by mass to 150 parts by mass, 13 parts by mass to 130 parts by mass, or 15 parts by mass to 115 parts by mass with respect to 100 parts by mass of the component (A). According to this configuration, the cured product obtained by curing the composition has the advantage of excellent strength and toughness.

In a curable resin composition satisfying at least the (3), the number of active hydrogen atoms in an amino group of component (C) may be on average 1.5 or more and less than 3.8 per molecule, 1.7 to 3.7, 1.9 to 3.6, or 2.2 to 3.3. According to this configuration, it has the advantage of being able to obtain a cured product with an excellent balance of toughness and heat resistance.

### <1-3-5. Component (D)>

In the curable resin composition satisfying at least the (3), the composition may contain the component (D) or may not contain the component (D). From the viewpoint of toughness of the resulting cured product, in a curable resin composition satisfying at least the (3), the composition need not contain the component (D).

In the curable resin composition satisfying at least the (3), regarding the specific aspects other than those mentioned above concerning the component (D), they are the same as those described in the section <1-1-5. Component (D)>, and therefore the description is incorporated herein by reference and omitted here. Regarding the aspects other than those mentioned above concerning the component (D), the aspects in the curable resin composition satisfying at least the (1) may be also aspects in the curable resin composition satisfying at least the (3).

### <1-3-6. Other Formulation Components>

Regarding the specific aspects concerning the other formulation components, they are the same as those described in the section <1-1-6. Other Formulation Components>, and therefore the description is incorporated herein by reference and omitted here.

### <1-3-7. Value Y>

In the curable resin composition satisfying at least the (3), the value Y of the composition can reflect the molecular weight between crosslinking points of the composition. In a curable resin composition satisfying at least the (3), the value Y of the composition may be 22 to 400, 25 to 360, 30 to 320, 35 to 280, or 40 to 200. The larger the value Y, the resulting cured product has the advantage of superior elongation properties. The smaller the value Y, the resulting cured product has the advantage of superior strength and heat resistance.

In the curable resin composition satisfying at least the (3), the value Y of the composition can be adjusted by changing (i) the average epoxy equivalent weight of the epoxy group-containing substance (A) contained in the composition, (ii) the average active hydrogen atom equivalent weight of the amine (c4) contained in the composition, (iii) the average number of epoxy groups per molecule of the epoxy group-containing substance (A) contained in the composition, (iv) the average number of active hydrogen atoms in the amino group per molecule of the amine (c4) contained in the composition, (v) the type and amount of the curing accelerator (D) contained in the composition, and (vi) the amount of the amine (c4) contained in the composition.

### <1-3-8. Viscosity of Curable Resin Composition>

Regarding the specific aspects concerning the viscosity of the curable resin composition, they are the same as those described in the section <1-1-9. Viscosity of Curable Resin Composition>, and therefore the description is incorporated herein by reference and omitted here. In the curable resin composition satisfying at least the (1), the aspect as the viscosity of the curable resin composition may be also an aspect as the viscosity of the curable resin composition in the curable resin composition satisfying at least the (3).

### [2. Form of Curable Resin Composition]

The present composition may be of one-component type, two-component type, or multi-component type with three or more components. When using the present composition as an adhesive agent, the present composition (adhesive agent) may be a two-component type or multi-component type curable resin composition.

When the present composition is a two-component type or multi-component type curable resin composition, for example, the following aspects are preferred:
A two-component type or multi-component type curable resin composition containing a first component and a second component, wherein
the first component contains the following component (A),
and the second component does not contain the following component (D) or further contains the following component (D):
the curable resin composition further contains the following component (B):
   component (A): an epoxy group-containing substance containing at least one type selected from the group consisting of a bisphenol A epoxy resin, a bisphenol F epoxy resin, and an alicyclic epoxy resin;
   component (B): polymer particles having a core-shell structure that includes a core layer and a shell layer;
   component (D): a curing accelerator,
A two-component type or multi-component type curable resin composition satisfying at least one of the following (1) to (3):
(1)
the second component further contains the following component (C):
   component (C): an acid anhydride (c1), an aromatic amine (c2), or an alicyclic amine (c3),
in 100 parts by mass of the component (A), a total contained amount of the bisphenol A epoxy resin, the bisphenol F epoxy resin, and the alicyclic epoxy resin is 60 parts by mass to 100 parts by mass,
a contained amount of the component (B) is 1 part by mass to 100 parts by mass with respect to 100 parts by mass of the component (A),
a contained amount of the component (C) is 5 parts by mass to 200 parts by mass with respect to 100 parts by mass of the component (A),
when the curable resin composition contains the component (D), a contained amount of the component (D) is 0.1 parts by mass to 10.0 parts by mass with respect to 100 parts by mass of the component (A), and
a value X calculated by the following formula is
   1.05 to 5.50 when the component (C) is the acid anhydride (c1), and
   1.30 to 9.00 when the component (C) is the aromatic amine (c2) or the alicyclic amine (c3):

X={[273+Tmin(M)]/[273+Tmin(Meq)]}×[E′(Meq)]/[E′(M)]; formula:
(2)
the second component further contains the following component (C):
   component (C): an epoxy curing agent containing at least one type selected from the group consisting of an acid anhydride (c1), an aromatic amine (c2), and an alicyclic amine (c3),
in 100 parts by mass of the component (A), a total contained amount of the bisphenol A epoxy resin, the bisphenol F epoxy resin, and the alicyclic epoxy resin is 5 parts by mass to 100 parts by mass,
a contained amount of the component (B) is 1 part by mass to 100 parts by mass with respect to 100 parts by mass of the component (A),
a contained amount of the component (C) is 10 parts by mass to 200 parts by mass with respect to 100 parts by mass of the component (A),
when the curable resin composition contains the component (D), a contained amount of the component (D) is 0.1 parts by mass to 10.0 parts by mass with respect to 100 parts by mass of the component (A),
the component (A) satisfies any of the following (i), (ii), or (iii):
   (i) the component (A) contains a polyfunctional epoxy group-containing substance (a1) having an epoxy equivalent weight of 300 g/eq or more and less than 3000 g/eq, and having two or more epoxy groups per molecule, and a contained amount of the polyfunctional epoxy group-containing substance (a1) in 100 parts by mass of the component (A) is 5 parts by mass to 100 parts by mass;
   (ii) the component (A) contains a monofunctional epoxy group-containing substance (a2) having one epoxy group per molecule, and a contained amount of the monofunctional epoxy group-containing substance (a2) in 100 parts by mass of the component (A) is 5 parts by mass to 95 parts by mass;
   (iii) the component (A) contains the polyfunctional epoxy group-containing substance (a1) and the monofunctional epoxy group-containing substance (a2), and a contained amount of the polyfunctional epoxy group-containing substance (a1) in 100 parts by mass of the component (A) is 5 parts by mass to 95 parts by mass, and a contained amount of the monofunctional epoxy group-containing substance (a2) in 100 parts by mass of the component (A) is 5 parts by mass to 95 parts by mass, and
a value Y calculated by the following formula is 22 to 400:

Y=[273+Tmin(M)]/[E′(M)]; formula:
(3)
the second component further contains the following component (C),
   component (C): an amine-based epoxy curing agent containing an amine (c4) with 1 or 2 active hydrogen atoms in an amino group per molecule;
in 100 parts by mass of the component (A), a total contained amount of the bisphenol A epoxy resin, the bisphenol F epoxy resin, and the alicyclic epoxy resin is 5 parts by mass to 100 parts by mass,
a contained amount of the component (B) is 1 part by mass to 100 parts by mass with respect to 100 parts by mass of the component (A),
a contained amount of the component (C) is 10 parts by mass to 200 parts by mass with respect to 100 parts by mass of the component (A),
when the curable resin composition contains the component (D), a contained amount of the component (D) is 0.1 parts by mass to 20.0 parts by mass with respect to 100 parts by mass of the component (A),
a contained amount of the amine (c4) in the component (C) is 5% by mass to 100% by mass in 100% by mass of the component (C), and
a value Y calculated by the following formula is 22 to 400:

Y=[273+Tmin(M)]/[E′(M)], formula:
wherein
   in the formulas for the value X and the value Y,
      a temperature at which a loss tangent is maximized, as determined by dynamic viscoelastic measurement under tensile mode and at a frequency of 1 Hz using a cured product (M) of a composition (M) as a sample, is defined as Ttg(M) (°C), and the E′(M) represents a minimum value of a storage modulus (E′) in a temperature range of [Ttg(M) (°C)] to [Ttg(M)+25 (°C)] of the cured product (M), and the Tmin(M) (°C) is a temperature (°C) at which a value of the E′(M) is obtained,
      the composition (M) contains the component (A), the component (C), and the component (D), which are the same as the component (A), the component (C), and the component (D) contained in the curable resin composition,
      respective contained amounts of the component (A), the component (C), and the component (D) in the composition (M) are the same as respective contained amounts of the component (A), the component (C), and the component (D) in the curable resin composition,
      the cured product (M) is a cured product obtained by curing the composition (M) and showing a cure degree of 98% or more as measured by DSC measurement,
   in the formula for the value X,
      a temperature at which a loss tangent is maximized, as determined by dynamic viscoelastic measurement under tensile mode and at a frequency of 1 Hz using a cured product (Meq) of a composition (Meq) as a sample, is defined as Ttg(Meq) (°C), and the E′(Meq) represents a minimum value of a storage modulus (E′) in a temperature range of [Ttg(Meq) (°C)] to [Ttg(Meq)+25 (°C)] of the cured product (Meq), and the Tmin(Meq) (°C) is a temperature (°C) at which a value of the E′(Meq) is obtained,
      the composition (Meq) contains the component (A), the component (C), and the component (D), which are the same as the component (A), the component (C), and the component (D) contained in the curable resin composition,
      respective contained amounts of the component (A) and the component (D) in the composition (Meq) are the same as respective contained amounts of the component (A) and the component (D) in the curable resin composition,
      when the component (C) in the composition (Meq) is the acid anhydride (c1), a contained amount of the component (C) in the composition (Meq) is such that a ratio of a molar mass of an acid anhydride group in the component (C) to a molar mass of an epoxy group in the component (A) contained in the composition (Meq) (molar mass of acid anhydride group in the component (C)/molar mass of the epoxy group in the component (A)) is 1,
      when the component (C) in the composition (Meq) is the aromatic amine (c2) or the alicyclic amine (c3), a contained amount of the component (C) in the composition (Meq) is such that a ratio of a molar mass of active hydrogen atom of an amine in the component (C) to a molar mass of an epoxy group in the component (A) contained in the composition (Meq) (molar mass of active hydrogen atom of the amine in the component (C)/molar mass of the epoxy group in the component (A)) is 1, and
      the cured product (Meq) is a cured product obtained by curing the composition (Meq) and showing a cure degree of 98% or more as measured by DSC measurement.

The two-component type or multi-component type curable resin composition is also a curable resin composition according to one or more embodiments of the present invention, that is, the present composition, and has the advantage of being able to provide a cured product with excellent toughness.

Regarding the specific aspects concerning the two-component type or multi-component type curable resin composition (for example, aspects of each component), the above description (for example, descriptions regarding each component) is appropriately incorporated by reference. The aspects in the above description (for example, descriptions regarding each component) may be also aspects in the two-component type or multi-component type curable resin composition.

### 3. Method for Producing Curable Resin Composition

The method for producing the curable resin composition is not particularly limited. When the present composition is a one-component type curable resin composition, the curable resin composition can be produced by mixing, for example, the component (A), component (B), component (C), and if necessary, component (D), as well as other components, if necessary, using a known mixing device (for example, a planetary mixer).

The present composition may be a composition in which the core-shell polymer particles, which are component (B), are dispersed in a primary particle state. Such a composition may be produced using a polymer particle dispersion composition in which core-shell polymer particles are dispersed in a primary particle state. By using the polymer particle dispersion composition, it is possible to easily achieve the dispersion of core-shell polymer particles in a primary particle state in the composition. In the polymer particle dispersion composition, the core-shell polymer particles may be at a high concentration.

The present composition can also be produced by directly mixing the powder (bulk, granules, or powder granules) of the core-shell polymer particles, which are component (B), with the component (A), thereby dispersing the core-shell polymer particles in the component (A). However, in order to obtain a composition in which the core-shell polymer particles are dispersed in a primary particle state, with no aggregates of the core-shell polymer particles or very few if any, it is preferable to produce the composition using the polymer particle dispersion composition after obtaining it.

Various methods can be used as methods for obtaining a polymer particle dispersion composition, and examples include a method of contacting core-shell polymer particles obtained in an aqueous latex state with component (A) and then removing unwanted components such as water; and a method of extracting core-shell polymer particles into an organic solvent, mixing the organic solvent containing the core-shell polymer particles with component (A), and then removing the organic solvent from the resulting mixture. As a method for obtaining a polymer particle dispersion composition, it is preferable to use the method described in International Publication No. WO 2005/028546. The specific production method is a method of sequentially performing the following first step, second step, and third step:
First step: a step of mixing an aqueous latex containing core-shell polymer particles (for example, a reaction mixture obtained after producing core-shell polymer particles by emulsion polymerization) with an organic solvent whose water solubility at 20 °C is 5% by weight to 40% by weight, and then further mixing the resulting mixture with an excess amount of water to aggregate the polymer particles;
Second step: a step of separating and recovering the aggregated core-shell polymer particles from the liquid phase, and then mixing the core-shell polymer particles again with the organic solvent to obtain an organic solvent solution of the core-shell polymer particles;
Third step: a step of further mixing the resulting organic solvent solution with component (A), and then removing the organic solvent from the resulting mixture.

The component (A) may be in liquid form at 23 °C. When the component (A) is in liquid at 23 °C, the third step becomes easier. The “liquid at 23 °C” means that the softening point is 23 °C or lower and indicates that it shows fluidity at 23 °C.

By going through the first step to the third step, it is possible to obtain a polymer particle dispersion composition in which the core-shell polymer particles, which are component (B), are dispersed in a primary particle state in the component (A). To the obtained polymer particle dispersion composition, additional component (A), component (B), component (C), and, if necessary, component (D), as well as, if necessary, other components can be mixed to obtain a composition. In the composition obtained in this way, the core-shell polymer particles can be dispersed in a primary particle state.

On the other hand, after solidifying the core-shell polymer particles by methods such as salting out, it is possible to obtain powdery core-shell polymer particles by drying the resulting solid. Powdery core-shell polymer particles can be redispersed in the component (A) in a primary particle state by using a dispersing machine with high mechanical shear force, such as a three-roll paint mill, a roll mill, or a kneader. In this case, by applying mechanical shear force at high temperatures to the mixture of the component (A) and the component (B) (powdery core-shell polymer particles), efficient dispersion of the component (B) in the component (A) can be achieved. The temperature during dispersion (when applying shear force) may be 50 °C to 200 °C, 70 °C to 170 °C, 80 °C to 150 °C, or 90 °C to 120 °C.

When the present composition is a curable resin composition of a two-component type or multi-component type containing a first component and a second component, for example, the component (A) and the component (B), and if necessary, other components can be mixed using a known mixing device (for example, a planetary mixer) to produce a first component containing the component (B). In the first component containing the component (A) and the component (B), the core-shell polymer particles, which are component (B), may be dispersed in a primary particle state within the component (A). In other words, the first component containing the component (A) and the component (B) may be the polymer particle dispersion composition. In addition, by mixing the component (C) and, if necessary, the component (D), as well as, if necessary, the component (B) and other components using a known mixing device (for example, a planetary mixer), a second component can be produced. The first component and the second component produced in this way may be mixed and used just before use (for example, just before the adhesion operation of the adherend or just before the curing of the curable resin composition).

When the present composition is a curable resin composition of a two-component type or multi-component type containing a first component and a second component, as another example, the component (A), and if necessary, other components can be mixed using a known mixing device (for example, a planetary mixer) to produce a first component that does not contain the component (B). In addition, by mixing the component (B), the component (C) and, if necessary, the component (D), as well as, if necessary, other components using a known mixing device (for example, a planetary mixer), a second component containing the component (B) can be produced. The first component and the second component produced in this way may be mixed and used just before use (for example, just before the adhesion operation of the adherend or just before the curing of the curable resin composition).

When the second component contains the component (C) and the component (D), there may be issues with storage stability, such as an increase in the viscosity of the second component after storage. In particular, when the second component contains an acid anhydride (c1) as the component (C) and an imidazole such as 2-ethyl-4-methylimidazole as the component (D), there is a tendency for the viscosity of the second component to increase over time due to the reaction between the acid anhydride (c1) and the imidazole. When using a second component in which the acid anhydride (c1) and the component (D) have been pre-mixed, the component (D) may be a tertiary amine such as 2,4,6-tris(dimethylaminomethyl)phenol or N-benzyl dimethylamine and a quaternary ammonium salt such as benzyltriethylammonium chloride, a tertiary amine without phenolic hydroxyl groups such as N-benzyl dimethylamine and a quaternary ammonium salt such as benzyltriethylammonium chloride, or a quaternary ammonium salt such as benzyltriethylammonium chloride, in terms of small viscosity change after storage and excellent storage stability.

### 4. Cured Product

The cured product according to one or more embodiments of the present invention is a cured product that is obtained by curing a curable resin composition according to one or more embodiments of the present invention, such as a curable resin composition described in the section [1. Curable Resin Composition] and/or a curable resin composition obtained by the manufacturing method described in the section [3. Method for Producing Curable Resin Composition]. In the present description, the “cured product according to one or more embodiments of the present invention” may hereinafter also be referred to as the “present cured product”. The present cured product can be said to be a cured product obtained by curing this composition. The present cured product can also be said to be a cured product including the present cured product.

The present cured product has the advantage of excellent toughness due to the above configuration.

In the present cured product, the polymer particles which are component (B) may be dispersed in the form of primary particles.

The method for producing the present cured product, in other words, the curing method of the present composition is not particularly limited. For example, when the present composition is of a one-component type, the composition can be cured by heating it to a certain temperature (curing temperature) and maintaining the composition at the curing temperature for a certain time (curing time), thereby obtaining a cured product. When the present composition is of a two-component type or multi-component type containing a first component and a second component, the first component and the second component are uniformly mixed using a static mixer or the like, and the resulting mixture can be cured by heating it to a certain temperature (curing temperature) and maintaining the mixture at the curing temperature for a certain time (curing time), thereby obtaining a cured product.

The curing temperature is not particularly limited as long as it can cure a composition or mixture. The curing temperature may be between 50 °C and 200 °C, between 70 °C and 180 °C, or between 90 °C and 150 °C. When the curing temperature is 50 °C or higher, the curing reaction can sufficiently proceed. When the curing temperature is 200 °C or lower, there is no risk of deterioration in the physical properties and/or quality of the resulting cured product.

The curing time is not particularly limited as long as it can cure a composition or mixture. The curing time may be between 0.5 hours and 12 hours, between 0.5 hours and 6 hours, between 1 hour and 4 hours, or between 1 hour and 2 hours.

### 5. Adhesive Agent

The adhesive agent according to one or more embodiments of the present invention is an adhesive agent that contains a curable resin composition according to one or more embodiments of the present invention, such as a curable resin composition described in the section [1. Curable Resin Composition] and/or a curable resin composition obtained by the manufacturing method described in the section [3. Method for Producing Curable Resin Composition]. In the present description, the “adhesive agent according to one or more embodiments of the present invention” may hereinafter also be referred to as the “present adhesive agent”. The present adhesive agent can be said to be an adhesive agent that contains the present composition.

The present adhesive agent has the advantage of excellent toughness of the cured product obtained by curing it and adhesive strength, due to the above configuration.

In the present adhesive agent, the polymer particles, which are component (B), may be dispersed in the form of primary particles.

The present adhesive agent may be of a two-component type or a multi-component type. When the present adhesive agent is a two-component type or a multi-component type, it may be an adhesive agent that contains a two-component type or multi-component type curable resin composition as described in the section [2. Form of Curable Resin Composition]. Alternatively, when the present adhesive agent is a two-component type or a multi-component type, the following aspects may be included:
A two-component type or multi-component type adhesive agent containing a first component and a second component, wherein
the first component contains the following component (A),
and the second component does not contain the following component (D) or further contains the following component (D):
the adhesive agent further contains the following component (B);
   component (A): an epoxy group-containing substance containing at least one type selected from the group consisting of a bisphenol A epoxy resin, a bisphenol F epoxy resin, and an alicyclic epoxy resin;
   component (B): polymer particles having a core-shell structure that includes a core layer and a shell layer;
   component (D): a curing accelerator,
A two-component type or multi-component type adhesive agent satisfying at least one of the following (1) to (3):
(1)
the curable resin composition further contains the following component (C):
   component (C): an acid anhydride (c1), an aromatic amine (c2), or an alicyclic amine (c3),
in 100 parts by mass of the component (A), a total contained amount of the bisphenol A epoxy resin, the bisphenol F epoxy resin, and the alicyclic epoxy resin is 60 parts by mass to 100 parts by mass,
a contained amount of the component (B) is 1 part by mass to 100 parts by mass with respect to 100 parts by mass of the component (A),
a contained amount of the component (C) is 5 parts by mass to 200 parts by mass with respect to 100 parts by mass of the component (A),
when the curable resin composition contains the component (D), a contained amount of the component (D) is 0.1 parts by mass to 10.0 parts by mass with respect to 100 parts by mass of the component (A), and
a value X calculated by the following formula is
   1.05 to 5.50 when the component (C) is the acid anhydride (c1), and
   1.30 to 9.00 when the component (C) is the aromatic amine (c2) or the alicyclic amine (c3):

X={[273+Tmin(M)]/[273+Tmin(Meq)]}×[E′(Meq)]/[E′(M)]; formula:
(2)
the curable resin composition further contains the following component (C):
   component (C): an epoxy curing agent containing at least one type selected from the group consisting of an acid anhydride (c1), an aromatic amine (c2), and an alicyclic amine (c3),
in 100 parts by mass of the component (A), a total contained amount of the bisphenol A epoxy resin, the bisphenol F epoxy resin, and the alicyclic epoxy resin is 5 parts by mass to 100 parts by mass,
a contained amount of the component (B) is 1 part by mass to 100 parts by mass with respect to 100 parts by mass of the component (A),
a contained amount of the component (C) is 10 parts by mass to 200 parts by mass with respect to 100 parts by mass of the component (A),
when the curable resin composition contains the component (D), a contained amount of the component (D) is 0.1 parts by mass to 10.0 parts by mass with respect to 100 parts by mass of the component (A),
the component (A) satisfies any of the following (i), (ii), or (iii):
   (i) the component (A) contains a polyfunctional epoxy group-containing substance (a1) having an epoxy equivalent weight of 300 g/eq or more and less than 3000 g/eq, and having two or more epoxy groups per molecule, and a contained amount of the polyfunctional epoxy group-containing substance (a1) in 100 parts by mass of the component (A) is 5 parts by mass to 100 parts by mass;
   (ii) the component (A) contains a monofunctional epoxy group-containing substance (a2) having one epoxy group per molecule, and a contained amount of the monofunctional epoxy group-containing substance (a2) in 100 parts by mass of the component (A) is 5 parts by mass to 95 parts by mass;
   (iii) the component (A) contains the polyfunctional epoxy group-containing substance (a1) and the monofunctional epoxy group-containing substance (a2), and a contained amount of the polyfunctional epoxy group-containing substance (a1) in 100 parts by mass of the component (A) is 5 parts by mass to 95 parts by mass, and a contained amount of the monofunctional epoxy group-containing substance (a2) in 100 parts by mass of the component (A) is 5 parts by mass to 95 parts by mass, and
a value Y calculated by the following formula is 22 to 400:

Y=[273+Tmin(M)]/[E′(M)]; formula:
(3)
the curable resin composition further contains the following component (C):
   component (C): an amine-based epoxy curing agent containing an amine (c4) with 1 or 2 active hydrogen atoms in an amino group per molecule;
in 100 parts by mass of the component (A), a total contained amount of the bisphenol A epoxy resin, the bisphenol F epoxy resin, and the alicyclic epoxy resin is 5 parts by mass to 100 parts by mass,
a contained amount of the component (B) is 1 part by mass to 100 parts by mass with respect to 100 parts by mass of the component (A),
a contained amount of the component (C) is 10 parts by mass to 200 parts by mass with respect to 100 parts by mass of the component (A),
when the curable resin composition contains the component (D), a contained amount of the component (D) is 0.1 parts by mass to 20.0 parts by mass with respect to 100 parts by mass of the component (A),
a contained amount of the amine (c4) in the component (C) is 5% by mass to 100% by mass in 100% by mass of the component (C), and
a value Y calculated by the following formula is 22 to 400:

Y=[273+Tmin(M)]/[E′(M)], formula:
wherein
   in the formulas for the value X and the value Y,
      a temperature at which a loss tangent is maximized, as determined by dynamic viscoelastic measurement under tensile mode and at a frequency of 1 Hz using a cured product (M) of a composition (M) as a sample, is defined as Ttg(M) (°C), and the E′(M) represents a minimum value of a storage modulus (E′) in a temperature range of [Ttg(M) (°C)] to [Ttg(M)+25 (°C)] of the cured product (M), and the Tmin(M) (°C) is a temperature (°C) at which a value of the E′(M) is obtained,
      the composition (M) contains the component (A), the component (C), and the component (D), which are the same as the component (A), the component (C), and the component (D) contained in the curable resin composition,
      respective contained amounts of the component (A), the component (C), and the component (D) in the composition (M) are the same as respective contained amounts of the component (A), the component (C), and the component (D) in the curable resin composition,
      the cured product (M) is a cured product obtained by curing the composition (M) and showing a cure degree of 98% or more as measured by DSC measurement,
   in the formula for the value X,
      a temperature at which a loss tangent is maximized, as determined by dynamic viscoelastic measurement under tensile mode and at a frequency of 1 Hz using a cured product (Meq) of a composition (Meq) as a sample, is defined as Ttg(Meq) (°C), and the E′(Meq) represents a minimum value of a storage modulus (E′) in a temperature range of [Ttg(Meq) (°C)] to [Ttg(Meq)+25 (°C)] of the cured product (Meq), and the Tmin(Meq) (°C) is a temperature (°C) at which a value of the E′(Meq) is obtained,
      the composition (Meq) contains the component (A), the component (C), and the component (D), which are the same as the component (A), the component (C), and the component (D) contained in the curable resin composition,
      respective contained amounts of the component (A) and the component (D) in the composition (Meq) are the same as respective contained amounts of the component (A) and the component (D) in the curable resin composition,
      when the component (C) in the composition (Meq) is the acid anhydride(c1), a contained amount of the component (C) in the composition (Meq) is such that a ratio of a molar mass of an acid anhydride group in the component (C) to a molar mass of an epoxy group in the component (A) contained in the composition (Meq) (molar mass of acid anhydride group in the component (C)/molar mass of the epoxy group in the component (A)) is 1,
      when the component (C) in the composition (Meq) is the aromatic amine (c2) or the alicyclic amine (c3), a contained amount of the component (C) in the composition (Meq) is such that a ratio of a molar mass of active hydrogen atom of an amine in the component (C) to a molar mass of an epoxy group in the component (A) contained in the composition (Meq) (molar mass of active hydrogen atom of the amine in the component (C)/molar mass of the epoxy group in the component (A)) is 1, and
      the cured product (Meq) is a cured product obtained by curing the composition (Meq) and showing a cure degree of 98% or more as measured by DSC measurement.

When the present adhesive agent is a two-component type or a multi-component type, the following aspects may be included:
A two-component type or multi-component type adhesive agent containing a first component and a second component, wherein
the first component contains the following component (A),
the second component contains the following component (C), and does not contain the following component (D) or further contains the following component (D),
the adhesive agent further contains the following component (B):
   component (A): an epoxy group-containing substance containing at least one type selected from the group consisting of a bisphenol A epoxy resin, a bisphenol F epoxy resin, and an alicyclic epoxy resin;
   component (B): polymer particles having a core-shell structure that includes a core layer and a shell layer;
   component (C): an amine-based epoxy curing agent containing an amine (c1) with 1 or 2 active hydrogen atoms in an amino group per molecule;
   component (D): a curing accelerator,
in 100 parts by mass of the component (A), a total contained amount of the bisphenol A epoxy resin, the bisphenol F epoxy resin, and the alicyclic epoxy resin is 5 parts by mass to 100 parts by mass,
a contained amount of the component (B) is 1 part by mass to 100 parts by mass with respect to 100 parts by mass of the component (A),
a contained amount of the component (C) is 10 parts by mass to 200 parts by mass with respect to 100 parts by mass of the component (A),
when the curable resin composition contains the component (D), a contained amount of the component (D) is 0.1 parts by mass to 20.0 parts by mass with respect to 100 parts by mass of the component (A),
a contained amount of the amine (c1) in the component (C) is 5% by mass to 100% by mass in 100% by mass of the component (C),
a value Y calculated by the following formula is 22 to 400:

Y=[273+Tmin(M)]/[E′(M)], formula:
wherein
a temperature at which a loss tangent is maximized, as determined by dynamic viscoelastic measurement under tensile mode and at a frequency of 1 Hz using a cured product (M) of a composition (M) as a sample, is defined as Ttg(M) (°C), and the E′(M) represents a minimum value of a storage modulus (E′) in a temperature range of [Ttg(M) (°C)] to [Ttg(M)+25 (°C)] of the cured product (M), and the Tmin(M) (°C) is a temperature (°C) at which a value of the E′(M) is obtained,
the composition (M) contains the component (A), the component (C), and the component (D), which are the same as the component (A), the component (C), and the component (D) contained in the adhesive agent,
respective contained amounts of the component (A), the component (C), and the component (D) in the composition (M) are the same as respective contained amounts of the component (A), the component (C), and the component (D) in the adhesive agent, and
the cured product (M) is, for example, a cured product obtained by curing the composition (M) at a curing temperature of 120 °C for a curing time of 2 hours.

The present adhesive agent can be suitably used for various applications such as structural adhesive agents for vehicles and aircraft, structural adhesive agents for wind power generation, automotive interior materials, general woodworking, furniture, interior, wall materials, and food packaging. The present adhesive agent is particularly useful as a structural adhesive agent for vehicles due to its excellent toughness.

Additionally, the present adhesive agent can cure at temperatures near room temperature and is suitable for bonding dissimilar base materials with different coefficients of thermal expansion due to its superior toughness. For example, the present adhesive agent is suitable for bonding steel plates and aluminum.

The present adhesive agent can bond materials such as wood, metal, plastic, and glass. The present adhesive agent shows good adhesion to various substrates, including cold-rolled steel, aluminum, fiberglass-reinforced polyester (FRP), panels of cured products of thermosetting resins such as epoxy resins reinforced with carbon fibers, panels of thermoplastic resin sheets reinforced with carbon fibers, sheet molding compound (SMC), acrylonitrile-butadiene-styrene copolymer (ABS), polyvinyl chloride (PVC), polycarbonate, polypropylene, TPO, wood, and glass.

The curing temperature of the present adhesive agent is not particularly limited as long as it can cure a composition or mixture. When the present adhesive agent is a two-component type or multi-component type adhesive agent, the curing temperature may be between 5 °C and 50 °C, between 10 °C and 45 °C, or between 20 °C and 40 °C. When the curing temperature is 5 °C or higher, there is the advantage that the curing reaction can proceed sufficiently. When the curing temperature is 50 °C or lower, there is the advantage that a cured product can be obtained through an economical production process near room temperature.

The present adhesive agent can be produced using the present composition. The method for producing the present adhesive agent is not particularly limited and may employ known methods.

### 6. Laminate

The laminate according to one or more embodiments of the present invention includes at least two base materials and an adhesive layer formed by curing the adhesive agent described in section [5. Adhesive Agent], i.e., the adhesive agent according to one or more embodiments of the present invention, which bonds the at least two base materials. In the present description, the “laminate according to one or more embodiments of the present invention” may hereinafter also be referred to as the “present laminate”.

The present laminate has the advantage of exhibiting high adhesive strength due to the above configuration.

### (Base Material)

The base material is not particularly limited. Examples of the base material include wood, metal, plastic, glass, and the like. As for the base material, one of the types mentioned above may be used alone, or two or more types may be combined for use.

Examples of the metal include steel materials such as cold-rolled steel and hot-dip galvanized steel, and aluminum materials such as aluminum and coated aluminum. Examples of the plastic include general-purpose plastics, engineering plastics, and various plastic-based substrates such as composites (e.g., CFRP and GFRP).

The method of manufacturing the present laminate is not particularly limited. The present laminate can be obtained by, for example, applying the present adhesive agent to one or both of at least two base materials, and then sandwiching the present composition between the base materials, and thereafter curing the present adhesive agent to bond the base materials together. When the adhesive agent is a two-component type or multi-component type adhesive agent containing a first component and a second component, the first and second components can be uniformly mixed using a static mixer, and the resulting mixture can be applied to one or both of at least two base materials, then sandwiching the mixture between the base materials and curing the mixture to bond the base materials together.

There are no particular restrictions on the curing conditions. For example, by heating the present adhesive agent to a temperature of 80 °C or higher, 130 °C or higher, or 150 °C or higher, the adhesive agent can be cured within 30 minutes, or within 20 minutes, to form an adhesive layer, thereby obtaining a laminate in which at least two base materials are bonded.

In the case of a two-component type or multi-component type adhesive agent, while there are no particular restrictions on the curing conditions, for example, the adhesive agent can be cured at a temperature of 5 °C to 50 °C, 10 °C to 45 °C, or 20 °C to 40 °C, within 60 minutes, or within 30 minutes, to form an adhesive layer, thereby obtaining a laminate in which at least two base materials are bonded.

From the viewpoint of the adhesive strength of the present laminate, the thickness of the adhesive layer of the present laminate may be 0.001 mm to 5.000 mm, 0.01 mm to 1.000 mm, or 0.10 mm to 0.30 mm. The adhesive layer of the present laminate can also be said to be the thickness of the present adhesive agent.

### 7. Fiber-Reinforced Composite Material

The fiber-reinforced composite material according to one or more embodiments of the present invention contains a curable resin composition according to one or more embodiments of the present invention, such as a curable resin composition described in the section [1. Curable Resin Composition] and/or a curable resin composition obtained by the manufacturing method described in the section [3. Method for Producing Curable Resin Composition], and a fiber. In the present description, the “fiber-reinforced composite material according to one or more embodiments of the present invention” may hereinafter also be referred to as the “present fiber-reinforced composite material”.

The present fiber-reinforced composite material has the advantage of excellent toughness due to the above configuration. The fiber-reinforced composite material may require heat resistance. The cured product obtained by curing the present composition also has the advantage of a high glass transition temperature and excellent heat resistance. Therefore, the present fiber-reinforced composite material also has the advantage of excellent heat resistance. In other words, the composition can be particularly suitably used, in combination with fibers, in the field of fiber-reinforced composite material where heat resistance is required.

### (Fiber)

The fiber is not particularly limited. Examples of the fiber include glass fibers, carbon fibers, aramid fibers, and boron fibers. Since a fiber-reinforced composite material that is lightweight yet excels in mechanical properties such as strength and elastic modulus is obtained, the fiber may contain a carbon fiber, or the fiber is a carbon fiber (composed only of carbon fibers). As for the fiber, one of the types mentioned above may be used alone, or two or more types may be combined for use.

Examples of the carbon fibers include PAN-based fibers, pitch-based fibers, and rayon-based fibers. As for the carbon fibers, one of the types mentioned above may be used alone, or two or more types may be combined for use.

The fiber may be either short fibers or continuous fibers, or a combination of both may be used. The fiber may be used in the form of strands or as a fiber base material. As a fiber base material, it may consist of fibers aligned in one direction or a combination of fibers aligned in one direction (warp) and glass fibers or chemical fibers that fix the fibers (weft). Specifically, non-crimp fabric, mats, woven fabrics, knits, and braids can be used as the fiber base material.

By impregnating the present composition into fibers and further curing the composition, a fiber-reinforced composite material can be obtained.

Specific examples of the method for impregnating a composition into fibers are shown below, but the impregnation methods are not limited to those described below. For example, (i) a method of heating the composition as needed, film-forming it on a roll and/or release paper, then transferring the film to one side or both sides of fibers, and pressurizing the resulting material by passing it through a bending roll or pressure roll for impregnation; (ii) a method of applying the composition, heated as needed, to fibers for impregnation; (iii) a method of filling a tank with the composition, heating it as needed, and immersing fibers in the composition in the tank, and the like can be mentioned.

The present composition can be suitably used in the production of fiber-reinforced composite materials as described above.

This fiber-reinforced composite material can be suitably used as a component of wheels (especially vehicle wheels), as described later. Additionally, the present fiber-reinforced composite material can also be suitably used to cover the outer surface of a tank liner to constitute a pressure vessel (for example, a high-pressure vessel), as described later. However, the present fiber-reinforced composite material is not limited to these applications and can also be suitably used as, for example, structural members and/or outer panels of aircraft, spacecraft (space vehicles), automobiles, industrial machinery, railway vehicles, ships, and the like.

The molding methods for obtaining fiber-reinforced composite materials for the applications described above are not particularly limited, and known methods can be utilized to impregnate a liquid composition into fibers and cure the composition in the resulting composition-impregnated fibers. Specific examples of the methods include hand lay-up, filament winding, pultrusion, wet molding, prepreg, vacuum bagging method, pressure bagging method, spray-up method, autoclave methods, matched die methods, sheet molding compound (SMC) methods, bulk molding compound (BMC) methods, continuous lamination methods, resin transfer molding (RTM), high-pressure resin transfer molding (HP-RTM), and vacuum-assisted RTM (VaRTM). Among these, RTM and VaRTM may be used due to their relatively high productivity and the ability to obtain fiber-reinforced composite materials with complex shapes. Here, RTM refers to a method in which reinforcing fibers are placed in a male and female closed mold made of rigid material, and pressure is applied to flow a liquid resin composition into the closed mold. Additionally, VaRTM refers to a method in which reinforcing fibers are placed between an open mold made of rigid material and a flexible film (bag), utilizing the force of vacuum pressure to flow a liquid resin composition. In addition, filament winding is also suitably used.

### 8. Wheel

The wheel according to one or more embodiments of the present invention includes the fiber-reinforced composite material described in the section [7. Fiber-Reinforced Composite Material], that is, a fiber-reinforced composite material according to one or more embodiments of the present invention. In the present description, the “wheel according to one or more embodiments of the present invention” may hereinafter also be referred to as the “present wheel”. The present wheel can be said to be a wheel made using the present fiber-reinforced composite material. The present wheel has the advantage of excellent toughness due to the above configuration.

The present wheel may be a vehicle wheel used for aircraft wheels, spacecraft (space vehicles) wheels, automobile wheels, railway vehicle wheels, and the like. Toughness is required for vehicle wheels. The present wheel can be used particularly suitably as a vehicle wheel due to its excellent toughness. In other words, one or more embodiments of the present invention provide a vehicle wheel that includes the fiber-reinforced composite material described in the section [7. Fiber-Reinforced Composite Material], that is, a fiber-reinforced composite material according to one or more embodiments of the present invention.

The manufacturing method (molding method) for obtaining a fiber-reinforced composite material for wheels, particularly vehicle wheels, is not particularly limited, and methods such as sheet molding compound (SMC) methods, resin transfer molding (RTM), high-pressure resin transfer molding (HP-RTM), and vacuum-assisted RTM (VaRTM) can be suitably used.

### 9. High-Pressure Vessel

The high-pressure vessel according to one or more embodiments of the present invention includes the fiber-reinforced composite material described in the section [7. Fiber-Reinforced Composite Material], that is, a fiber-reinforced composite material according to one or more embodiments of the present invention. In the present description, a “high-pressure vessel according to one or more embodiments of the present invention” may hereinafter also be referred to as the “present high-pressure vessel”. The present high-pressure vessel can be said to be a high-pressure vessel made using the present fiber-reinforced composite material. The present high-pressure vessel has the advantage of excellent toughness due to the above configuration.

When manufacturing a pressure vessel (including the present high-pressure vessel), fibers obtained by impregnating a composition into fibers (hereinafter sometimes referred to as “composition-impregnated fibers”) are wound around the outer surface of a hollow vessel (also referred to as a tank liner) made of plastic or metal that can be sealed and has gas barrier properties using a filament winding method. In winding the composition-impregnated fibers onto the tank liner, known methods such as hoop winding, low-angle or high-angle helical winding, or the like, can be utilized. Subsequently, by heating the composition-impregnated fibers to a predetermined curing temperature to cure the composition, it is possible to manufacture a pressure vessel (including the present high-pressure vessel) that contains the fiber-reinforced composite material. The obtained pressure vessel can be suitably used as a high-pressure vessel (for example, a high-pressure hydrogen tank). The curing temperature is not particularly limited, but may be about 50 °C to 250 °C, 80 °C to 200 °C, or 100 °C to 150 °C.

One or more embodiments of the present invention may be configured as follows.
[1]A curable resin composition containing:
the following component (A) and component (B), and not containing the following component (D) or further containing the following component (D):
   component (A): an epoxy group-containing substance containing at least one type selected from the group consisting of a bisphenol A epoxy resin, a bisphenol F epoxy resin, and an alicyclic epoxy resin;
   component (B): polymer particles having a core-shell structure that includes a core layer and a shell layer;
   component (D): a curing accelerator,
wherein the curable resin composition satisfies at least one of the following (1) to (3):
(1)
the curable resin composition further contains the following component (C):
   component (C): an acid anhydride (c1), an aromatic amine (c2), or an alicyclic amine (c3),
in 100 parts by mass of the component (A), a total contained amount of the bisphenol A epoxy resin, the bisphenol F epoxy resin, and the alicyclic epoxy resin is 60 parts by mass to 100 parts by mass,
a contained amount of the component (B) is 1 part by mass to 100 parts by mass with respect to 100 parts by mass of the component (A),
a contained amount of the component (C) is 5 parts by mass to 200 parts by mass with respect to 100 parts by mass of the component (A),
when the curable resin composition contains the component (D), a contained amount of the component (D) is 0.1 parts by mass to 10.0 parts by mass with respect to 100 parts by mass of the component (A), and
a value X calculated by the following formula is
   1.05 to 5.50 when the component (C) is the acid anhydride (c1), and
   1.30 to 9.00 when the component (C) is the aromatic amine (c2) or the alicyclic amine (c3):

X={[273+Tmin(M)]/[273+Tmin(Meq)]}×[E′(Meq)]/[E′(M)]; formula:
(2)
the curable resin composition further contains the following component (C):
   component (C): an epoxy curing agent containing at least one type selected from the group consisting of an acid anhydride (c1), an aromatic amine (c2), and an alicyclic amine (c3),
in 100 parts by mass of the component (A), a total contained amount of the bisphenol A epoxy resin, the bisphenol F epoxy resin, and the alicyclic epoxy resin is 5 parts by mass to 100 parts by mass,
a contained amount of the component (B) is 1 part by mass to 100 parts by mass with respect to 100 parts by mass of the component (A),
a contained amount of the component (C) is 10 parts by mass to 200 parts by mass with respect to 100 parts by mass of the component (A),
when the curable resin composition contains the component (D), a contained amount of the component (D) is 0.1 parts by mass to 10.0 parts by mass with respect to 100 parts by mass of the component (A),
the component (A) satisfies any of the following (i), (ii), or (iii):
   (i) the component (A) contains a polyfunctional epoxy group-containing substance (a1) having an epoxy equivalent weight of 300 g/eq or more and less than 3000 g/eq, and having two or more epoxy groups per molecule, and a contained amount of the polyfunctional epoxy group-containing substance (a1) in 100 parts by mass of the component (A) is 5 parts by mass to 100 parts by mass;
   (ii) the component (A) contains a monofunctional epoxy group-containing substance (a2) having one epoxy group per molecule, and a contained amount of the monofunctional epoxy group-containing substance (a2) in 100 parts by mass of the component (A) is 5 parts by mass to 95 parts by mass;
   (iii) the component (A) contains the polyfunctional epoxy group-containing substance (a1) and the monofunctional epoxy group-containing substance (a2), and a contained amount of the polyfunctional epoxy group-containing substance (a1) in 100 parts by mass of the component (A) is 5 parts by mass to 95 parts by mass, and a contained amount of the monofunctional epoxy group-containing substance (a2) in 100 parts by mass of the component (A) is 5 parts by mass to 95 parts by mass, and
a value Y calculated by the following formula is 22 to 400:

Y=[273+Tmin(M)]/[E′(M)]; formula:
(3)
the curable resin composition further contains the following component (C):
   component (C): an amine-based epoxy curing agent containing an amine (c4) with 1 or 2 active hydrogen atoms in an amino group per molecule;
in 100 parts by mass of the component (A), a total contained amount of the bisphenol A epoxy resin, the bisphenol F epoxy resin, and the alicyclic epoxy resin is 5 parts by mass to 100 parts by mass,
a contained amount of the component (B) is 1 part by mass to 100 parts by mass with respect to 100 parts by mass of the component (A),
a contained amount of the component (C) is 10 parts by mass to 200 parts by mass with respect to 100 parts by mass of the component (A),
when the curable resin composition contains the component (D), a contained amount of the component (D) is 0.1 parts by mass to 20.0 parts by mass with respect to 100 parts by mass of the component (A),
a contained amount of the amine (c4) in the component (C) is 5% by mass to 100% by mass in 100% by mass of the component (C), and
a value Y calculated by the following formula is 22 to 400:

Y=[273+Tmin(M)]/[E′(M)], formula:
wherein
   in the formulas for the value X and the value Y,
      a temperature at which a loss tangent is maximized, as determined by dynamic viscoelastic measurement under tensile mode and at a frequency of 1 Hz using a cured product (M) of a composition (M) as a sample, is defined as Ttg(M) (°C), and the E′(M) represents a minimum value of a storage modulus (E′) in a temperature range of [Ttg(M) (°C)] to [Ttg(M)+25 (°C)] of the cured product (M), and the Tmin(M) (°C) is a temperature (°C) at which a value of the E′(M) is obtained,
      the composition (M) contains the component (A), the component (C), and the component (D), which are the same as the component (A), the component (C), and the component (D) contained in the curable resin composition,
      respective contained amounts of the component (A), the component (C), and the component (D) in the composition (M) are the same as respective contained amounts of the component (A), the component (C), and the component (D) in the curable resin composition,
      the cured product (M) is a cured product obtained by curing the composition (M) and showing a cure degree of 98% or more as measured by DSC measurement,
   in the formula for the value X,
      a temperature at which a loss tangent is maximized, as determined by dynamic viscoelastic measurement under tensile mode and at a frequency of 1 Hz using a cured product (Meq) of a composition (Meq) as a sample, is defined as Ttg(Meq) (°C), and the E′(Meq) represents a minimum value of a storage modulus (E′) in a temperature range of [Ttg(Meq) (°C)] to [Ttg(Meq)+25 (°C)] of the cured product (Meq), and the Tmin(Meq) (°C) is a temperature (°C) at which a value of the E′(Meq) is obtained,
      the composition (Meq) contains the component (A), the component (C), and the component (D), which are the same as the component (A), the component (C), and the component (D) contained in the curable resin composition,
      respective contained amounts of the component (A) and the component (D) in the composition (Meq) are the same as respective contained amounts of the component (A) and the component (D) in the curable resin composition,
      when the component (C) in the composition (Meq) is the acid anhydride(c1), a contained amount of the component (C) in the composition (Meq) is such that a ratio of a molar mass of an acid anhydride group in the component (C) to a molar mass of an epoxy group in the component (A) contained in the composition (Meq) (molar mass of acid anhydride group in the component (C)/molar mass of the epoxy group in the component (A)) is 1,
      when the component (C) in the composition (Meq) is the aromatic amine (c2) or the alicyclic amine (c3), a contained amount of the component (C) in the composition (Meq) is such that a ratio of a molar mass of active hydrogen atom of an amine in the component (C) to a molar mass of an epoxy group in the component (A) contained in the composition (Meq) (molar mass of active hydrogen atom of the amine in the component (C)/molar mass of the epoxy group in the component (A)) is 1, and
      the cured product (Meq) is a cured product obtained by curing the composition (Meq) and showing a cure degree of 98% or more as measured by DSC measurement.
[2] The curable resin composition according to [1], wherein the component (B) contains at least one type of polymer particles selected from the group consisting of the following polymer particles (B-1), polymer particles (B-2), and polymer particles (B-3):
the polymer particles (B-1):
   polymer particles in which the shell layer has an epoxy group, and a contained amount of the epoxy group in the shell layer with respect to a total mass of the shell layer is 0.2 mmol/g to 5.0 mmol/g;
the polymer particles (B-2):
   polymer particles in which the core layer is diene-based rubber obtained by polymerizing a monomer mixture containing (bi) a conjugated diene-based monomer in an amount of 50.00% by mass to 99.99% by mass, (b2) a vinyl-based monomer that is copolymerizable with the conjugated diene-based monomer, in an amount of 0.00% by mass to 49.99% by mass, and (b3) a chain transfer agent in an amount of 0.01% by mass to 3.00% by mass, where a total of the conjugated diene-based monomer (b1), the vinyl-based monomer (b2) that is copolymerizable with the conjugated diene-based monomer, and the chain transfer agent (b3) is 100% by mass,
the polymer particles (B-3):
   polymer particles in which the core layer is diene-based rubber obtained by polymerizing a monomer mixture containing (b1) a conjugated diene-based monomer in an amount of 50.00% by mass to 99.99% by mass, (b2) a vinyl-based monomer that is copolymerizable with the conjugated diene-based monomer, in an amount of 0.00% by mass to 49.99% by mass, and (b3) a chain transfer agent in an amount of 0.01% by mass to 3.00% by mass, where a total of the conjugated diene-based monomer (b1), the vinyl-based monomer (b2) that is copolymerizable with the conjugated diene-based monomer, and the chain transfer agent (b3) is 100% by mass, and the shell layer has an epoxy group, and a contained amount of the epoxy group in the shell layer with respect to a total mass of the shell layer is 0.2 mmol/g to 5.0 mmol/g.
[3] The curable resin composition according to [1] or [2], wherein the core layer of the component (B) is butadiene rubber and/or butadiene-styrene rubber.
[4] The curable resin composition according to any one of [1] to [3], wherein the shell layer contains at least one type of structural unit selected from the group consisting of an aromatic vinyl-based unit, a vinyl cyanide-based unit, and a (meth)acrylate-based unit.
[5] The curable resin composition according to any one of [1] to [4], wherein when the curable resin composition satisfies the (1),
the component (C) is the acid anhydride (c1), and the contained amount of the component (C) in the curable resin composition is such that a ratio of a molar mass of an acid anhydride group in the component (C) to a molar mass of an epoxy group in the component (A) contained in the curable resin composition (molar mass of acid anhydride group in the component (C)/molar mass of the epoxy group in the component (A)) is 0.35 to 0.87.
[6] The curable resin composition according to any one of [1] to [4], wherein when the curable resin composition satisfies the (1),
the component (C) is the aromatic amine (c2) or the alicyclic amine (c3), and the contained amount of the component (C) in the curable resin composition is such that a ratio of a molar mass of active hydrogen atom of an amine in the component (C) to a molar mass of an epoxy group in the component (A) contained in the curable resin composition (molar mass of active hydrogen atom of the amine in the component (C)/molar mass of the epoxy group in the component (A)) is 0.67 to 0.87 or 1.10 to 2.40.
[7] The curable resin composition according to any one of [1] to [4], wherein when the curable resin composition satisfies the (1),
the component (C) is the aromatic amine (c2) or the alicyclic amine (c3), and the contained amount of the component (C) in the curable resin composition is such that a ratio of a molar mass of active hydrogen atom of an amine in the component (C) to a molar mass of an epoxy group in the component (A) contained in the curable resin composition (molar mass of active hydrogen atom of the amine in the component (C)/molar mass of the epoxy group in the component (A)) is 0.67 to 0.87.
[8] The curable resin composition according to any one of [1] to [7], wherein when the curable resin composition satisfies the (1) and/or (2),
the component (A) further contains a glycidyl amine type epoxy resin, and in 100 parts by mass of the component (A), a contained amount of the glycidyl amine type epoxy resin is 29 parts by mass or less.
[9] The curable resin composition according to any one of [1] to [8], wherein when the curable resin composition satisfies the (1),
the component (A) satisfies any of the following (i), (ii) or (iii):
(i) the component (A) contains a polyfunctional epoxy group-containing substance (a1) having an epoxy equivalent weight of 300 g/eq or more and less than 3000 g/eq, and having two or more epoxy groups per molecule, and a contained amount of the polyfunctional epoxy group-containing substance (a1) in 100 parts by mass of the component (A) is 5 parts by mass to 100 parts by mass;
(ii) the component (A) contains a monofunctional epoxy group-containing substance (a2) having one epoxy group per molecule, and a contained amount of the monofunctional epoxy group-containing substance (a2) in 100 parts by mass of the component (A) is 5 parts by mass to 40 parts by mass;
(iii) the component (A) contains the polyfunctional epoxy group-containing substance (a1) and the monofunctional epoxy group-containing substance (a2), and a contained amount of the polyfunctional epoxy group-containing substance (a1) in 100 parts by mass of the component (A) is 5 parts by mass to 95 parts by mass, and a contained amount of the monofunctional epoxy group-containing substance (a2) in 100 parts by mass of the component (A) is 5 parts by mass to 40 parts by mass.
[10] The curable resin composition according to any one of [1] to [4], wherein when the curable resin composition satisfies the (3),
the number of active hydrogen atoms in an amino group of the component (C) is on average 1.5 or more and less than 3.8 per molecule.
[11]A cured product obtained by curing the curable resin composition according to any one of [1] to [10].
[12]A laminate including: at least two base materials; and an adhesive layer that is for bonding the at least two base materials and that is obtained by curing an adhesive agent containing the curable resin composition according to any one of [1] to [10].
[13]A fiber-reinforced composite material including: the curable resin composition according to any one of [1] to [10]; and a fiber.
[14]A wheel including the fiber-reinforced composite material according to [13].
[15]A high-pressure vessel including the fiber-reinforced composite material according to [13].

One or more embodiments of the present invention may be configured as follows.
[A1]A curable resin composition containing: the following component (A); the following component (B); and the following component (C); and not containing the following component (D) or further containing the following component (D):
   component (A): an epoxy group-containing substance containing at least one type selected from the group consisting of a bisphenol A epoxy resin, a bisphenol F epoxy resin, and an alicyclic epoxy resin;
   component (B): polymer particles having a core-shell structure that includes a core layer and a shell layer;
   component (C): an acid anhydride (c1) or an aromatic amine (c2);
   component (D): a curing accelerator,
in 100 parts by mass of the component (A), a total contained amount of the bisphenol A epoxy resin, the bisphenol F epoxy resin, and the alicyclic epoxy resin is 60 parts by mass to 100 parts by mass, a contained amount of the component (B) is 1 part by mass to 100 parts by mass with respect to 100 parts by mass of the component (A), a contained amount of the component (C) is 10 parts by mass to 200 parts by mass with respect to 100 parts by mass of the component (A), and when the component (D) is contained, a contained amount of the component (D) is 0.1 parts by mass to 10.0 parts by mass with respect to 100 parts by mass of the component (A),
the value X calculated by the following formula is 1.05 to 5.50 when the component (C) is the acid anhydride (c1), and 1.30 to 9.00 when the component (C) is the aromatic amine (c2):

X={[273+Tₘᵢₙ(M)]/[273+Tmin_{(M}eq)]}×[E′_{(M}eq)]/[E′_{(M)}] formula:
wherein
a temperature at which a loss tangent is maximized, as determined by dynamic viscoelastic measurement under tensile mode and at a frequency of 1 Hz using a cured product (M) of a composition (M) as a sample, is defined as Ttg_{(M)} (°C), and the E′(M) represents a minimum value of a storage modulus (E′) in a temperature range of [Ttg_{(M)} (°C)] to [Ttg_{(M)}+25 (°C)] of the cured product (M), and the Tmin_{(M)} (°C) is a temperature (°C) at which a value of the E′_{(M)} is obtained,
a temperature at which a loss tangent is maximized, as determined by dynamic viscoelastic measurement under tensile mode and at a frequency of 1 Hz using a cured product (Meq) of a composition (Meq) as a sample, is defined as Ttg_{(Meq)} (°C), and the E′_{(Meq)} represents a minimum value of a storage modulus (E′) in a temperature range of [Ttg_{(Meq)} (°C)] to [Ttg_{(Meq)}+25 (°C)] of the cured product (Meq), and the Tmin_{(Meq)} (°C) is a temperature (°C) at which a value of the E′_{(Meq)} is obtained,
the composition (M) contains the component (A), the component (C), and the component (D), which are the same as the component (A), the component (C), and the component (D) contained in the curable resin composition, and respective contained amounts of the component (A), the component (C), and the component (D) in the composition (M) are the same as respective contained amounts of the component (A), the component (C), and the component (D) in the curable resin composition,
the composition (Meq) contains the component (A), the component (C), and the component (D), which are the same as the component (A), the component (C), and the component (D) contained in the curable resin composition, and respective contained amounts of the component (A) and the component (D) in the composition (Meq) are the same as respective contained amounts of the component (A) and the component (D) in the curable resin composition, and when the component (C) in the composition (Meq) is the acid anhydride (c1), a contained amount of the component (C) in the composition (Meq) is such that a ratio of a molar mass of an acid anhydride group in the component (C) to a molar mass of an epoxy group in the component (A) contained in the composition (Meq) (molar mass of acid anhydride group in the component (C)/molar mass of the epoxy group in the component (A)) is 1, and when the component (C) in the composition (Meq) is the aromatic amine (c2), a contained amount of the component (C) in the composition (Meq) is such that a ratio of a molar mass of active hydrogen atom of an amine in the component (C) to a molar mass of an epoxy group in the component (A) contained in the composition (Meq) (molar mass of active hydrogen atom of the amine in the component (C)/molar mass of the epoxy group in the component (A)) is 1.
[A2] The curable resin composition according to [A1], wherein the component (B) contains at least one type of polymer particles selected from the group consisting of the following polymer particles (B-1), polymer particles (B-2), and polymer particles (B-3): the polymer particles (B-1): polymer particles in which the shell layer has an epoxy group, and a contained amount of the epoxy group in the shell layer with respect to a total mass of the shell layer is 0.2 mmol/g to 5.0 mmol/g; the polymer particles (B-2): polymer particles in which the core layer is diene-based rubber obtained by polymerizing a monomer mixture containing (bi) conjugated diene-based monomer in an amount of 50% by mass to 99.99% by mass, (b2) vinyl-based monomer that is copolymerizable with the conjugated diene-based monomer, in an amount of 0% by mass to 49.99% by mass, and (b3) chain transfer agent in an amount of 0.01% by mass to 3.00% by mass, where a total of the conjugated diene-based monomer (b1), the vinyl-based monomer (b2) that is copolymerizable with the conjugated diene-based monomer, and the chain transfer agent (b3) is 100% by mass; the polymer particles (B-3): polymer particles in which the core layer is diene-based rubber obtained by polymerizing a monomer mixture containing (bi) conjugated diene-based monomer in an amount of 50% by mass to 99.99% by mass, (b2) vinyl-based monomer that is copolymerizable with the conjugated diene-based monomer, in an amount of 0% by mass to 49.99% by mass, and (b3) chain transfer agent in an amount of 0.01% by mass to 3.00% by mass, where a total of the conjugated diene-based monomer (b1), the vinyl-based monomer (b2) that is copolymerizable with the conjugated diene-based monomer, and the chain transfer agent (b3) is 100% by mass, and the shell layer has an epoxy group, and a contained amount of the epoxy group in the shell layer with respect to a total mass of the shell layer is 0.2 mmol/g to 5.0 mmol/g.
[A3] The curable resin composition according to [A1] or [A2], wherein the component (C) is the acid anhydride (c1), and the contained amount of the component (C) in the curable resin composition is such that a ratio of a molar mass of an acid anhydride group in the component (C) to a molar mass of an epoxy group in the component (A) contained in the curable resin composition (molar mass of acid anhydride group in the component (C)/molar mass of the epoxy group in the component (A)) is 0.35 to 0.87.
[A4] The curable resin composition according to [A1] or [A2], wherein the component (C) is the aromatic amine (c2), and a contained amount of the component (C) in the curable resin composition is such that a ratio of a molar mass of active hydrogen atom of an amine in the component (C) to a molar mass of an epoxy group in the component (A) contained in the curable resin composition (molar mass of active hydrogen atom of the amine in the component (C)/molar mass of the epoxy group in the component (A)) is 0.67 to 0.87 or 1.10 to 2.40.
[A5] The curable resin composition according to [A1] or [A2], wherein the component (C) is the aromatic amine (c2), and a contained amount of the component (C) in the curable resin composition is such that a ratio of a molar mass of active hydrogen atom of an amine in the component (C) to a molar mass of an epoxy group in the component (A) contained in the curable resin composition (molar mass of active hydrogen atom of the amine in the component (C)/molar mass of the epoxy group in the component (A)) is 0.67 to 0.87.
[A6] The curable resin composition according to any one of [A1] to [A5], wherein the component (A) further contains a glycidyl amine type epoxy resin, and a contained amount of the glycidyl amine type epoxy resin in 100 parts by mass of the component (A) is 29 parts by mass or less.
[A7] The curable resin composition according to any one of [A1] to [A6], wherein the component (A) satisfies any one of the following (i), (ii), or (iii):
(i) the component (A) contains a polyfunctional epoxy group-containing substance (a1) having an epoxy equivalent weight of 300 g/eq or more and less than 3000 g/eq, and having two or more epoxy groups per molecule, and a contained amount of the polyfunctional epoxy group-containing substance (a1) in 100 parts by mass of the component (A) is 5 parts by mass to 100 parts by mass; (ii) the component (A) contains a monofunctional epoxy group-containing substance (a2) having one epoxy group per molecule, and a contained amount of the monofunctional epoxy group-containing substance (a2) in 100 parts by mass of the component (A) is 5 parts by mass to 40 parts by mass; (iii) the component (A) contains the polyfunctional epoxy group-containing substance (a1) and the monofunctional epoxy group-containing substance (a2), and a contained amount of the polyfunctional epoxy group-containing substance (a1) in 100 parts by mass of the component (A) is 5 parts by mass to 95 parts by mass, and a contained amount of the monofunctional epoxy group-containing substance (a2) in 100 parts by mass of the component (A) is 5 parts by mass to 40 parts by mass.
[A8] The curable resin composition according to [A2], wherein the core layer of the polymer particles (B-1) contains at least one type selected from the group consisting of diene-based rubber, (meth)acrylate-based rubber, and organosiloxane-based rubber.
[A9]A cured product obtained by curing the curable resin composition according to any one of [A1] to [A8].
[A10]A fiber-reinforced composite material containing: the curable resin composition according to any one of [A1] to [A8]; and a fiber.
[A11] The fiber-reinforced composite material according to [A10], wherein the fiber is a carbon fiber.
[A12]A wheel containing the fiber-reinforced composite material according to [A10] or [A11].
[A13]A vehicle wheel containing the fiber-reinforced composite material according to [A10] or [A11].

One or more embodiments of the present invention may be configured as follows.
[B1]A curable resin composition containing: the following component (A); the following component (B); and the following component (C); and not containing the following component (D) or further containing the following component (D):
   component (A): an epoxy group-containing substance containing at least one type selected from the group consisting of a bisphenol A epoxy resin, a bisphenol F epoxy resin, and an alicyclic epoxy resin;
   component (B): polymer particles having a core-shell structure that includes a core layer and a shell layer;
   component (C): alicyclic amine;
   component (D): a curing accelerator,
in 100 parts by mass of the component (A), a total contained amount of the bisphenol A epoxy resin, the bisphenol F epoxy resin, and the alicyclic epoxy resin is 60 parts by mass to 100 parts by mass, a contained amount of the component (B) is 1 part by mass to 100 parts by mass with respect to 100 parts by mass of the component (A), a contained amount of the component (C) is 5 parts by mass to 200 parts by mass with respect to 100 parts by mass of the component (A), and when the component (D) is contained, a contained amount of the component (D) is 0.1 parts by mass to 10.0 parts by mass with respect to 100 parts by mass of the component (A), and
a value X calculated by the following formula is 1.30 to 9.00:

X={[273+Tmin(M)]/[273+Tmin(Meq)]}×[E′(Meq)]/[E′(M)] formula:
wherein
a temperature at which a loss tangent is maximized, as determined by dynamic viscoelastic measurement under tensile mode and at a frequency of 1 Hz using a cured product (M) of a composition (M) as a sample, is defined as Ttg(M) (°C), and the E′(M) represents a minimum value of a storage modulus (E′) in a temperature range of [Ttg(M) (°C)] to [Ttg(M)+25 (°C)] of the cured product (M), and the Tmin(M) (°C) is a temperature (°C) at which a value of the E′(M) is obtained,
a temperature at which a loss tangent is maximized, as determined by dynamic viscoelastic measurement under tensile mode and at a frequency of 1 Hz using a cured product (Meq) of a composition (Meq) as a sample, is defined as Ttg(Meq) (°C), and the E′(Meq) represents a minimum value of a storage modulus (E′) in a temperature range of [Ttg(Meq) (°C)] to [Ttg(Meq)+25 (°C)] of the cured product (Meq), and the Tmin(Meq) (°C) is a temperature (°C) at which a value of the E′(Meq) is obtained,
the composition (M) contains the component (A), the component (C), and the component (D), which are the same as the component (A), the component (C), and the component (D) contained in the curable resin composition, and respective contained amounts of the component (A), the component (C), and the component (D) in the composition (M) are the same as respective contained amounts of the component (A), the component (C), and the component (D) in the curable resin composition, and
the composition (Meq) contains the component (A), the component (C), and the component (D), which are the same as the component (A), the component (C), and the component (D) contained in the curable resin composition, and respective contained amounts of the component (A) and the component (D) in the composition (Meq) are the same as respective contained amounts of the component (A) and the component (D) in the curable resin composition, and the contained amount of the component (C) in the composition (Meq) is such that a ratio of a molar mass of active hydrogen atom of an amine in the component (C) to a molar mass of an epoxy group in the component (A) contained in the composition (Meq) (molar mass of active hydrogen atom of the amine in the component (C)/molar mass of the epoxy group in the component (A)) is 1.
[B2] The curable resin composition according to [B1], wherein the component (B) contains at least one type of polymer particles selected from the group consisting of the following polymer particles (B-1), polymer particles (B-2), and polymer particles (B-3): the polymer particles (B-1): polymer particles in which the shell layer has an epoxy group, and a contained amount of the epoxy group in the shell layer with respect to a total mass of the shell layer is 0.2 mmol/g to 5.0 mmol/g; the polymer particles (B-2): polymer particles in which the core layer is diene-based rubber obtained by polymerizing a monomer mixture containing (b1) conjugated diene-based monomer in an amount of 50% by mass to 99.99% by mass, (b2) vinyl-based monomer that is copolymerizable with the conjugated diene-based monomer, in an amount of 0% by mass to 49.99% by mass, and (b3) chain transfer agent in an amount of 0.01% by mass to 3.00% by mass, where a total of the conjugated diene-based monomer (b1), the vinyl-based monomer (b2) that is copolymerizable with the conjugated diene-based monomer, and the chain transfer agent (b3) is 100% by mass; the polymer particles (B-3): polymer particles in which the core layer is diene-based rubber obtained by polymerizing a monomer mixture containing (b1) conjugated diene-based monomer in an amount of 50% by mass to 99.99% by mass, (b2) vinyl-based monomer that is copolymerizable with the conjugated diene-based monomer, in an amount of 0% by mass to 49.99% by mass, and (b3) chain transfer agent in an amount of 0.01% by mass to 3.00% by mass, where a total of the conjugated diene-based monomer (bi), the vinyl-based monomer (b2) that is copolymerizable with the conjugated diene-based monomer, and the chain transfer agent (b3) is 100% by mass, and the shell layer has an epoxy group, and a contained amount of the epoxy group in the shell layer with respect to a total mass of the shell layer is 0.2 mmol/g to 5.0 mmol/g.
[B3] The curable resin composition according to [B1] or [B2], wherein the contained amount of the component (C) in the curable resin composition is such that a ratio of a molar mass of active hydrogen atom of an amine in the component (C) to a molar mass of an epoxy group in the component (A) contained in the curable resin composition (molar mass of active hydrogen atom of the amine in the component (C)/molar mass of the epoxy group in the component (A)) is 0.67 to 0.87 or 1.10 to 2.40.
[B4] The curable resin composition according to [B1] or [B2], wherein the contained amount of the component (C) in the curable resin composition is such that a ratio of a molar mass of active hydrogen atom of an amine in the component (C) to a molar mass of an epoxy group in the component (A) contained in the curable resin composition (molar mass of active hydrogen atom of the amine in the component (C)/molar mass of the epoxy group in the component (A)) is 0.67 to 0.87.
[B5] The curable resin composition according to any one of [B1] to [B4], wherein the component (A) further contains a glycidyl amine type epoxy resin, and
a contained amount of the glycidyl amine type epoxy resin in 100 parts by mass of the component (A) is 29 parts by mass or less.
[B6] The curable resin composition according to any one of [B1] to [B5], wherein the component (A) satisfies any one of the following (i), (ii), or (iii):
(i) the component (A) contains a polyfunctional epoxy group-containing substance (a1) having an epoxy equivalent weight of 300 g/eq or more and less than 3000 g/eq, and having two or more epoxy groups per molecule, and a contained amount of the polyfunctional epoxy group-containing substance (a1) in 100 parts by mass of the component (A) is 5 parts by mass to 100 parts by mass; (ii) the component (A) contains a monofunctional epoxy group-containing substance (a2) having one epoxy group per molecule, and a contained amount of the monofunctional epoxy group-containing substance (a2) in 100 parts by mass of the component (A) is 5 parts by mass to 40 parts by mass; (iii) the component (A) contains the polyfunctional epoxy group-containing substance (a1) and the monofunctional epoxy group-containing substance (a2), and a contained amount of the polyfunctional epoxy group-containing substance (a1) in 100 parts by mass of the component (A) is 5 parts by mass to 95 parts by mass, and a contained amount of the monofunctional epoxy group-containing substance (a2) in 100 parts by mass of the component (A) is 5 parts by mass to 40 parts by mass.
[B7] The curable resin composition according to [B2], wherein the core layer of the polymer particles (B-1) contains at least one type selected from the group consisting of diene-based rubber, (meth)acrylate-based rubber, and organosiloxane-based rubber.
[B8]A cured product obtained by curing the curable resin composition according to any one of [B1] to [B7].
[B9]A fiber-reinforced composite material containing: the curable resin composition according to any one of [B1] to [B7]; and a fiber.
[B10] The fiber-reinforced composite material according to [B9], wherein the fiber is a carbon fiber.
[B11]A wheel containing the fiber-reinforced composite material according to [B9] or [B10].
[B12]A vehicle wheel containing the fiber-reinforced composite material according to [B9] or [B10].

One or more embodiments of the present invention may be configured as follows.
[C1]A curable resin composition containing: the following component (A); the following component (B); and the following component (C); and not containing the following component (D) or further containing the following component (D):
   component (A): an epoxy group-containing substance containing at least one type selected from the group consisting of a bisphenol A epoxy resin, a bisphenol F epoxy resin, and an alicyclic epoxy resin;
   component (B): polymer particles having a core-shell structure that includes a core layer and a shell layer;
   component (C): an epoxy curing agent containing at least one type selected from the group consisting of an acid anhydride (c1), an aromatic amine (c2), and an alicyclic amine (c3);
   component (D): a curing accelerator,
in 100 parts by mass of the component (A), a total contained amount of the bisphenol A epoxy resin, the bisphenol F epoxy resin, and the alicyclic epoxy resin is 5 parts by mass to 100 parts by mass, a contained amount of the component (B) is 1 part by mass to 100 parts by mass with respect to 100 parts by mass of the component (A), a contained amount of the component (C) is 10 parts by mass to 200 parts by mass with respect to 100 parts by mass of the component (A), and when the component (D) is contained, a contained amount of the component (D) is 0.1 parts by mass to 10.0 parts by mass with respect to 100 parts by mass of the component (A), and the component (A) satisfies any of the following (i), (ii), or (iii):
(i) the component (A) contains a polyfunctional epoxy group-containing substance (a1) having an epoxy equivalent weight of 300 g/eq or more and less than 3000 g/eq, and having two or more epoxy groups per molecule, and a contained amount of the polyfunctional epoxy group-containing substance (a1) in 100 parts by mass of the component (A) is 5 parts by mass to 100 parts by mass;
(ii) the component (A) contains a monofunctional epoxy group-containing substance (a2) having one epoxy group per molecule, and a contained amount of the monofunctional epoxy group-containing substance (a2) in 100 parts by mass of the component (A) is 5 parts by mass to 95 parts by mass;
(iii) the component (A) contains the polyfunctional epoxy group-containing substance (a1) and the monofunctional epoxy group-containing substance (a2), and a contained amount of the polyfunctional epoxy group-containing substance (a1) in 100 parts by mass of the component (A) is 5 parts by mass to 95 parts by mass, and a contained amount of the monofunctional epoxy group-containing substance (a2) in 100 parts by mass of the component (A) is 5 parts by mass to 95 parts by mass, and
a value Y calculated by the following formula is 22 to 400:

Y=[273+Tmin(M)]/[E′(M)], formula:
wherein
a temperature at which a loss tangent is maximized, as determined by dynamic viscoelastic measurement under tensile mode and at a frequency of 1 Hz using a cured product (M) of a composition (M) as a sample, is defined as Ttg(M) (°C), and the E′(M) represents a minimum value of a storage modulus (E′) in a temperature range of [Ttg(M) (°C)] to [Ttg(M)+25 (°C)] of the cured product (M), and the Tmin(M) (°C) is a temperature (°C) at which a value of the E′(M) is obtained,
the composition (M) contains the component (A), the component (C), and the component (D), which are the same as the component (A), the component (C), and the component (D) contained in the curable resin composition, and respective contained amounts of the component (A), the component (C), and the component (D) in the composition (M) are the same as respective contained amounts of the component (A), the component (C), and the component (D) in the curable resin composition, and
the cured product (M) is a cured product obtained by curing the composition (M) under the following curing conditions:
   when the component (C) is the acid anhydride (c1), curing temperature is 175 °C and curing time is 2 hours;
   when the component (C) is the aromatic amine (c2), curing temperature is 175 °C and curing time is 2 hours;
   when the component (C) is the alicyclic amine (c3), curing temperature is 120 °C and curing time is 2 hours.
[C2] The curable resin composition according to [C1], wherein the component (B) contains at least one type of polymer particles selected from the group consisting of the following polymer particles (B-1), polymer particles (B-2), and polymer particles (B-3):
the polymer particles (B-1): polymer particles in which the shell layer has an epoxy group, and a contained amount of the epoxy group in the shell layer with respect to a total mass of the shell layer is 0.2 mmol/g to 5.0 mmol/g;
the polymer particles (B-2): polymer particles in which the core layer is diene-based rubber obtained by polymerizing a monomer mixture containing (b1) conjugated diene-based monomer in an amount of 50% by mass to 99.99% by mass, (b2) vinyl-based monomer that is copolymerizable with the conjugated diene-based monomer, in an amount of 0% by mass to 49.99% by mass, and (b3) chain transfer agent in an amount of 0.01% by mass to 3.00% by mass, where a total of the conjugated diene-based monomer (b1), the vinyl-based monomer (b2) that is copolymerizable with the conjugated diene-based monomer, and the chain transfer agent (b3) is 100% by mass;
the polymer particles (B-3): polymer particles in which the core layer is diene-based rubber obtained by polymerizing a monomer mixture containing (b1) conjugated diene-based monomer in an amount of 50% by mass to 99.99% by mass, (b2) vinyl-based monomer that is copolymerizable with the conjugated diene-based monomer, in an amount of 0% by mass to 49.99% by mass, and (b3) chain transfer agent in an amount of 0.01% by mass to 3.00% by mass, where a total of the conjugated diene-based monomer (b1), the vinyl-based monomer (b2) that is copolymerizable with the conjugated diene-based monomer, and the chain transfer agent (b3) is 100% by mass, and the shell layer has an epoxy group, and a contained amount of the epoxy group in the shell layer with respect to a total mass of the shell layer is 0.2 mmol/g to 5.0 mmol/g.
[C3] The curable resin composition according to [C1] or [C2], wherein the component (A) further contains a glycidyl amine type epoxy resin, and in 100 parts by mass of the component (A), a contained amount of the glycidyl amine type epoxy resin is 29 parts by mass or less.
[C4] The curable resin composition according to [C2], wherein the core layer of the polymer particles (B-1) contains at least one type selected from the group consisting of diene-based rubber, (meth)acrylate-based rubber, and organosiloxane-based rubber.
[C5] The curable resin composition according to any one of [C1] to [C4], wherein the core layer of the component (B) is butadiene rubber and/or butadiene-styrene rubber.
[C6] The curable resin composition according to any one of [C1] to [C5], wherein the shell layer contains at least one type of structural unit selected from the group consisting of an aromatic vinyl-based unit, a vinyl cyanide-based unit, and a (meth)acrylate-based unit.
[C7]A cured product obtained by curing the curable resin composition according to any one of [C1] to [C6].
[C8]A fiber-reinforced composite material containing: the curable resin composition according to any one of [C1] to [C6]; and a fiber.
[C9] The fiber-reinforced composite material according to [C8], wherein the fiber is a carbon fiber.
[C10]A wheel containing the fiber-reinforced composite material according to [C8] or [C9].
[C11]A vehicle wheel containing the fiber-reinforced composite material according to [C8] or [C9].
[C12]A high-pressure vessel including the fiber-reinforced composite material according to [C8] or [C9].

One or more embodiments of the present invention may be configured as follows.
[D1]A curable resin composition containing:
the following component (A), component (B), and component (C),
and not containing the following component (D) or further containing the following component (D):
   component (A): an epoxy group-containing substance containing at least one type selected from the group consisting of a bisphenol A epoxy resin, a bisphenol F epoxy resin, and an alicyclic epoxy resin;
   component (B): polymer particles having a core-shell structure that includes a core layer and a shell layer;
   component (C): an amine-based epoxy curing agent containing an amine (c1) with 1 or 2 active hydrogen atoms in an amino group per molecule;
   component (D): a curing accelerator,
in 100 parts by mass of the component (A), a total contained amount of the bisphenol A epoxy resin, the bisphenol F epoxy resin, and the alicyclic epoxy resin is 5 parts by mass to 100 parts by mass,
a contained amount of the component (B) is 1 part by mass to 100 parts by mass with respect to 100 parts by mass of the component (A),
a contained amount of the component (C) is 10 parts by mass to 200 parts by mass with respect to 100 parts by mass of the component (A),
when the curable resin composition contains the component (D), a contained amount of the component (D) is 0.1 parts by mass to 20.0 parts by mass with respect to 100 parts by mass of the component (A),
a contained amount of the amine (c1) in the component (C) is 5% by mass to 100% by mass in 100% by mass of the component (C), and
a value Y calculated by the following formula is 22 to 400:

Y=[273+Tmin(M)]/[E′(M)] formula:
wherein
a temperature at which a loss tangent is maximized, as determined by dynamic viscoelastic measurement under tensile mode and at a frequency of 1 Hz using a cured product (M) of a composition (M) as a sample, is defined as Ttg(M) (°C), and the E′(M) represents a minimum value of a storage modulus (E′) in a temperature range of [Ttg(M) (°C)] to [Ttg(M)+25 (°C)] of the cured product (M), and the Tmin(M) (°C) is a temperature (°C) at which a value of the E′(M) is obtained,
the composition (M) contains the component (A), the component (C), and the component (D), which are the same as the component (A), the component (C), and the component (D) contained in the curable resin composition,
respective contained amounts of the component (A), the component (C), and the component (D) in the composition (M) are the same as respective contained amounts of the component (A), the component (C), and the component (D) in the curable resin composition, and
the cured product (M) is a cured product obtained by curing the composition (M) at a curing temperature of 120 °C for a curing time of 2 hours.
[D2]A two-component type or multi-component type curable resin composition containing a first component and a second component, wherein
the first component contains the following component (A),
the second component contains the following component (C), and does not contain the following component (D) or further contains the following component (D), and
the curable resin composition further contains the following component (B):
   component (A): an epoxy group-containing substance containing at least one type selected from the group consisting of a bisphenol A epoxy resin, a bisphenol F epoxy resin, and an alicyclic epoxy resin;
   component (B): polymer particles having a core-shell structure that includes a core layer and a shell layer;
   component (C): an amine-based epoxy curing agent containing an amine (c1) with 1 or 2 active hydrogen atoms in an amino group per molecule;
   component (D): a curing accelerator,
in 100 parts by mass of the component (A), a total contained amount of the bisphenol A epoxy resin, the bisphenol F epoxy resin, and the alicyclic epoxy resin is 5 parts by mass to 100 parts by mass,
a contained amount of the component (B) is 1 part by mass to 100 parts by mass with respect to 100 parts by mass of the component (A),
a contained amount of the component (C) is 10 parts by mass to 200 parts by mass with respect to 100 parts by mass of the component (A),
when the curable resin composition contains the component (D), a contained amount of the component (D) is 0.1 parts by mass to 20.0 parts by mass with respect to 100 parts by mass of the component (A),
the contained amount of the amine (c1) in the component (C) is 5% by mass to 100% by mass in 100% by mass of the component (C), and
a value Y calculated by the following formula is 22 to 400:

Y=[273+Tmin(M)]/[E′(M)], formula:
wherein
a temperature at which a loss tangent is maximized, as determined by dynamic viscoelastic measurement under tensile mode and at a frequency of 1 Hz using a cured product (M) of a composition (M) as a sample, is defined as Ttg(M) (°C), and the E′(M) represents a minimum value of a storage modulus (E′) in a temperature range of [Ttg(M) (°C)] to [Ttg(M)+25 (°C)] of the cured product (M), and the Tmin(M) (°C) is a temperature (°C) at which a value of the E′(M) is obtained,
the composition (M) contains the component (A), the component (C), and the component (D), which are the same as the component (A), the component (C), and the component (D) contained in the curable resin composition,
respective contained amounts of the component (A), the component (C), and the component (D) in the composition (M) are the same as respective contained amounts of the component (A), the component (C), and the component (D) in the curable resin composition, and
the cured product (M) is a cured product obtained by curing the composition (M) at a curing temperature of 120 °C for a curing time of 2 hours.
[D3] The curable resin composition according to [D1] or [D2], wherein the number of active hydrogen atoms in an amino group of the component (C) is on average 1.5 or more and less than 3.8 per molecule.
[D4] The curable resin composition according to any one of [D1] to [D3], wherein the component (C) further contains an alicyclic amine (c2) with 4 active hydrogen atoms in an amino group per molecule, and a contained amount of the amine (c2) in the component (C) is 0.1% by mass to 95.0% by mass in 100% by mass of the component (C).
[D5] The curable resin composition according to any one of [D1] to [D4], wherein the component (B) contains at least one type of polymer particles selected from the group consisting of the following polymer particles (B-1), polymer particles (B-2), and polymer particles (B-3):
the polymer particles (B-1):
   polymer particles in which the shell layer has an epoxy group, and a contained amount of the epoxy group in the shell layer with respect to a total mass of the shell layer is 0.2 mmol/g to 5.0 mmol/g;
the polymer particles (B-2):
   polymer particles in which the core layer is diene-based rubber obtained by polymerizing a monomer mixture containing (bi) a conjugated diene-based monomer in an amount of 50.00% by mass to 99.99% by mass, (b2) a vinyl-based monomer that is copolymerizable with the conjugated diene-based monomer, in an amount of 0.00% by mass to 49.99% by mass, and (b3) a chain transfer agent in an amount of 0.01% by mass to 3.00% by mass, where a total of the conjugated diene-based monomer (b1), the vinyl-based monomer (b2) that is copolymerizable with the conjugated diene-based monomer, and the chain transfer agent (b3) is 100% by mass;
the polymer particles (B-3):
   polymer particles in which the core layer is diene-based rubber obtained by polymerizing a monomer mixture containing (b1) a conjugated diene-based monomer in an amount of 50.00% by mass to 99.99% by mass, (b2) a vinyl-based monomer that is copolymerizable with the conjugated diene-based monomer, in an amount of 0.00% by mass to 49.99% by mass, and (b3) a chain transfer agent in an amount of 0.01% by mass to 3.00% by mass, where a total of the conjugated diene-based monomer (b1), the vinyl-based monomer (b2) that is copolymerizable with the conjugated diene-based monomer, and the chain transfer agent (b3) is 100% by mass, and the shell layer has an epoxy group, and a contained amount of the epoxy group in the shell layer with respect to a total mass of the shell layer is 0.2 mmol/g to 5.0 mmol/g.
[D6] The curable resin composition according to [D5], wherein the core layer of the polymer particles (B-1) contains at least one type selected from the group consisting of diene-based rubber, (meth)acrylate-based rubber, and organosiloxane-based rubber.
[D7] The curable resin composition according to any one of [D1] to [D6], wherein the core layer of the component (B) is a butadiene rubber and/or a butadiene-styrene rubber.
[D8] The curable resin composition according to any one of [D1] to[D7], wherein the shell layer contains at least one type of structural unit selected from the group consisting of an aromatic vinyl-based unit, a vinyl cyanide-based unit, and a (meth)acrylate-based unit.
[D9]A cured product obtained by curing the curable resin composition according to any one of [D1] to [D8].
[D10] An adhesive agent containing the curable resin composition according to any one of [D1] to [D8].
[D11]A laminate including: at least two base materials; and an adhesive layer that is for bonding the at least two base materials and that is obtained by curing the adhesive agent according to [D10].
[D12]A fiber-reinforced composite material including: the curable resin composition according to any one of [D1] to [D8]; and a fiber.
[D13] The fiber-reinforced composite material according to [D12], wherein the fiber is a carbon fiber.
[D14]A wheel containing the fiber-reinforced composite material according to [D12] or [D13].
[D15]A vehicle wheel containing the fiber-reinforced composite material according to [D12] or [D13].
[D16]A high-pressure vessel including the fiber-reinforced composite material according to [D12] or [D13].

### Examples

The following description will discuss one or more embodiments of the present invention in detail with reference to Examples and Comparative Examples. Note that the present invention is not limited to these examples. One or more embodiments of the present invention can be achieved by altering the following Examples as appropriate within the scope of the gist disclosed herein. One or more embodiments of the present invention also includes, in its technical scope, embodiments achieved by altering the following Examples as appropriate. Note that in the following examples, comparative examples, and tables, “parts” means “parts by mass”, and “%” means “% by mass”.

### [Material]

First, the substances used in the examples and comparative examples are shown below.

### <Component (A)>

A-(1): Alicyclic epoxy resin <3,4-epoxycyclohexylmethyl (3,4-epoxy) cyclohexanecarboxylate> (manufactured by Daicel Corporation, “CELLOXIDE 2021P”, epoxy equivalent weight: 130 g/eq)
A-(2): Bisphenol A epoxy resin <liquid bisphenol A epoxy resin at normal temperature> (manufactured by Mitsubishi Chemical Corporation “jER828”, epoxy equivalent weight: 189 g/eq)
A-(3): Bisphenol F epoxy resin <liquid bisphenol F epoxy resin at room temperature> (manufactured by Hexion Inc., “EPON 863”, epoxy equivalent weight: 170 g/eq)
A-(4): Other polyfunctional epoxy group-containing substance <1,4-butanediol diglycidyl ether> (manufactured by Huntsman Corporation, “ERISYS GE-21”, epoxy equivalent weight: 115 g/eq)
A-(5): Polyfunctional epoxy group-containing substance (a1)<polypropylene glycol diglycidyl ether> (manufactured by NIPPON STEEL Chemical & Material Co., Ltd., “PG-207”, epoxy equivalent weight: 315 g/eq)
A-(6): Polyfunctional epoxy group-containing substance (a1)<solid bisphenol A epoxy resin at room temperature> (manufactured by Mitsubishi Chemical Corporation, “JER1001”, epoxy equivalent weight: 480 g/eq)
A-(7): Monofunctional epoxy group-containing substance (a2)<o-cresyl glycidyl ether> (manufactured by Huntsman Corporation, “ERISYS GE-10”, epoxy equivalent weight: 182 g/eq)
A-(8): Glycidyl amine type epoxy resin <tetraglycidyl diamino diphenylmethane> (manufactured by Sumitomo Chemical Co., Ltd., “ELM-434VL”, epoxy equivalent weight: 115 g/eq)

### <Component (B)>

As the component (B), polymer particles prepared by the following method were used. Note that dispersions (M-(1) to M-(11)) in which the prepared component (B) (polymer particles) was dispersed in the component (A) (A-(1) or A-(2)) were prepared as described later, and these dispersions were used.

### 1. Formation of Core Layer

### Production Example 1-1: Preparation of Polybutadiene Rubber Latex (R-1)

Into a 100 L pressure-resistant polymerization apparatus were introduced 200 parts by mass of deionized water, 0.03 parts by mass of tripotassium phosphate, 0.25 parts by mass of potassium dihydrogenphosphate, 0.002 parts by mass of disodium ethylenediaminetetraacetate (EDTA), 0.001 parts by mass of ferrous sulfate heptahydrate (FE), and 1.5 parts by mass of sodium dodecylbenzenesulfonate (SDS) as an emulsifying agent. Next, while the materials thus introduced were stirred, gas in the pressure-resistant polymerization apparatus was replaced with nitrogen, so as to sufficiently remove oxygen from the inside of the pressure-resistant polymerization apparatus. Thereafter, 100 parts by mass of butadiene (BD) was introduced into the pressure-resistant polymerization apparatus, and the temperature inside the pressure-resistant polymerization apparatus was raised to 45 °C. Then, 0.015 parts by mass of paramenthane hydroperoxide (PHP) was introduced into the pressure-resistant polymerization apparatus, and subsequently 0.04 parts by mass of sodium formaldehyde sulfoxylate (SFS) was introduced into the pressure-resistant polymerization apparatus, and polymerization was commenced. At 10 hours from the start of polymerization, devolatilization was carried out under reduced pressure to remove the remaining monomer that was not used in polymerization, so as to end the polymerization. During the polymerization, PUP, EDTA, and FE were each added to the pressure-resistant polymerization apparatus in discretionarily selected amounts and discretionarily selected points in time. Through this polymerization operation, a latex (R-1), which included a core layer (polybutadiene rubber particles) whose main component was polybutadiene rubber, was obtained. The volume-average particle size of the polybutadiene rubber particles contained in the latex thus obtained was 0.10 μm.

### Production Example 1-2: Preparation of Polybutadiene Rubber Latex (R-2)

Into a 100 L pressure-resistant polymerization apparatus were introduced 21 parts by mass of the polybutadiene rubber latex (R-1) (including 7 parts by mass of polybutadiene rubber particles) obtained in Production Example 1-1, 200 parts by mass of deionized water, 0.03 parts by mass of tripotassium phosphate, 0.002 parts by mass of EDTA, and 0.001 parts by mass of FE. Next, while the materials thus introduced were stirred, gas in the pressure-resistant polymerization apparatus was replaced with nitrogen, so as to sufficiently remove oxygen from the inside of the pressure-resistant polymerization apparatus. Thereafter, 93 parts by mass of BD was introduced into the pressure-resistant polymerization apparatus, and the temperature inside the pressure-resistant polymerization apparatus was raised to 45 °C. Then, 0.02 parts by mass of PUP was introduced into the pressure-resistant polymerization apparatus, and subsequently 0.10 parts by mass of SFS was introduced into the pressure-resistant polymerization apparatus, and polymerization was commenced. At 30 hours from the start of polymerization, devolatilization was carried out under reduced pressure to remove the remaining monomer that was not used in polymerization, so as to end the polymerization. During the polymerization, PUP, EDTA, and FE were each added to the pressure-resistant polymerization apparatus in discretionarily selected amounts and discretionarily selected points in time. Through this polymerization operation, a latex (R-2), which included a core layer (polybutadiene rubber particles) whose main component was polybutadiene rubber, was obtained. The volume-average particle size of the polybutadiene rubber particles contained in the latex thus obtained was 0.20 μm.

### Production Example 1-3: Preparation of Polybutadiene Rubber Latex (R-3)

In a pressure-resistant polymerization apparatus with a volume of 100 L, 200 parts by mass of deionized water, 0.03 parts by mass of tripotassium phosphate, 0.002 parts by mass of EDTA, 0.001 parts by mass of FE, and 0.5 parts by mass of SDS as an emulsifier were introduced. Next, while the materials thus introduced were stirred, gas in the pressure-resistant polymerization apparatus was replaced with nitrogen, so as to sufficiently remove oxygen from the inside of the pressure-resistant polymerization apparatus. Thereafter, 99.6 parts by mass of BD and 0.4 parts by mass of t-dodecyl mercaptan were introduced into the pressure-resistant polymerization apparatus, and the temperature inside the pressure-resistant polymerization apparatus was raised to 45 °C. Then, 0.03 parts by mass of PHP was introduced into the pressure-resistant polymerization apparatus, and subsequently 0.10 parts by mass of SFS was introduced into the pressure-resistant polymerization apparatus, and polymerization was commenced. At 15 hours from the start of polymerization, devolatilization was carried out under reduced pressure to remove the remaining monomer that was not used in polymerization, so as to end the polymerization. During the polymerization, PHP, EDTA, and FE were each added to the pressure-resistant polymerization apparatus in discretionarily selected amounts and discretionarily selected points in time. Through this polymerization operation, a latex (R-3), which included a core layer (polybutadiene rubber particles) whose main component was polybutadiene rubber, was obtained. The volume-average particle size of the polybutadiene rubber particles contained in the latex thus obtained was 0.13 μm.

### 2. Preparation of Component (B) (Polymer Particles) (Formation of Shell Layer)

### Production Example 2-1: Preparation of Aqueous Latex (L-1) Containing Polymer Particles

To a glass reactor, 262 parts by mass of the polybutadiene rubber latex (R-2) prepared in Production Example 1-2 (including 87 parts by mass of polybutadiene rubber particles) and 57 parts by mass of deionized water were introduced. Here, the glass reactor had a thermometer, a stirrer, a reflux condenser, a nitrogen inlet, and a monomer adding device. The gas in the glass reactor was replaced with nitrogen, and during the replacement, the materials in the glass reactor were stirred at 60 °C. Next, 0.004 parts by mass of EDTA, 0.001 parts by mass of FE, and 0.2 parts by mass of SFS were added to the glass reactor. Thereafter, a mixture of a monomer for shell layer formation (8 parts by mass of methyl acrylate (MA), 3.5 parts by mass of butyl acrylate (BA), and 1.5 parts by mass of glycidyl methacrylate (GMA)) and 0.04 parts by mass of cumene hydroperoxide (CUP) was added continuously to the glass reactor over 120 minutes. After completion of the addition, 0.04 parts by mass of CHP was added to the glass reactor, and the resulting mixture in the glass reactor was stirred for 2 hours so as to finish polymerization. As a result of the above operations, an aqueous latex (L-1) containing component (B) (polymer particles) was obtained. The polymerization conversion ratio of the monomer component was 99% or more. The volume-average particle size of the polymer particles contained in the aqueous latex (L-1) thus obtained was 0.21 μm. The contained amount of an epoxy group with respect to the total mass of a shell layer in the polymer particles was 0.8 mmol/g.

### Production Example 2-2: Preparation of Aqueous Latex (L-2) Containing Polymer Particles

To a glass reactor, 271 parts by mass of the polybutadiene rubber latex (R-2) prepared in Production Example 1-2 (including 90 parts by mass of polybutadiene rubber particles) and 51 parts by mass of deionized water were introduced. Here, the glass reactor had a thermometer, a stirrer, a reflux condenser, a nitrogen inlet, and a monomer adding device. The gas in the glass reactor was replaced with nitrogen, and during the replacement, the materials in the glass reactor were stirred at 60 °C. Next, 0.004 parts by mass of EDTA, 0.001 parts by mass of FE, and 0.2 parts by mass of SFS were added to the glass reactor. Thereafter, a mixture of monomers for shell layer formation (9.25 parts by mass of methyl methacrylate (MMA) and 0.75 parts by mass of GMA) and 0.14 parts by mass of CHP was continuously added to a glass reactor over 120 minutes. After completion of the addition, 0.04 parts by mass of CHP was added to the glass reactor, and the resulting mixture in the glass reactor was stirred for 2 hours so as to finish polymerization. As a result of the above operations, an aqueous latex (L-2) containing component (B) (polymer particles) was obtained. The polymerization conversion ratio of the monomer component was 99% or more. The volume-average particle size of the polymer particles contained in the aqueous latex (L-2) thus obtained was 0.21 μm. The contained amount of an epoxy group with respect to the total mass of a shell layer in the polymer particles was 0.5 mmol/g.

### Production Example 2-3: Preparation of Aqueous Latex (L-3) Containing Polymer Particles

An aqueous latex (L-3) containing the component (B) (polymer particles) was obtained by the same method as in Production Example 2-2, except that, as the monomer for shell layer formation, <10 parts by mass of MMA> was used instead of <9.25 parts by mass of MMA and 0.75 parts by mass of GMA> in Production Example 2-2. The volume-average particle size of the polymer particles (B) contained in the aqueous latex (L-3) thus obtained was 0.21 μm. The contained amount of an epoxy group with respect to the total mass of a shell layer in the polymer particles (B) was 0 mmol/g.

### Production Example 2-4: Preparation of Aqueous Latex (L-4) Containing Polymer Particles

To a glass reactor, 250 parts by mass of the polybutadiene rubber latex (R-3) prepared in Production Example 1-3 (including 83 parts by mass of polybutadiene rubber particles) and 65 parts by mass of deionized water were introduced. Here, the glass reactor had a thermometer, a stirrer, a reflux condenser, a nitrogen inlet, and a monomer adding device. The gas in the glass reactor was replaced with nitrogen, and during the replacement, the materials in the glass reactor were stirred at 60 °C. Next, 0.0048 parts by mass of EDTA, 0.0012 parts by mass of FE, and 0.15 parts by mass of SFS were added to the glass reactor. Thereafter, a mixture of monomers for shell layer formation (16.5 parts by mass of MMA and 0.5 parts by mass of BA) and 0.078 parts by mass of CHP was continuously added to a glass reactor over 120 minutes. After completion of the addition, 0.04 parts by mass of CHP was added to the glass reactor, and the resulting mixture in the glass reactor was stirred for 2 hours so as to finish polymerization. As a result of the above operations, an aqueous latex (L-4) containing component (B) (polymer particles) was obtained. The polymerization conversion ratio of the monomer component was 99% or more. The volume-average particle size of the polymer particles contained in the aqueous latex (L-4) thus obtained was 0.14 μm. The contained amount of an epoxy group with respect to the total mass of a shell layer in the polymer particles was 0 mmol/g.

### Production Example 2-5: Preparation of Aqueous Latex (L-5) Containing Polymer Particles

An aqueous latex (L-5) containing the component (B) (polymer particles) was obtained by the same method as in Production Example 2-4, except that, as the monomer for shell layer formation, <15 parts by mass of MMA, 0.5 parts by mass of BA, and 1.5 parts by mass of GMA> were used instead of <16.5 parts by mass of MMA and 0.5 parts by mass of BA> in Production Example 2-4. The volume-average particle size of the polymer particles (B) contained in the aqueous latex (L-5) thus obtained was 0.14 μm. The contained amount of an epoxy group with respect to the total mass of a shell layer in the polymer particles (B) was 0.6 mmol/g.

### Production Example 2-6: Preparation of Aqueous Latex (L-6) Containing Polymer Particles

To a glass reactor, 262 parts by mass of the polybutadiene rubber latex (R-2) prepared in Production Example 1-2 (including 87 parts by mass of polybutadiene rubber particles) and 57 parts by mass of deionized water were introduced. Here, the glass reactor had a thermometer, a stirrer, a reflux condenser, a nitrogen inlet, and a monomer adding device. The gas in the glass reactor was replaced with nitrogen, and during the replacement, the materials in the glass reactor were stirred at 60 °C. Next, 0.0024 parts by mass of EDTA, 0.0006 parts by mass of FE, and 0.13 parts by mass of SFS were added to the glass reactor. Thereafter, a mixture of monomers for shell layer formation (4 parts by mass of MMA, 6 parts by mass of styrene (ST), 2 parts by mass of acrylonitrile (AN), and 1 part by mass of GMA) and 0.058 parts by mass of CHP was continuously added to a glass reactor over 120 minutes. After completion of the addition, 0.11 parts by mass of CHP was added to the glass reactor, and the resulting mixture in the glass reactor was stirred for 2 hours so as to finish polymerization. As a result of the above operations, an aqueous latex (L-6) containing component (B) (polymer particles) was obtained. The polymerization conversion ratio of the monomer component was 99% or more. The volume-average particle size of the polymer particles contained in the aqueous latex (L-6) thus obtained was 0.21 μm. The contained amount of an epoxy group with respect to the total mass of a shell layer in the polymer particles was 0.5 mmol/g.

### Production Example 2-7: Preparation of Aqueous Latex (L-7) Containing Polymer Particles

An aqueous latex (L-7) containing the component (B) (polymer particles) was obtained by the same method as in Production Example 2-6, except that, as the monomer for shell layer formation, <3 parts by mass of MMA, 6 parts by mass of ST, 2 parts by mass of AN, and 2 parts by mass of GMA> were used instead of <4 parts by mass of MMA, 6 parts by mass of ST, 2 parts by mass of AN, and 1 part by mass of GMA> in Production Example 2-6. The volume-average particle size of the polymer particles (B) contained in the aqueous latex (L-7) thus obtained was 0.21 μm. The contained amount of an epoxy group with respect to the total mass of a shell layer in the polymer particles (B) was 1.1 mmol/g.

### Production Example 2-8: Preparation of Aqueous Latex (L-8) Containing Polymer Particles

An aqueous latex (L-8) containing the component (B) (polymer particles) was obtained by the same method as in Production Example 2-6, except that, as the monomer for shell layer formation, <1 part by mass of MMA, 6 parts by mass of ST, 2 parts by mass of AN, and 4 parts by mass of GMA> were used instead of <4 parts by mass of MMA, 6 parts by mass of ST, 2 parts by mass of AN, and 1 part by mass of GMA> in Production Example 2-6. The volume-average particle size of the polymer particles (B) contained in the aqueous latex (L-8) thus obtained was 0.21 μm. The contained amount of an epoxy group with respect to the total mass of a shell layer in the polymer particles (B) was 2.2 mmol/g.

### Production Example 2-9: Preparation of Aqueous Latex (L-9) Containing Polymer Particles

An aqueous latex (L-9) containing the component (B) (polymer particles) was obtained by the same method as in Production Example 2-6, except that, as the monomer for shell layer formation, <5 parts by mass of MMA, 6 parts by mass of ST, and 2 parts by mass of AN> were used instead of <4 parts by mass of MMA, 6 parts by mass of ST, 2 parts by mass of AN, and 1 part by mass of GMA> in Production Example 2-6. The volume-average particle size of the polymer particles (B) contained in the aqueous latex (L-9) thus obtained was 0.21 μm. The contained amount of an epoxy group with respect to the total mass of a shell layer in the polymer particles (B) was 0 mmol/g.

### Production Example 2-10: Preparation of Aqueous Latex (L-10) Containing Polymer Particles

An aqueous latex (L-10) containing the component (B) (polymer particles) was obtained by the same method as in Production Example 2-6, except that, as the monomer for shell layer formation, <3 parts by mass of MMA and 10 parts by mass of GMA> were used instead of <4 parts by mass of MMA, 6 parts by mass of ST, 2 parts by mass of AN, and 1 part by mass of GMA> in Production Example 2-6. The volume-average particle size of the polymer particles (B) contained in the aqueous latex (L-10) thus obtained was 0.21 μm. The contained amount of an epoxy group with respect to the total mass of a shell layer in the polymer particles (B) was 5.4 mmol/g.

### Production Example 2-11: Preparation of Aqueous Latex (L-11) Containing Polymer Particles

An aqueous latex (L-11) containing the component (B) (polymer particles) was obtained by the same method as in Production Example 2-6, except that, as the monomer for shell layer formation, <12.5 parts by mass of MMA and 0.5 parts by mass of ST> were used instead of <4 parts by mass of MMA, 6 parts by mass of ST, 2 parts by mass of AN, and 1 part by mass of GMA> in Production Example 2-6. The volume-average particle size of the polymer particles (B) contained in the aqueous latex (L-11) thus obtained was 0.21 μm. The contained amount of an epoxy group with respect to the total mass of a shell layer in the polymer particles (B) was 0 mmol/g.

### 3. Preparation of Dispersion (M) in which Polymer Particles are Dispersed in Component (A)

### Production Example 3-1: Preparation of Dispersion (M-(1))

Into a 1 L mixing vessel at 25 °C was introduced 132 g of methyl ethyl ketone (MEK). Next, while stirring MEK, 132 g of the aqueous latex (L-1) containing the polymer particles obtained in Production Example 2-1 (including 40 g of polymer particles) was charged into a mixing vessel. After the materials in the mixing vessel had been mixed uniformly, 200 g of water was introduced into the mixing vessel at a feed rate of 80 g/min while the materials in the mixing vessel were stirred. After the water had been fed, the stirring was promptly stopped, and a slurry liquid was obtained, the slurry liquid being constituted by an aggregate that contains polymer particles and an aqueous phase that contains a small amount of organic solvent. The aggregate was buoyant. Next, 360 g of the aqueous phase was let out from an outlet in a lower part of the mixing vessel such that the aggregate containing a portion of the aqueous phase remained in the mixing vessel. To the aggregate thus obtained was added 90 g of MEK, and these were mixed uniformly so as to obtain a dispersion in which the polymer particles were dispersed uniformly in the MEK. To the resulting dispersion, 60 g of the component (A), namely the A-(1) (alicyclic epoxy resin), was added, and these were mixed uniformly. The MEK was removed from the resulting mixture with use of a rotary evaporator. In this way, dispersion (M-(1)) in which the component (B) (polymer particles) was dispersed in the component (A) was obtained.

### Production Example 3-2: Preparation of Dispersion (M-2)

A dispersion (M-(2)) in which the component (B) (polymer particles) was dispersed in the component (A) was obtained by the same method as in Production Example 3-1, except that (L-2) obtained in Production Example 2-2 was used instead of (L-1) as the aqueous latex containing polymer particles, and the A-(2) (bisphenol A epoxy resin in liquid form at room temperature) was used instead of A-(1) as the component (A) in Production Example 3-1.

### Production Examples 3-3 to 3-11: Preparation of Dispersions (M-(3) to M-(11))

Dispersions (M-(3) to M-(11)) in which the component (B) (polymer particles) was dispersed in the component (A) were obtained by the same method as in Production Example 3-2, except that (L-3 to L-11) obtained in Production Examples 2-3 to 2-11 were used respectively, instead of (L-2) as the aqueous latex containing polymer particles in Production Example 3-2.

### <Component (C)>

(Acid Anhydride (c1))
c1-(1): 4-methylcyclohexane-1,2-dicarboxylic anhydride (isomer mixture) (manufactured by Tokyo Chemical Industry Co., Ltd., acid anhydride group equivalent weight: 168 g/eq)
c1-(2): methyl tetrahydrophthalic anhydride (manufactured by DIC Corporation, “EPICLON B-570-H”, acid anhydride group equivalent weight: 166 g/eq)
   (Aromatic Amine (c2))
c2-(1): diethyl toluene diamine (manufactured by Mitsubishi Chemical Corporation, “jER Cure WA”, active hydrogen atom equivalent weight: 44.6 g/eq)
   (Alicyclic Amine (c3))
c3-(1): isophorone diamine (manufactured by BASF SE, active hydrogen atom equivalent weight: 42.6 g/eq)
c3-(2): 1,3-bis(amino methyl)cyclohexane (isomer mixture) (manufactured by Tokyo Chemical Industry Co., Ltd., active hydrogen atom equivalent weight: 35.6 g/eq)
c3-(3): 4,4′-methylenebis(cyclohexylamine) (isomer mixture) (manufactured by Tokyo Chemical Industry Co., Ltd., active hydrogen atom equivalent weight: 52.6 g/eq)
   (Amine (c4))
c4-(1): 3-diethylaminopropylamine (manufactured by Tokyo Chemical Industry Co., Ltd., an amine with 2 active hydrogen atoms in an amino group per molecule, molecular weight: 130.24)
c4-(2): 4-(2-hydroxyethyl)piperidine (manufactured by Tokyo Chemical Industry Co., Ltd., an amine with 1 active hydrogen atom in the amino group per molecule, molecular weight: 129.20)
c4-(3): n-octylamine (manufactured by Tokyo Chemical Industry Co., Ltd., an amine with 2 active hydrogen atoms in an amino group per molecule, molecular weight: 144.21)
c4-(4): 2-diethylaminoethylamine (manufactured by Tokyo Chemical Industry Co., Ltd., an amine with 2 active hydrogen atoms in an amino group per molecule, molecular weight: 116.21)
c4-(5): 4-methylpiperidine (manufactured by Tokyo Chemical Industry Co., Ltd., an amine with 1 active hydrogen atom in the amino group per molecule, molecular weight: 99.18)
c4-(6): 1-methylpiperazine (manufactured by Tokyo Chemical Industry Co., Ltd., an amine with 1 active hydrogen atom in the amino group per molecule, molecular weight:100.17)
c4-(7): 2-methylpiperazine (manufactured by Tokyo Chemical Industry Co., Ltd., an amine with 2 active hydrogen atoms in an amino group per molecule, molecular weight:100.17)
   (Amine (c5))
c5-(1): 4,4′-methylenebis(cyclohexylamine) (isomer mixture) (manufactured by Tokyo Chemical Industry Co., Ltd., an alicyclic amine with 4 active hydrogen atoms in an amino group per molecule, molecular weight: 210.36)
   (Amine-Based Epoxy Curing Agent Other than Amine (c4) and Amine (c5))
c-(1): triethylenetetramine (manufactured by Tokyo Chemical Industry Co., Ltd., an amine with 6 active hydrogen atoms in an amino group per molecule, molecular weight: 146.24).
c-(2): a condensation product of dimer acid or fatty acid with polyamine (“Vegechem Green V140” manufactured by Tsuno Food Industrial Co., Ltd., an amidoamine with 3 or more active hydrogen atoms in an amino group per molecule, active hydrogen atom equivalent weight: 97 g/eq)

### <Component (D)>

D-(1): 2-ethyl-4-methylimidazole (manufactured by Tokyo Chemical Industry Co., Ltd.)
D-(2): 2,4,6-tris(dimethylaminomethyl)phenol (manufactured by Tokyo Chemical Industry Co., Ltd.)
D-(3): N-benzildimethylamine (manufactured by Tokyo Chemical Industry Co., Ltd.)
D-(4): benzyltriethylammonium chloride (manufactured by Tokyo Chemical Industry Co., Ltd.).

### [Measurement and Evaluation Method]

The measurement and evaluation methods for each physical property measured in Examples are shown below.

### [Measurement of Volume-Average Particle Size]

The volume-average particle size (Mv) of polymer particles which are component (B) dispersed in aqueous latex was measured with use of the Microtrac UPA150 (manufactured by Nikkiso Co., Ltd.). The sample used for measurement was prepared by diluting the aqueous latex in deionized water. When making measurements, the refractive index of water and the refractive index of respective polymer particles were inputted, measurement time was set to 600 seconds, and the concentration of the sample was adjusted such that the signal level fell within a range of 0.6 to 0.8.

### [Measurement of Fracture Toughness (K1c, G1c)]

Each curable resin composition obtained in the examples and comparative examples was poured between two fluorine-coated aluminum plates (dimensions: 25 cm×25 cm×0.5 cm) separated by a 5 mm thick spacer, and the curing temperature was set to 120 °C for the compositions in Tables 9, 10, 13, 16, 17, and 18 described below, while the curing temperature was set to 175 °C for the other compositions, and all compositions were cured under the condition of a curing time of 2 hours to obtain a plate-like cured product having a thickness of 5 mm. The cured product was cut to a size of 2.5 inches in length, 0.5 inches in width, and 5 mm in thickness to create a test specimen. A V-notch was made in the test specimen, and a crack was introduced from the tip of the V-notch to the center of the specimen using a razor blade. The test specimen obtained in this way were subjected to a three-point bending test under conditions of a span distance of 50 mm, a test speed of 1 mm/min, and a temperature of 23 °C. From the bending test results, the fracture toughness values (K1c and G1c) were evaluated in accordance with ASTM D-5045.

### [Calculation of Values X and Y]

The following compositions (M) corresponding to the curable resin compositions of each example and each comparative example were prepared: Compositions (M) that contain the component (A), the component (C), and the component (D), which are the same as (identical to) the component (A), the component (C), and the component (D) contained in the curable resin compositions of each example and each comparative example, and respective contained amounts of the component (A), the component (C), and the component (D) in the composition (M) are the same as respective contained amounts of the component (A), the component (C), and the component (D) in the curable resin compositions of each example and each comparative example.

The composition of composition (M) of each curable resin composition is shown in Tables 1 to 18.

In addition, the following compositions (Meq) corresponding to the curable resin compositions in Tables 1 to 4 and 8 described below were prepared: Compositions (Meq) that contain the component (A), the component (C), and the component (D), which are the same as (identical to) the component (A), the component (C), and the component (D) contained in the curable resin compositions in Tables 1 to 4 and 8 described below; respective contained amounts of the component (A) and the component (D) in the composition (Meq) are the same as respective contained amounts of the component (A) and the component (D) in the curable resin compositions in Tables 1 to 4 and 8 described below; and a contained amount of the component (C) in the composition (Meq) is such that a ratio of a molar mass of an acid anhydride group in the component (C) to a molar mass of an epoxy group in the component (A) contained in the composition (Meq) (molar mass of acid anhydride group in component (C)/molar mass of epoxy group in component (A)) is 1.

In addition, the following compositions (Meq) corresponding to the curable resin compositions in Tables 5 to 7 and 9 to 10 described below were prepared: Compositions (Meq) that contain the component (A), the component (C), and the component (D), which are the same as (identical to) the component (A), the component (C), and the component (D) contained in the curable resin compositions in Tables 5 to 7 and 9 to 10 described below, respective contained amounts of the component (A) and the component (D) in the composition (Meq) are the same as respective contained amounts of the component (A) and the component (D) in the curable resin compositions in Tables 5 to 7 and 9 to 10 described below, and a contained amount of the component (C) in the composition (Meq) is such that a ratio of a molar mass of active hydrogen atom of an amine in the component (C) to a molar mass of an epoxy group in the component (A) contained in the composition (Meq) (molar mass of active hydrogen atom of amine in component (C)/molar mass of epoxy group in component (A)) is 1.

The composition of composition (Meq) of each curable resin composition is shown in Tables 1 to 10.

Next, each composition (M) and each composition (Meq) were cured under the same conditions as described in the [Measurement of Fracture Toughness (K1c, G1c)], and the respective cured products were obtained.

Subsequently, each cured product was cut to a size of 40 mm in length, 5 mm in thickness, and 3 mm in width to form a test specimen. For the obtained test specimen, dynamic viscoelastic measurements were performed using the dynamic viscoelastic measurement device itk DVA-200 (IT Keisoku Seigyo Co., Ltd.), heating at a rate of 8 °C/min under tensile mode and at a frequency of 1 Hz, and the temperature (°C) at which the loss tangent (tan δ) was maximized (Ttg(M) and Ttg(Meq)) was measured.

Next, for each cured product obtained by curing each composition (M), the minimum value of the storage modulus (E′) (E′(M)) and the temperature (°C) (Tmin(M)) at which the storage modulus (E′) is minimized were identified in the temperature range of [Ttg(M) (°C)] to [Ttg(M)+25 (°C)]. In addition, for the cured product obtained by curing each composition (Meq), the minimum value of the storage modulus (E′) (E′(Meq)) and the temperature (°C) (Tmin(Meq)) at which the storage modulus (E′) is minimized were identified in the temperature range of [Ttg(Meq) (°C)] to [Ttg(Meq)+25 (°C)].

Using the obtained E′(M), Tmin(M), E′(Meq), and Tmin(Meq), the value X of the curable resin compositions in Tables 1 to 10 was calculated based on the following formula:

X={[273+Tmin(M)]/[273+Tmin(Meq)]}×[E′(Meq)]/[E′(M)]. formula:

The results are shown in Tables 1 to 10.

In addition, using the obtained E′(M) and Tmin(M), the value Y of the curable resin compositions in Tables 4, 7, and 11 to 18 was calculated based on the following formula:

Y=[273+Tmin(M)]/[E′(M)]. formula:

The results are shown in Tables 4, 7, and 11 to 18.

### [Measurement of Cure Degree of Cured Product]

The cure degree of the cured product was measured (calculated) by the following method. First, for 20 mg of the uncured curable resin composition, a temperature rise measurement was conducted from 30 °C to 300 °C at a heating rate of 10 °C/min using DSC, and a heat generation curve was obtained. The total heat generation of the uncured curable resin composition was calculated from the area of the obtained heat generation curve, and the obtained value was designated as QT. Next, for the cured product obtained by curing 20 mg of the curable resin composition, a temperature rise measurement was conducted from 30 °C to 300 °C at a heating rate of 10 °C/min using DSC, and a heat generation curve was obtained. The residual heat generation of the cured product was calculated from the area of the obtained residual heat generation curve, and the obtained value was designated as QR. In the cured product, when no residual heat generation peak is present, QR is set to 0. Subsequently, the cure degree (%) of the cured product was calculated from the following formula:

Cure degree of cured product(%)=(QT−QR)/QT×100.

### Examples and Comparative Examples

Curable resin compositions were obtained by weighing each component according to the formulations shown in Tables 1 to 18 and thoroughly mixing them. The fracture toughness (K1c and G1c) of the obtained curable resin compositions was measured and evaluated in accordance with the above method. Furthermore, the values X and Y of each curable resin composition were calculated in accordance with the above method. The results are shown in Tables 1 to 18.

In all examples and comparative examples, DSC measurements were performed on the cured products (M) and cured products (Meq) used for measuring values X and Y, as well as on the cured products used for measuring fracture toughness (K1c and G1c), and the cure degree was measured by the above method, resulting in a cure degree of 98% or more.

In the curable resin composition shown in Table 8, a mixture obtained by pre-mixing the component (C) and the component (D) was used. The mixture showed little increase in viscosity even after being stored at 50 °C for 7 days, indicating good storage stability.

| [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|
| [symbol] urable | Component(B) | [symbol] dispersed in | 0.8 [symbol] | 0.0 [symbol] | (B-1) | M-(1) | 100 | 100 | 100 | 100 | 100 |
| resin | | component(A) | | | | | | | | | |
| [symbol] mposition | Component(C) | Acid anhydride | | | (c1) | c1-(1) | 60 | 54 | 48 | 78 | 72 |
| | Component(D) | Curing accelerator | | | | D-(1) | 4 | 4 | 4 | 4 | 4 |
| | Type of component(B) | | | | | | B-1 | B-1 | B-1 | B-1 | B-1 |
| | Type of component(C) | | | | | | c1 | c1 | c1 | c1 | c1 |
| | Molar mass of acid anhydride group in component(C)/ | | | | | | 0.77 | 0.70 | 0.62 | 1.00 | 0.93 |
| | Molar mass of epoxy group in component(A) | | | | | | | | | | |
| | Amount of component(B) with respect to 100 parts of component(A) (parts by mass) | | | | | | 67 parts | 67 parts | 67 parts | 67 parts | 67 parts |
| | Amount of component(C) with respect to 100 parts of component(A) (parts by mass) | | | | | | 100 parts | 80 parts | 80 parts | 130 parts | 120 parts |
| | Amount of component(D) with respect to 100 parts of component(A) (parts by mass) | | | | | | 7 parts | 7 parts | 7 parts | 7 parts | 7 parts |
| [symbol] ured | K1c | | MPa m [symbol] | | | | 1.37 | 1.42 | 1.47 | 1.25 | 1.25 |
| [symbol] oduct | [symbol] | | kJ/m [symbol] | | | | 1.15 | 1.27 | 1.30 | 0.80 | 0.85 |
| [symbol] mposition | Component(A) | Alicycli [symbol] epoxy resin | difunctional [symbol] | 1.30 [symbol] | (A) [symbol] | A-(1) | [symbol] | [symbol] | [symbol] | [symbol] | [symbol] |
| [symbol] ) | Component(C) | Acid anhydride | | | (c1) | c1-(1) | [symbol] | [symbol] | 48 | 78 | 72 |
| | Component(D) | Curing accelerator | | | | D-(1) | 4 | 4 | 4 | 4 | 4 |
| | Molar mass of acid anhydride group in component(C)/ | | | | | | 0.77 | 0.70 | 0.62 | 1.00 | 0.93 |
| | Molar mass of epoxy group in component(A) | | | | | | | | | | |
| | T [symbol] (M) | | °C | | | | 200 | 187 | 167 | 228 | 228 |
| | E′ (M) | | MPa | | | | 15.47 | 13.18 | 10.72 | 18.81 | 18.48 |
| | Tmin (M) | | °C | | | | 225 | 212 | 192 | 283 | 250 |
| [symbol] mposition | Component(A) | Alicycli [symbol] epoxy resin | difunctional [symbol] | 1.30 [symbol] | (A) [symbol] | A-(1) | [symbol] | [symbol] | [symbol] | [symbol] | [symbol] |

| | | | | | | | | | |
|---|---|---|---|---|---|---|---|---|---|
| [symbol] eq) | Component(C) | Acid anhydride | (c1) | c1-(1) | 78 | 78 | 78 | 78 | 78 |

| | | | | | | | |
|---|---|---|---|---|---|---|---|
| Component(D) | Curing accelerator | D-(1) | 4 | 4 | 4 | 4 | 4 |

| Molar mass of acid anhydride group in component(C)/ | | 1.00 | 1.00 | 1.00 | 1.00 | 1.00 |
|---|---|---|---|---|---|---|
| Molar mass of epoxy group in component(A) | | | | | | |
| T [symbol] g (Meq) | °C | 228 | 228 | 228 | 228 | 228 |
| E′ (Meq) | MPa | 18.81 | 18.81 | 18.81 | 18.81 | 18.81 |
| Tmin (Meq) | °C | 253 | 253 | 253 | 253 | 253 |

| | | | | | |
|---|---|---|---|---|---|
| ([273 + Tmin (M)]/[273 + Tmin (Meq)]) × [E′ (Meq)]/[E′ (M)] | 1.15 | 1.32 | 1.85 | 1.00 | 1.01 |

[symbol]

+) Number of epoxy functional groups of component(A) [symbol]
++) Epoxy equivalent weight of component(A) (g/eq) [symbol]
+++) Component(A) which is neither component(a1) nor component(a2)
(*) Contained amount of epoxy group with respect to total mass of shell layer of polymer particles which are component(B) (mmol/g)
(**) % by mass of chain transfer agent in monomer mixture of core layered polymer particles which are component(B)(%)

| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|---|---|---|
| Curable resin | Component(A) | Alicycli [symbol] epoxy resin | difunctional [symbol] | 1.30 [symbol] | (A) [symbol] | A-(1) | 70 | 70 | 70 | 70 | 70 | 70 | | | 70 | 70 |
| composition | | BisphenolA epoxy resin | difunctional [symbol] | 1.89 [symbol] | (A) [symbol] | A-(2) | | | | | | | 70 | | | |
| | | BisphenolF epoxy resin | difunctional [symbol] | 1.70 [symbol] | (A) [symbol] | A-(3) | | | | | | | | 83 | | |
| | Component(A) + | [symbol] (M) in | 0.5 [symbol] | 0.0 [symbol] | (B-1) | M-(2) | 60 | 60 | 60 | 60 | 60 | 60 | 60 | 60 | | |
| | Component(B) | which component(B) | 0.0 [symbol] | 0.4 [symbol] | (B-2) | M-(4) | | | | | | | | | 60 | |
| | | is dispersed in | | | | | | | | | | | | | | |
| | | component(A) | 0.6 [symbol] | 0.4 [symbol] | (B-3) | M-(5) | | | | | | | | | | 60 |
| | Component(C) | Acid anhydride | | | (c1) | c1-(2) | 98 | 89 | 80 | 71 | 53 | 44 | 75 | 75 | 98 | 98 |
| | Component(D) | Curing accelerator | | | | D-(2) | 4 | 4 | 4 | 4 | 4 | 4 | 4 | 4 | 4 | 4 |
| | Type of component(A) | | | | | | A [symbol] | A [symbol] | A [symbol] | A [symbol] | A [symbol] | A [symbol] | A [symbol] | A [symbol] | A [symbol] | A [symbol] |
| | Type of component(B) | | | | | | B-1 | B-1 | B-1 | B-1 | B-1 | B-1 | B-1 | B-1 | B-2 | B-3 |
| | Type of component(C) | | | | | | c1 | c1 | c1 | c1 | c1 | c1 | c1 | c1 | c1 | c1 |
| | Molar mass of acid anhydride group in component(C)/ | | | | | | 0.85 | 0.77 | 0.69 | 0.61 | 0.46 | [symbol] | 0.85 | 0.85 | 0.85 | 0.85 |
| | Molar mass of epoxy group in component(A) | | | | | | | | | | | | | | | |
| | Amount of component(B) with respect to 100 parts of component(A) (parts by mass) | | | | | | 20 parts | 20 parts | 20 parts | 20 parts | 20 parts | 20 parts | 20 parts | 20 parts | 20 parts | 20 parts |
| | Amount of component(C) with respect to 100 parts of component(A) (parts by mass) | | | | | | 98 parts | 89 parts | 80 parts | 71 parts | 53 parts | 44 parts | 75 parts | 81 parts | 98 parts | 98 parts |
| | Amount of component(D) with respect to 100 parts of component(A) (parts by mass) | | | | | | 4 parts | 4 parts | 4 parts | 4 parts | 4 parts | 4 parts | 4 parts | 4 parts | 4 parts | 4 parts |
| Cured | K1c | | MP [symbol] | | | | 1.46 | 1.81 | 1.81 | 1.98 | 1.82 | 1.86 | 1.83 | 2.05 | 1.48 | 1.47 |
| product | G1c | | kJ/m [symbol] | | | | 0.81 | 1.00 | 1.27 | 1.61 | 1.81 | 1.41 | 1.87 | 2.21 | 0.83 | 0.85 |
| Composition | Component(A) | Alicycli [symbol] epoxy resin | difunctional [symbol] | 1.30 [symbol] | (A) [symbol] | A-(1) | 70 | 70 | 70 | 70 | 70 | 70 | | | 70 | 70 |
| (M) | | BisphenolA epoxy resin | difunctional [symbol] | 1.89 [symbol] | (A) [symbol] | A-(2) | 30 | 30 | 30 | 30 | 30 | 30 | 100 | 30 | 30 | 30 |
| | | BisphenolF epoxy resin | difunctional [symbol] | 1.70 [symbol] | (A) [symbol] | A-(3) | | | | | | | | 83 | | |
| | Component(C) | Acid anhydride | | | (c1) | c1-(2) | 98 | 89 | 80 | 71 | 83 | 46 | 75 | 78 | 98 | 98 |
| | Component(D) | Curing accelerator | | | | D-(2) | 4 | 4 | 4 | 4 | 4 | 4 | 4 | 4 | 4 | 4 |
| | Molar mass of acid anhydride group in component(C)/ | | | | | | 0.88 | 0.77 | 0.69 | 0.81 | 0.48 | 0.38 | 0.85 | 0.85 | 0.85 | 0.85 |
| | Molar mass of epoxy group in component(A) | | | | | | | | | | | | | | | |
| | T [symbol] (M) | | °C | | | | 173 | 151 | 139 | 117 | 89 | 78 | 138 | 129 | 173 | 173 |
| | E′ (M) | | MPa | | | | 21.27 | 15.82 | 14.37 | 10.60 | 0.30 | 4.81 | 24.58 | 26.30 | 21.27 | 21.27 |
| | Tmin (M) | | °C | | | | 190 | 178 | 103 | 142 | 117 | 101 | 148 | 148 | 196 | 196 |
| Composition | Component(A) | Alicycli [symbol] epoxy resin | difunctional [symbol] | 1.30 [symbol] | (A) [symbol] | A-(1) | 70 | 70 | 70 | 70 | 70 | 70 | | | 70 | 70 |
| (Meq) | | BisphenolA epoxy resin | difunctional [symbol] | 1.89 [symbol] | (A) [symbol] | A-(2) | 30 | 30 | 30 | 30 | 30 | 30 | 100 | 30 | 30 | 30 |
| | | BisphenolF epoxy resin | difunctional [symbol] | 1.70 [symbol] | (A) [symbol] | A-(3) | | | | | | | | 83 | | |

| | | | | | | | | | | | | | |
|---|---|---|---|---|---|---|---|---|---|---|---|---|---|
| Component(C) | Acid anhydride | (c1) | c1-(2) | 110 | 110 | 110 | 110 | 110 | 110 | 88 | 88 | 110 | 110 |

| | | | | | | | | | | | | |
|---|---|---|---|---|---|---|---|---|---|---|---|---|
| Component(D) | Curing accelerator | D-(2) | 4 | 4 | 4 | 4 | 4 | 4 | 4 | 4 | 4 | 4 |

| Molar mass of acid anhydride group in component(C)/ | | 1.00 | 1.00 | 1.00 | 1.00 | 1.00 | 1.00 | 1.00 | 1.00 | 1.00 | 1.00 |
|---|---|---|---|---|---|---|---|---|---|---|---|
| Molar mass of epoxy group in component(A) | | | | | | | | | | | |
| T [symbol] g (Meq) | °C | 186 | 186 | 186 | 186 | 186 | 186 | 140 | 133 | 185 | 188 |
| E′ (Meq) | MPa | 23.54 | 23.54 | 23.54 | 23.54 | 23.54 | 23.54 | 23.54 | 23.54 | 23.54 | 23.54 |
| Tmin (Meq) | °C | 205 | 205 | 205 | 205 | 205 | 205 | 158 | 153 | 205 | 205 |

| | | | | | | | | | | |
|---|---|---|---|---|---|---|---|---|---|---|
| ([273 + Tmin (M)]/[273 + Tmin (Meq)]) × [E′ (Meq)]/[E′ (M)] | 1.00 | 1.40 | 1.49 | 1.03 | 3.01 | 3.99 | 1.07 | 1.07 | 1.09 | 1.09 |

(+) Number of epoxy functional groups of component(A)
(++) Epoxy equivalent weight of component(A) (g/eq)
(+++) Component(A) which is neither component(a1) nor component(a2)
(*) Contained amount of epoxy group with respect to total mass of shell layer of polymer particles which are component(B) (mmol/g)
(**) % by mass of chain transfer agent in monomer mixture of core layered polymer particles which are component(B)(%)

| [symbol] | [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|
| [symbol] osition | Component(A) | BisphenolA epoxy resin | difunctional [symbol] | 1.89 [symbol] | (A) [symbol] | A-(2) | 30 | 30 | 30 | 30 | | | |
| | | BisphenolF epoxy resin | difunctional [symbol] | 1.70 [symbol] | (A) [symbol] | A-(3) | | | | | | | |
| | Component(A) + | Dispersion(M) | 0.5 [symbol] | 0.0 [symbol] | (B-1) | M-(2) | | | | | 50 | 50 | 50 |
| | Component(B) | in which | 0.0 [symbol] | 0.4 [symbol] | (B-2) | M-(4) | | | | | | | |
| | | component(B) is | 0.6 [symbol] | 0.4 [symbol] | (B-3) | M-(5) | | | | | | | |
| | | dispersed in | | | | | | | | | | | |
| | | component(A) | | | | | | | | | | | |
| | Component(C) | Acid anhydride | | | (c1) | c1-(2) | 116 | 98 | 80 | 71 | 116 | 107 | 35 |
| | Component(D) | Curing accelerator | | | | D-(2) | 4 | 4 | 4 | 4 | 4 | 4 | 4 |
| | Type of component(A) | | | | | | A [symbol] | A [symbol] | A [symbol] | A [symbol] | A [symbol] | A [symbol] | A [symbol] |
| | Type of component(B) | | | | | | — | — | — | — | B-1 | B-1 | B-1 |
| | Type of component(C) | | | | | | c1 | c1 | c1 | c1 | c1 | c1 | c1 |
| | Molar mass of acid anhydride group in component(C)/ | | | | | | 1.00 | 0.88 | 0.77 | 0.61 | 1.00 | 0.92 | 0.30 |
| | Molar mass of epoxy group in component(A) | | | | | | | | | | | | |
| | Amount of component(B) with respect to 100 parts of component(A) (parts by mass) | | | | | | 0 parts | 0 parts | 0 parts | 0 parts | 20 parts | 20 parts | 20 parts |
| | Amount of component(C) with respect to 100 parts of component(A) (parts by mass) | | | | | | 116 parts | 98 parts | 80 parts | 71 parts | 116 parts | 107 parts | 35 parts |
| | Amount of component(D) with respect to 100 parts of component(A) (parts by mass) | | | | | | 4 parts | 4 parts | 4 parts | 4 parts | 4 parts | 4 parts | 4 parts |
| [symbol] d | K1c | | MPa [symbol] | | | | 3.49 | 0.82 | 0.82 | 0.67 | 1.21 | 0.83 | 0.71 |
| [symbol] ct | G1c | | kJ/m [symbol] | | | | 0.07 | 0.11 | 0.10 | 0.11 | 0.51 | 0.84 | 0.76 |
| [symbol] osition | Component(A) | Alicycli [symbol] epoxy resin | difunctional [symbol] | 1.30 [symbol] | (A) [symbol] | A-(1) | 70 | 70 | 70 | 70 | 70 | 70 | 70 |
| [symbol] | | BisphenolA epoxy resin | difunctional [symbol] | 1.89 [symbol] | (A) [symbol] | A-(2) | 30 | 30 | 30 | 30 | 30 | 30 | 30 |
| | | BisphenolF epoxy resin | difunctional [symbol] | 1.70 [symbol] | (A) [symbol] | A-(3) | | | | | | | |
| | Component(C) | Acid anhydride | | | (c1) | c1-(2) | 116 | 98 | 69 | 71 | 116 | 107 | 35 |
| | Component(D) | Curing accelerator | | | | D-(2) | 4 | 4 | 4 | 4 | 4 | 4 | 4 |
| | Molar mass of acid anhydride group in component(C)/ | | | | | | 1.00 | 0.85 | 0.77 | 0.81 | 1.00 | 0.92 | 0.30 |
| | Molar mass of epoxy group in component(A) | | | | | | | | | | | | |
| | T [symbol] (M) | | °C | | | | 186 | 173 | 151 | 117 | 188 | 180 | 60 |
| | E′ (M) | | MPa | | | | 23.54 | 21.27 | 15.82 | 10.60 | 23.54 | 22.53 | 2.95 |
| | Tmin (M) | | °C | | | | 205 | 195 | 170 | 142 | 205 | 200 | 85 |
| [symbol] osition | Component(A) | Alicycli [symbol] epoxy resin | difunctional [symbol] | 1.30 [symbol] | (A) [symbol] | A-(1) | 70 | 70 | 70 | 70 | 70 | 70 | 70 |
| [symbol] | | BisphenolA epoxy resin | difunctional [symbol] | 1.89 [symbol] | (A) [symbol] | A-(2) | 30 | 30 | 30 | 30 | 30 | 30 | 30 |
| | | BisphenolF epoxy resin | difunctional [symbol] | 1.70 [symbol] | (A) [symbol] | A-(3) | | | | | | | |

| | | | | | | | | | | |
|---|---|---|---|---|---|---|---|---|---|---|
| Component(C) | Acid anhydride | (c1) | c1-(2) | 110 | 110 | 110 | 110 | 110 | 110 | 110 |

| | | | | | | | | | |
|---|---|---|---|---|---|---|---|---|---|
| Component(D) | Curing accelerator | D-(2) | 4 | 4 | 4 | 4 | 4 | 4 | 4 |

| Molar mass of acid anhydride group in component(C)/ | | 1.00 | 1.00 | 1.00 | 1.00 | 1.00 | 1.00 | 1.00 |
|---|---|---|---|---|---|---|---|---|
| Molar mass of epoxy group in component(A) | | | | | | | | |
| T [symbol] g (Meq) | °C | 186 | 186 | 186 | 186 | 186 | 186 | 186 |
| E′ (Meq) | MPa | 23.54 | 23.54 | 23.54 | 23.54 | 23.54 | 23.54 | 23.54 |
| Tmin (Meq) | °C | 205 | 205 | 205 | 205 | 205 | 205 | 205 |

| | | | | | | | |
|---|---|---|---|---|---|---|---|
| ([273 + Tmin (M)]/[273 + Tmin (Meq)]) × [E′ (Meq)]/[E′ (M)] | 1.00 | 1.09 | 1.40 | 1.93 | 1.00 | 1.03 | 5.98 |

[symbol]

Number of epoxy functional groups of component(A) [symbol]
Epoxy equivalent weight of component(A) (g/eq) [symbol]
) Component(A) which is neither component(a1) nor component(a2)
(*) Contained amount of epoxy group with respect to total mass of shell layer of polymer particles which are component(B) (mmol/g)
(**) % by mass of chain transfer agent in monomer mixture of core layered polymer particles which are component(B)(%)

| [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|
| Curable resin | Component(A) | Alicyclic epoxy resin | difunctional [symbol] | 130 [symbol] | (A) [symbol] | A-(1) | 30 | 30 | 30 | 30 | 30 |
| composition | | BisphenolA epoxy resin | difunctional [symbol] | 189 [symbol] | (A) [symbol] | A-(2) | 10 | | 4 | | |
| | | Other polyfunctional epoxy | difunctional [symbol] | 115 [symbol] | (A) [symbol] | A-(4) | | 5.2 | | | |
| | | group-containing substances | | | | | | | | | |
| | | Polyfunctional epoxy group- | difunctional [symbol] | 315 [symbol] | (a1) | A-(5) | | | 10 | | |
| | | containing substance(a1) | | | | | | | | | |
| | | Monofunctional epoxy group- | monofunctional [symbol] | 182 [symbol] | (a2) | A-(7) | | | | 9.7 | 9.7 |
| | | containing substances(a2) | | | | | | | | | |
| | Component(A) + | Dispersion(M) in which | 0.0 [symbol] | 0.0 [symbol] | (B) [symbol] | M-(3) | 50 | 50 | 50 | 50 | 50 |
| | Component(B) | component(B) is | | | | | | | | | |
| | | dispersed in component(A) | | | | | | | | | |
| | Component(C) | Acid anhydride | | | (c1) | c1-(2) | 95 | 95 | 95 | 95 | 103 |
| | Component(D) | Curing accelerator | | | | D-(2) | 4 | 4 | 4 | 4 | 4 |
| | Type of component(A) | | | | | | A [symbol] | A [symbol] | A [symbol] a1 | A [symbol] a2 | A [symbol] a2 |
| | Type of component(B) | | | | | | B⁽**⁾ | B⁽**⁾ | B⁽**⁾ | B⁽**⁾ | B⁽**⁾ |
| | Type of component(C) | | | | | | c1 | c1 | c1 | c1 | c1 |
| | Molar mass of acid anhydride group in component(C)/ | | | | | | 0.85 | 0.85 | 0.85 | 0.85 | 0.92 |
| | Molar mass of epoxy group in component(A) | | | | | | | | | | |
| | Amount of component(B) with respect to 100 parts of component(A) (parts by mass) | | | | | | 20 parts | 21 parts | 19 parts | 20 parts | 20 parts |
| | Amount of component(C) with respect to 100 parts of component(A) (parts by mass) | | | | | | 95 parts | 99 parts | 91 parts | 95 parts | 103 parts |
| | Amount of component(D) with respect to 100 parts of component(A) (parts by mass) | | | | | | 4 parts | 4 parts | 4 parts | 4 parts | 4 parts |
| Cured | K1c | | MPa m [symbol] | | | | 1.39 | 1.41 | 1.51 | 1.49 | 1.37 |
| product | G1c | | kJ/m [symbol] | | | | 0.73 | 0.78 | 0.85 | 0.88 | 0.73 |
| Composition | Component(A) | Alicyclic epoxy resin | difunctional [symbol] | 130 [symbol] | (A) [symbol] | A-(1) | 60 | 60 | 60 | 60 | 60 |
| (M) | | BisphenolA epoxy resin | difunctional [symbol] | 189 [symbol] | (A) [symbol] | A-(2) | 40 | 30 | 34 | 30 | 30 |
| | | Other polyfunctional epoxy | difunctional [symbol] | 115 [symbol] | (A) [symbol] | A-(3) | | 6.2 | | | |
| | | group-containing substances | | | | | | | | | |
| | | Polyfunctional epoxy group- | difunctional [symbol] | 315 [symbol] | (a1) | A-(4) | | | 10 | | |
| | | containing substance(a1) | | | | | | | | | |
| | | Monofunctional epoxy group- | monofunctional [symbol] | 182 [symbol] | (a2) | A-(5) | | | | 0.7 | 0.7 |
| | | containing substances(a2) | | | | | | | | | |
| | Component(C) | Acid anhydride | | | (c1) | c1-(2) | 95 | 95 | 95 | 95 | 103 |
| | Component(D) | Curing accelerator | | | | D-(2) | 4 | 4 | 4 | 4 | 4 |
| | Molar mass of acid anhydride group in component(C)/ | | | | | | 0.85 | 0.85 | 0.85 | 0.85 | 0.92 |
| | Molar mass of epoxy group in component(A) | | | | | | | | | | |
| | T [symbol] (M) | | °C | | | | 169 | 169 | 163 | 155 | 163 |
| | E′ (M) | | MPa | | | | 23.20 | 24.80 | 20.30 | 18.00 | 21.40 |
| | Tmin (M) | | °C | | | | 192 | 191 | 188 | 180 | 188 |
| Composition | Component(A) | Alicyclic epoxy resin | difunctional [symbol] | 130 [symbol] | (A) [symbol] | A-(1) | 60 | 60 | 60 | 60 | 60 |
| (Meq) | | BisphenolA epoxy resin | difunctional [symbol] | 189 [symbol] | (A) [symbol] | A-(2) | 40 | 30 | 34 | 30 | 30 |
| | | Other polyfunctional epoxy | difunctional [symbol] | 115 [symbol] | (A) [symbol] | A-(3) | | 6.2 | | | |
| | | group-containing substances | | | | | | | | | |
| | | Polyfunctional epoxy group- | difunctional [symbol] | 315 [symbol] | (a1) | A-(4) | | | 10 | | |
| | | containing substance(a1) | | | | | | | | | |
| | | Monofunctional epoxy group- | monofunctional [symbol] | 182 [symbol] | (a2) | A-(5) | | | | 0.7 | 0.7 |
| | | containing substances(a2) | | | | | | | | | |

| | | | | | | | | |
|---|---|---|---|---|---|---|---|---|
| Component(C) | Acid anhydride | (c1) | c1-(2) | 112 | 112 | 112 | 112 | 112 |

| | | | | | | | |
|---|---|---|---|---|---|---|---|
| Component(D) | Curing accelerator | D-(2) | 4 | 4 | 4 | 4 | 4 |

| Molar mass of acid anhydride group in component(C)/ | | 1.00 | 1.00 | 1.00 | 1.00 | 1.00 |
|---|---|---|---|---|---|---|
| Molar mass of epoxy group in component(A) | | | | | | |
| T [symbol] g (Meq) | °C | 182 | 182 | 174 | 166 | 166 |
| E′ (Meq) | MPa | 20.71 | 28.80 | 25.01 | 22.20 | 22.20 |
| Tmin (Meq) | °C | 201 | 199 | 196 | 188 | 186 |

| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|---|---|---|---|
| [symbol] | [symbol] | BisphenolA | [symbol] | [symbol] | (A) [symbol] | [symbol] -(2) | 70 | 70 | 70 | 70 | 70 | 70 | 70 | 70 | 70 | 70 | 70 |
| | | epoxy resin | | | | | | | | | | | | | | | |
| [symbol] urable | Component(A) + | Dispersion(M) in | 0.5 [symbol] | 0.0 [symbol] | (B [symbol] ) | M-(2) | 50 | 50 | 50 | 50 | | | | | | | |
| [symbol] esin | Component(B) | which | 0.5 [symbol] | 0.0 [symbol] | (B [symbol] ) | M-(6) | | | | | 50 | | | | | | |
| [symbol] omposition | | component(B) | 1.1 [symbol] | 0.0 [symbol] | (B [symbol] ) | M-(7) | | | | | | 50 | | | | | |
| | | is dispersed in | 0.2 [symbol] | 0.0 [symbol] | (B [symbol] ) | M-(8) | | | | | | | 50 | | | | |
| | | component(A) | 0.0 [symbol] | 0.0 [symbol] | (B) [symbol] | M-(9) | | | | | | | | 50 | | | |
| | | | 5.4 [symbol] | 0.0 [symbol] | (B) [symbol] | M-(10) | | | | | | | | | 50 | | |
| | | | 0.0 [symbol] | 0.4 [symbol] | (B-2) | M-(4) | | | | | | | | | | 50 | |
| | | | 0.6 [symbol] | 0.4 [symbol] | (B-3) | M-(5) | | | | | | | | | | | 50 |
| | Component(C) | Aromatic amide | | | (c2) | c2-(1) | 18.9 | [symbol] | [symbol] | 47.2 | 18.9 | 18.9 | 18.9 | 18.9 | 18.9 | 18.9 | 18.9 |
| | Type of component(A) | | | | | | A [symbol] | A [symbol] | A [symbol] | A [symbol] | A [symbol] | A [symbol] | A [symbol] | A [symbol] | A [symbol] | A [symbol] | A [symbol] |
| | Type of component(B) | | | | | | B-1 | B-1 | B-1 | B-1 | B-1 | B-1 | B-1 | B [symbol] | B [symbol] | B-2 | B-3 |
| | Type of component(C) | | | | | | c2 | c2 | c2 | c2 | c2 | c2 | c2 | c2 | c2 | c2 | c2 |
| | Molar mass of active hydrogen atom of amine in component(C)/ | | | | | | 0.80 | 0.70 | 1.50 | 2.00 | 0.80 | 0.80 | 0.80 | 0.80 | 0.80 | 0.80 | 0.80 |
| | Molar mass of epoxy group in component(A) | | | | | | | | | | | | | | | | |
| | Amount of component(B) with respect to 100 parts of component(A) (parts by mass) | | | | | | 20 parts | 20 parts | 20 parts | 20 parts | 20 parts | 20 parts | 20 parts | 20 parts | 20 parts | 20 parts | 20 parts |
| | Amount of component(C) with respect to 100 parts of component(A) (parts by mass) | | | | | | 19 parts | 17 parts | 35 parts | 47 parts | 19 parts | 19 parts | 19 parts | 19 parts | 19 parts | 19 parts | 19 parts |
| [symbol] ured | K1c | | MPa m [symbol] | | | | [symbol] | 1.99 | 1.93 | 2.23 | 1.65 | 1.60 | 1.60 | 1.52 | 1.56 | 1.63 | 1.63 |
| [symbol] roduct | G1c | | kJ/m [symbol] | | | | 1.18 | 1.71 | 2.38 | 5.24 | 1.18 | 1.11 | 1.07 | 1.03 | 1.03 | 1.32 | 1.25 |
| [symbol] omposition | Component(A) | BisphenolA epoxy resin | difunctional [symbol] | 180 [symbol] | (A) [symbol] | A-(2) | 100 | 100 | 100 | 100 | 100 | 100 | 100 | 100 | 100 | 100 | 100 |
| [symbol] M) | Component(C) | Aromatic amide | | | (c2) | c2-(1) | 18.9 | 16.5 | 35.4 | 47.2 | 18.9 | 18.9 | 18.9 | 18.9 | 18.9 | 18.9 | 18.9 |
| | Molar mass of active hydrogen atom of amine in component(C)/ | | | | | | 0.80 | 0.70 | 1.50 | 2.00 | 0.80 | 0.80 | 0.80 | 0.80 | 0.80 | 0.80 | 0.80 |
| | Molar mass of epoxy group in component(A) | | | | | | | | | | | | | | | | |
| | T [symbol] g (M) | | °C | | | | 125 | 105 | 142 | 109 | 128 | 128 | 128 | 128 | 128 | 128 | 128 |
| | E′ (M) | | MPa | | | | 11.0 | 5.2 | 14.1 | 2.0 | 11.0 | 11.0 | 11.0 | 11.0 | 11.0 | 11.0 | 11.0 |
| | Tmin (M) | | °C | | | | 152 | 130 | 158 | 183 | 152 | 152 | 152 | 152 | 152 | 152 | 152 |
| [symbol] omposition | Component(A) | BisphenolA epoxy resin | difunctional [symbol] | 1.30 [symbol] | (A) [symbol] | A-(2) | 100 | 100 | 100 | 100 | 100 | 100 | 100 | 100 | 100 | 100 | 100 |

| | | | | | | | | | | | | | | | |
|---|---|---|---|---|---|---|---|---|---|---|---|---|---|---|---|
| [symbol] Meq) | Component(C) | Aromatic amide | (c2 [symbol] | c2-(3) | 23.6 | 23.6 | 23.6 | 23.6 | 23.6 | 23.6 | 23.6 | 23.6 | 23.6 | 23.6 | 23.6 |

| Molar mass of active hydrogen atom of amine in component(C)/ | | 1.00 | 1.00 | 1.00 | 1.00 | 1.00 | 1.00 | 1.00 | 1.00 | 1.00 | 1.00 | 1.00 |
|---|---|---|---|---|---|---|---|---|---|---|---|---|
| Molar mass of epoxy group in component(A) | | | | | | | | | | | | |
| T [symbol] g (Meq) | °C | 178 | 178 | 178 | 178 | 178 | 178 | 178 | 178 | 178 | 178 | 178 |
| E′ (Meq) | MPa | 23.8 | 23.8 | 23.8 | 23.8 | 23.8 | 23.8 | 23.8 | 23.8 | 23.8 | 23.8 | 23.8 |
| Tmin (Meq) | °C | 197 | 197 | 197 | 197 | 197 | 197 | 197 | 197 | 197 | 197 | 197 |

| | | | | | | | | | | | |
|---|---|---|---|---|---|---|---|---|---|---|---|
| ([273 + Tmin (M)]/[273 + Tmin (Meq)]) × [E′ (Meq)]/[E′ (M)] | 1.96 | 3.92 | 1.54 | 7.91 | 1.96 | 1.96 | 1.96 | 1.96 | 1.96 | 1.96 | 1.96 |

[symbol]

) Number of epoxy functional groups of component(A) [symbol]
+) Epoxy equivalent weight of component(A) (g/eq)

[symbol]

(*) Contained amount of epoxy group with respect to total mass of shell layer of polymer particles which are component(B) (mmol/g)
(**) % by mass of chain transfer agent in monomer mixture of core layered polymer particles which are component(B)(%)

[symbol]

| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|---|
| [symbol] rable | Component (A) | Bisphenol A epoxy resin | difunctional [symbol] | 189⁽**⁾ | (A) [symbol] | A-(2) | 100 | 100 | 100 | 100 | 70 | 70 | 70 | 70 |
| [symbol] sin | Component (A) + | Dispersion (M) in | 0.5 [symbol] | 0.0⁽**⁾ | (B-1) | M-(2) | | | | | 50 | 50 | 50 | 50 |
| | Component (B) | which component (B) | | | | | | | | | | | | |
| | | is dispersed in | | | | | | | | | | | | |
| | | component (A) | | | | | | | | | | | | |
| [symbol] mposition | Component (C) | Aromatic amide | | | (c2) | c2-(1) | 18.9 | 16.5 | 23.6 | 47.2 | 23.6 | 21.2 | 14.1 | 59.0 |
| | Type of component (A) | | | | | | A [symbol] | A [symbol] | A [symbol] | A [symbol] | A [symbol] | A [symbol] | A [symbol] | A [symbol] |
| | Type of component (B) | | | | | | — | — | — | — | B-1 | B-1 | B-1 | B-1 |
| | Type of component (C) | | | | | | c2 | c2 | c2 | c2 | c2 | c2 | c2 | c2 |
| | Molar mass of active hydrogen atom of amine in component (C)/ | | | | | | 0.80 | 0.70 | 1.00 | 2.00 | 1.00 | 0.90 | 0.60 | 2.5 |
| | Molar mass of epoxy group in component (A) | | | | | | | | | | | | | |
| | Amount of component (B) with respect to 100 parts of component (A) (parts by mass) | | | | | | 0 parts | 0 parts | 0 parts | 0 parts | 20 parts | 20 parts | 20 parts | 20 parts |
| | Amount of component (C) with respect to 100 parts of component (A) (parts by mass) | | | | | | 19 parts | 17 parts | 24 parts | 47 parts | 24 parts | 21 parts | 14 parts | 59 parts |
| [symbol] red | K1c | | MPa m [symbol] | | | | 0.69 | 0.78 | 0.62 | 1.05 | 1.09 | 1.17 | 0.60 | 0.17 |
| [symbol] oduct | G1c | | kJ/m² | | | | 0.15 | 0.22 | 0.09 | 0.33 | 0.52 | 0.50 | 0.14 | 0.00 |
| [symbol] omposition | Component (A) | Bisphenol A epoxy resin | difunctional [symbol] | 189 ⁽ | (A) [symbol] | A-(2) | 100 | 100 | 100 | 100 | 100 | 100 | 100 | 100 |
| [symbol] ) | Component (C) | Aromatic amide | | | (c2) | c2-(1) | 18.9 | 16.5 | 23.6 | 47.2 | 23.6 | 21.2 | 14.1 | 58.0 |
| | Molar mass of active hydrogen atom of amine in component (C)/ | | | | | | 0.80 | 0.70 | 1.00 | 2.00 | 1.00 | 0.90 | 0.60 | 2.5 |
| | Molar mass of epoxy group in component (A) | | | | | | | | | | | | | |
| | T [symbol] g (M) | | °C | | | | 128 | 106 | 176 | 109 | 176 | 151 | 85 | 60 |
| | E′ (M) | | MPa | | | | 11.0 | 5.2 | 14.1 | 2.0 | 23.8 | 18.1 | 1.9 | 0.1 |
| | Tmin (M) | | °C | | | | 152 | 130 | 197 | 133 | 197 | 176 | 109 | 105 |
| [symbol] omposition | Component (A) | Bisphenol A epoxy resin | difunctional [symbol] | 1.30 [symbol] | (A) [symbol] | A-(2) | 100 | 100 | 100 | 100 | 100 | 100 | 100 | 100 |

| | | | | | | | | | | | | |
|---|---|---|---|---|---|---|---|---|---|---|---|---|
| [symbol] Meq) | Component (C) | Aromatic amide | (a2 [symbol] | a2-(3) | 23.6 | 23.6 | 23.6 | 23.6 | 23.6 | 23.6 | 23.6 | 23.6 |

| Molar mass of active hydrogen atom of amine in component (C)/ | | 1.00 | 1.00 | 1.00 | 1.00 | 1.00 | 1.00 | 1.00 | 1.00 |
|---|---|---|---|---|---|---|---|---|---|
| Molar mass of epoxy group in component (A) | | | | | | | | | |
| T [symbol] g (Meq) | °C | 176 | 176 | 176 | 176 | 176 | 176 | 176 | 176 |
| E′ (Meq) | MPa | 23.8 | 23.8 | 23.8 | 23.8 | 23.8 | 23.8 | 23.8 | 23.8 |
| Tmin (Meq) | °C | 197 | 197 | 197 | 197 | 197 | 197 | 197 | 197 |

| | | | | | | | | |
|---|---|---|---|---|---|---|---|---|
| ([273 + Tmin (M)]/[273 + Tmin (Meq)]) × [E′ (Meq)]/[E′ (M)] | 1.96 | 3.92 | 1.00 | 7.91 | 1.00 | 1.26 | 10.18 | 191.41 |

[symbol]

) Number of epoxy functional groups of component(A) [symbol]
+) Epoxy equivalent weight of component(A) (g/eq) [symbol]
++) Component(A) which is neither component(a1) nor component(a2)
(*) Contained amount of epoxy group with respect to total mass of shell layer of polymer particles which are component(B) (mmol/g)
(**) % by mass of chain transfer agent in monomer mixture of core layered polymer particles which are component(B)(%)

| [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|
| [symbol] urable | Component(A) | BisphenolA epoxy resin | difunctional [symbol] | 189 [symbol] | (A) [symbol] | A-(2) | 70 | 54 | 54 | 54 | 54 | 54 |
| [symbol] sin | | Polyfunctional epoxy group- | difunctional [symbol] | 480 [symbol] | (a1) | A-(6) | | 15.2 | | 15.2 | 15.2 | |
| [symbol] mposition | | containing substance(a1) | | | | | | | | | | |
| | | Monofunctional epoxy group- | monofunctional [symbol] | 182 [symbol] | (a2) | A-(7) | | | 5.8 | 5.8 | | 5.8 |
| | | containing substances(a2) | | | | | | | | | | |
| | Component(A) + | Dispersion(M) in which | 0.0 [symbol] | 0.0 [symbol] | (B) [symbol] | M-(11) | 50 | 50 | 50 | 50 | 50 | 50 |
| | Component(B) | component(B) is | | | | | | | | | | |
| | | dispersed in component(A) | | | | | | | | | | |
| | Component(C) | Aromatic amide | | | (c2) | c2-(1) | 18.9 | 18.9 | 18.9 | 18.9 | 23.6 | 23.6 |
| | Type of component(A) | | | | | | A [symbol] | A [symbol] a1 | A [symbol] a2 | A [symbol] a1, a2 | A [symbol] a1 | A [symbol] a2 |
| | Type of component(B) | | | | | | B⁽**⁾ | B⁽**⁾ | B⁽**⁾ | B⁽**⁾ | B⁽**⁾ | B⁽**⁾ |
| | Type of component(C) | | | | | | c2 | c2 | c2 | c2 | c2 | c2 |
| | Molar mass of active hydrogen atom of amine in component(C)/ | | | | | | 0.80 | 0.80 | 0.80 | 0.80 | 1.00 | 1.00 |
| | Molar mass of epoxy group in component(A) | | | | | | | | | | | |
| | Amount of component(B) with respect to 100 parts of component(A) (parts by mass) | | | | | | 20 parts | 18 parts | 20 parts | 18 parts | 18 parts | 20 parts |
| | Amount of component(C) with respect to 100 parts of component(A) (parts by mass) | | | | | | 19 parts | 17 parts | 19 parts | 17 parts | 22 parts | 24 parts |
| [symbol] ured | K1c | | MPa m [symbol] | | | | 1.52 | 1.68 | 1.53 | 1.85 | 0.98 | 1.10 |
| [symbol] oduct | G1c | | kJ/m [symbol] | | | | 1.03 | 1.33 | 1.24 | 1.55 | 0.48 | 0.57 |
| [symbol] omposition | Component(A) | BisphenolA epoxy resin | difunctional [symbol] | 189 [symbol] | (A) [symbol] | A-(2) | 100 | 94 | 94 | 88 | 94 | 94 |
| [symbol] ) | | Polyfunctional epoxy group- | difunctional [symbol] | 480 [symbol] | (a1) | A-(4) | | 15.2 | | 15.2 | 15.2 | |
| | | containing substance(a1) | | | | | | | | | | |
| | | Monofunctional epoxy group- | monofunctional [symbol] | 182 [symbol] | (a2) | A-(5) | | | 5.8 | 5.8 | | 5.8 |
| | | containing substances(a2) | | | | | | | | | | |
| | Component(C) | Aromatic amide | | | (c2) | c2-(1) | 18.9 | 18.9 | 18.9 | 18.9 | 23.6 | 23.6 |
| | Molar mass of active hydrogen atom of amine in component(C)/ | | | | | | 0.80 | 0.80 | 0.80 | 0.80 | 1.00 | 1.00 |
| | Molar mass of epoxy group in component(A) | | | | | | | | | | | |
| | T [symbol] g (M) | | °C | | | | 128 | 120 | 113 | 111 | 165 | 155 |
| | E′ (M) | | MPa | | | | 11.0 | 9.0 | [symbol] | [symbol] | 22.8 | 21.2 |
| | Tmin (M) | | °C | | | | 152 | 145 | 137 | 135 | 190 | 180 |
| [symbol] omposition | Component(A) | BisphenolA epoxy resin | difunctional [symbol] | 189 [symbol] | (A) [symbol] | A-(2) | 100 | 94 | 94 | 88 | 94 | 94 |
| [symbol] eq) | | Polyfunctional epoxy group- | difunctional [symbol] | 480 [symbol] | (a1) | A-(4) | | 15.2 | | 15.2 | 15.2 | |
| | | containing substance(a1) | | | | | | | | | | |
| | | Monofunctional epoxy group- | monofunctional [symbol] | 182 [symbol] | (a2) | A-(5) | | | 5.8 | 5.8 | | 5.8 |
| | | containing substances(a2) | | | | | | | | | | |

| | | | | | | | | | |
|---|---|---|---|---|---|---|---|---|---|
| Component(C) | Aromatic amide | (c2) | c2-(1) | 23.6 | 23.6 | 23.6 | 23.6 | 23.6 | 23.6 |

| Molar mass of active hydrogen atom of amine in component(C)/ | | 1.00 | 1.00 | 1.00 | 1.00 | 1.00 | 1.00 |
|---|---|---|---|---|---|---|---|
| Molar mass of epoxy group in component(A) | | | | | | | |
| T [symbol] g (Meq) | °C | 179 | 165 | 155 | 152 | 165 | 153 |
| E′ (Meq) | MPa | 23.8 | 22.8 | 21.2 | 20.2 | 22.8 | 21.2 |
| Tmin (Meq) | °C | 197 | 100 | 180 | 177 | 190 | 150 |

| | | | | | | |
|---|---|---|---|---|---|---|
| ([273 + Tmin (M)]/[273 + Tmin (Meq)]) × [E′ (Meq)]/[E′ (M)] | 1.96 | 2.29 | 2.23 | 2.29 | 1.00 | 1.00 |
| [273 + Tmin (M)]/[E′ (M)] | 18.6 | 15.8 | 47.7 | 51.0 | 20.3 | 21.4 |

[symbol]

) Number of epoxy functional groups of component(A) [symbol]
+) Epoxy equivalent weight of component(A) (g/eq) [symbol]
++) Component(A) which is neither component(a1) nor component(a2)
(*) Contained amount of epoxy group with respect to total mass of shell layer of polymer particles which are component(B) (mmol/g)
(**) % by mass of chain transfer agent in monomer mixture of core layered polymer particles which are component(B)(%)
(***) Component(B) which is neither component(B-1), (B-2), nor component(B-3)

| [symbol] | [symbol] | [symbol] | [symbol] | [symbol] | [symbol] | [symbol] | [symbol] | [symbol] |
|---|---|---|---|---|---|---|---|---|
| [symbol] urable resin | Component (A) + | Dispersion (M) in which | 0.6 [symbol] | 0.0 [symbol] | (B-1) | M-(1) | 100 | 100 |
| [symbol] mposition | Component (B) | component (B) is | | | | | | |
| | | dispersed in component (A) | | | | | | |
| | Component (C) | Acid anhydride | | | (c1) | c1-(1) | 66 | 66 |
| | Component (D) | Curing accelerator | | | | D-(3) | 2 | |
| | | | | | | D-(4) | | 2 |
| | Type of component (B) | | | | | | B-1 | B-1 |
| | Type of component (C) | | | | | | c1 | c1 |
| | Molar mass of acid anhydride group in component (C)/ | | | | | | 0.85 | 0.85 |
| | Molar mass of epoxy group in component (A) | | | | | | | |
| | Amount of component (B) with respect to 100 parts of component (A) (parts by mass) | | | | | | 67 parts | 67 parts |
| | Amount of component (C) with respect to 100 parts of component (A) (parts by mass) | | | | | | 110 parts | 110 parts |
| | Amount of component (D) with respect to 100 parts of component (A) (parts by mass) | | | | | | 3 parts | 3 parts |
| [symbol] ured | K1c | | MPa m [symbol] | | | | 1.95 | 1.50 |
| product | G1c | | kJ/m [symbol] | | | | 1.28 | 1.26 |
| [symbol] omposition | Component (A) | Alicyclic epoxy resin | difunctional [symbol] | 130 [symbol] | (A) [symbol] | A-(1) | 60 | 60 |
| [symbol] ) | Component (C) | Acid anhydride | | | (c1) | c1-(2) | 65 | 56 |
| | Component (D) | Curing accelerator | | | | D-(2) | 2 | |
| | | | | | | D-(4) | | 2 |
| | Molar mass of acid anhydride group in component (C)/ | | | | | | 0.85 | 0.85 |
| | Molar mass of epoxy group in component (A) | | | | | | | |
| | T [symbol] g (Meq) | | °C | | | | 206 | 209 |
| | E′ (Meq) | | MPa | | | | 19.86 | 20.88 |
| | Tmin (Meq) | | °C | | | | 227 | 230 |
| [symbol] omposition | Component (A) | Alicyclic epoxy resin | difunctional [symbol] | 130 [symbol] | (A) [symbol] | A-(1) | 60 | 60 |

| | | | | | | |
|---|---|---|---|---|---|---|
| [symbol] eq) | Component (C) | Acid anhydride | (c1) | c1-(1) | 78 | 78 |

| | | | | |
|---|---|---|---|---|
| Component (D) | Curing accelerator | D-(3) | 2 | |
| | | D-(4) | | 2 |

| Molar mass of acid anhydride group in component (C)/ | | 1.00 | 1.00 |
|---|---|---|---|
| Molar mass of epoxy group in component (A) | | | |
| T [symbol] g (Meq) | °C | 209 | 214 |
| E′ (Meq) | MPa | 21.36 | 21.97 |
| Tmin (Meq) | °C | 233 | 236 |

| | | |
|---|---|---|
| ([273 + Tmin (M)]/[273 + Tmin (Meq)]) × [E′ (Meq)]/[E′ (M)] | 1.06 | 1.05 |

[symbol]

) Number of epoxy functional groups of component(A) [symbol]
+) Epoxy equivalent weight of component(A) (g/eq) [symbol]
++) Component(A) which is neither component(a1) nor component(a2)
(*) Contained amount of epoxy group with respect to total mass of shell layer of polymer particles which are component(B) (mmol/g)
(**) % by mass of chain transfer agent in monomer mixture of core layered polymer particles which are component(B)(%)

| [symbol] | [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|
| | | | | | | | 1B | 2B | 3B | 1B | 2B | 3B | 4B |
| [symbol] urable resin | Component (A) | BisphenolA epoxy resin | difunctional [symbol] | 189 [symbol] | (A) [symbol] | A-(2) | 70 | 70 | 70 | 70 | 70 | 70 | 100 |
| [symbol] mposition | Component (A) + | Dispersion(M) in which | 0.5 [symbol] | 0.0 [symbol] | (B-1) | M-(2) | 50 | 50 | 50 | 50 | 50 | 50 | |
| | Component (B) | component(B) is | | | | | | | | | | | |
| | | dispersed in component(A) | | | | | | | | | | | |
| | Component(C) | Alicyclic amine | | | (c3) | c3-(1) | 18. | | | 22.5 | | | |
| | | | | | | c3-(2) | | 15.1 | | | 18.8 | | |
| | | | | | | c3-(3) | | | 22.3 | | | 27.8 | 22.3 |
| | Type of component(A) | | | | | | A [symbol] | A [symbol] | A [symbol] | A [symbol] | A [symbol] | A [symbol] | A [symbol] |
| | Type of component(B) | | | | | | B-1 | B-1 | B-1 | B-1 | B-1 | B-1 | — |
| | Molar mass of active hydrogen atom of amine in component(C)/ | | | | | | 0.80 | 0.80 | 0.80 | 1.00 | 1.00 | 1.00 | 0.80 |
| | Molar mass of epoxy group in component(A) | | | | | | | | | | | | |
| | Amount of component (B) with respect to 100 parts of component(A) (parts by mass) | | | | | | 20 parts | 20 parts | 20 parts | 20 parts | 20 parts | 20 parts | 0 parts |
| | Amount of component (C) with respect to 100 parts of component(A) (parts by mass) | | | | | | 18 parts | 15 parts | 22 parts | 23 parts | 19 parts | 28 parts | 22 parts |
| [symbol] ured | K1c | | MPa m [symbol] | | | | 2.21 | 2.91 | 2.05 | 1.78 | 1.85 | 1.47 | 0.83 |
| [symbol] oduct | G1c | | kJ/m [symbol] | | | | 2.32 | 5.49 | 2.28 | 1.82 | 1.58 | 1.28 | 0.12 |
| [symbol] omposition | Component (A) | BisphenolA epoxy resin | difunctional [symbol] | 189 [symbol] | (A) [symbol] | A-(2) | 100 | 100 | 100 | 100 | 100 | 100 | 100 |
| [symbol] ) | Component (C) | Alicyclic amine | | | (c3) | c3-(1) | 18.0 | | | 22.5 | | | |
| | | | | | | c3-(2) | | 15.1 | | | 18.8 | | |
| | | | | | | c3-(2) | | | 22.3 | | | 27.8 | 22.3 |
| | Molar mass of active hydrogen atom of amine in component(C)/ | | | | | | 0.80 | 0.80 | 0.80 | 1.00 | 1.00 | 1.00 | 0.80 |
| | Molar mass of epoxy group in component(A) | | | | | | | | | | | | |
| | T [symbol] g (M) | | °C | | | | 116 | [symbol] | 116 | 142 | 140 | 146 | 116 |
| | E′ (M) | | MPa | | | | 0.73 | 6.76 | 11.70 | 20.57 | 22.37 | 24.16 | 11.70 |
| | Tmin (M) | | °C | | | | 136 | 112 | 139 | 157 | 153 | 166 | 130 |
| [symbol] omposition | Component (A) | BisphenolA epoxy resin | difunctional [symbol] | 189 [symbol] | (A) [symbol] | A-(2) | 100 | 100 | 100 | 100 | 100 | 100 | 100 |

| | | | | | | | | | | | |
|---|---|---|---|---|---|---|---|---|---|---|---|
| [symbol] eq) | Component (C) | Alicyclic amine | (c3) | c3-(1) | 22.5 | | | 22.5 | | | |
| | | | | c3-(2) | | 18.8 | | | 18.8 | | |
| | | | | c3-(2) | | | 27.8 | | | 27.8 | 27.8 |

| Molar mass of active hydrogen atom of amine in component(C)/ | | 1.00 | 1.00 | 1.00 | 1.00 | 1.00 | 1.00 | 1.00 |
|---|---|---|---|---|---|---|---|---|
| Molar mass of epoxy group in component(A) | | | | | | | | |
| T [symbol] g (Meq) | °C | 142 | 140 | 146 | 142 | 140 | 146 | 146 |
| E′ (Meq) | MPa | 20.57 | 22.37 | 24.16 | 20.57 | 22.37 | 24.10 | 24.16 |
| Tmin (Meq) | °C | 157 | 153 | 166 | 157 | 153 | 166 | 166 |

| | | | | | | | |
|---|---|---|---|---|---|---|---|
| ([273 + Tmin (M)]/[273 + Tmin (Meq)]) × [E′ (Meq)]/[E′ (M)] | 2.01 | 2.31 | 1.94 | 1 | 1 | 1 | 1.94 |

[symbol]

) Number of epoxy functional groups of component(A) [symbol]
+) Epoxy equivalent weight of component(A) (g/eq) [symbol]
++) Component(A) which is neither component(a1) nor component(a2)
(*) Contained amount of epoxy group with respect to total mass of shell layer of polymer particles which are component(B) (mmol/g)
(**) % by mass of chain transfer agent in monomer mixture of core layered polymer particles which are component(B)(%)

[symbol]

indicates data missing or illegible when filed

| [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|
| [symbol] urable | Component(A) | BisphenolA epoxy resin | difunctional [symbol] | [symbol] | A [symbol] | A-(2) | 70 | 70 | [symbol] | [symbol] |
| resin | | Polyfunctional epoxy group- | difunctional [symbol] | 480 [symbol] | (a1) | A-(6) | | | | 25.4 |
| [symbol] mposition | | containing substance(a1) | | | | | | | | |
| | | Monofunctional epoxy group- | monofunctional [symbol] | 182 [symbol] | (a2) | A-(7) | | | 9.6 | |
| | | containing substances(a2) | | | | | | | | |
| | Component(A) + | Dispersion(M) in | 0.5 [symbol] | 0.0 [symbol] | (B-1) | M-(2) | | | 50 | 50 |
| | Component(B) | which component(B) | 0.0 [symbol] | 0.4 [symbol] | (B-2) | M-(4) | 50 | | | |
| | | is dispersed in | 0.5 [symbol] | 0.4 [symbol] | (B-3) | M-(5) | | 50 | | |
| | | component(A) | | | | | | | | |
| | Component(C) | Alicyclic amine | | | (c3) | c3-(1) | 18 | 18 | 18 | 18 |
| | Type of component(A) | | | | | | A [symbol] | A [symbol] | A [symbol] a2 | A [symbol] a1 |
| | Type of component(B) | | | | | | B-2 | B-3 | B-1 | B-1 |
| | Molar mass of active hydrogen atom of amine in component(C)/ | | | | | | 0.80 | 0.80 | 0.80 | 0.80 |
| | Molar mass of epoxy group in component(A) | | | | | | | | | |
| | Amount of component(a1) in 100 parts by mass of component(A) (parts by mass) | | | | | | 0 parts | 0 parts | 0 parts | 22 parts |
| | Amount of component(a2) in 100 parts by mass of component(A) (parts by mass) | | | | | | 0 parts | 0 parts | 10 parts | 0 parts |
| | Amount of component(B) with respect to 100 parts of component(A) (parts by mass) | | | | | | 20 parts | 20 parts | 20 parts | 17 parts |
| | Amount of component(C) with respect to 100 parts of component(A) (parts by mass) | | | | | | 18 parts | 18 parts | 18 parts | 16 parts |
| [symbol] ured | K1c | | MPa m [symbol] | | | | 2.30 | 2.41 | 2.60 | 2.39 |
| product | G1c | | kJ/m [symbol] | | | | 2.87 | 2.70 | 3.35 | 2.92 |
| [symbol] omposition | Component(A) | BisphenolA epoxy resin | difunctional [symbol] | 189 [symbol] | A [symbol] | A-(2) | 100 | 100 | 90 | 90 |
| [symbol] ) | | Polyfunctional epoxy group- | difunctional [symbol] | 480 [symbol] | (a1) | A-(6) | | | | 25.4 |
| | | containing substance(a1) | | | | | | | | |
| | | Monofunctional epoxy group- | monofunctional [symbol] | 182 [symbol] | (a2) | A-(7) | | | 9.6 | |
| | | containing substances(a2) | | | | | | | | |
| | Component(C) | Alicyclic amine | | | (c3) | c3-(1) | 18 | 18 | 18 | 18 |
| | Molar mass of active hydrogen atom of amine in component(C)/ | | | | | | 0.80 | 0.80 | 0.80 | 0.80 |
| | Molar mass of epoxy group in component(A) | | | | | | | | | |
| | T [symbol] g (M) | | °C | | | | 118 | 118 | 100 | 114 |
| | E′ (M) | | MPa | | | | 8.40 | 8.88 | 7.32 | 8.30 |
| | Tmin (M) | | °C | | | | 138 | 138 | 122 | 138 |
| [symbol] omposition | Component(A) | BisphenolA epoxy resin | difunctional [symbol] | 189 [symbol] | A [symbol] | A-(2) | 100 | 100 | 80 | 80 |
| [symbol] eq) | | Polyfunctional epoxy group- | difunctional [symbol] | 480 [symbol] | (a1) | A-(6) | | | | 25.4 |
| | | containing substance(a1) | | | | | | | | |
| | | Monofunctional epoxy group- | monofunctional [symbol] | 182 [symbol] | (a2) | A-(7) | | | 9.6 | |
| | | containing substances(a2) | | | | | | | | |

| | | | | | | | |
|---|---|---|---|---|---|---|---|
| Component(C) | Alicyclic amine | (a2 [symbol] | a2-(3) | 22.5 | 22.5 | 22.5 | 22.5 |

| Molar mass of active hydrogen atom of amine in component(C)/ | | 1.00 | 1.00 | 1.00 | 1.00 |
|---|---|---|---|---|---|
| Molar mass of epoxy group in component(A) | | | | | |
| T [symbol] g (Meq) | °C | 142 | 142 | 139 | 141 |
| E′ (Meq) | MPa | 20.57 | 20.57 | 18.84 | 19.50 |
| Tmin (Meq) | °C | 157 | 157 | 154 | 156 |

| | | | | |
|---|---|---|---|---|
| ([273 + Tmin (M)]/[273 + Tmin (Meq)]) × [E′ (Meq)]/[E′ (M)] | 2.33 | 2.28 | 2.28 | 2.20 |
| [273 + Tmin (M)]/[E′ (M)] | 20.0 | 20.0 | 22.7 | 22.0 |

[symbol]

) Number of epoxy functional groups of component(A) [symbol]
+) Epoxy equivalent weight of component(A) (g/eq) [symbol]
++) Component(A) which is neither component(a1) nor component(a2)
(*) Contained amount of epoxy group with respect to total mass of shell layer of polymer particles which are component(B) (mmol/g)
(**) % by mass of chain transfer agent in monomer mixture of core layered polymer particles which are component(B) (%)

| [symbol] | [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|
| [symbol] ble | Component (A) | Alicyclic epoxy resin | difunctional [symbol] | 130 [symbol] | (A) [symbol] | A-(1) | | | | | 13.8 | | |
| [symbol] | | BisphenolA epoxy resin | difunctional [symbol] | 189 [symbol] | (A) [symbol] | A-(2) | 45 | 45 | 10 | 25 | 25 | 70 | 65 |
| [symbol] position | | BisphenolF epoxy resin | difunctional [symbol] | 170 [symbol] | (A) [symbol] | A-(3) | | | | 18 | | | 18 |
| | | Monofunctional epoxy group- | monofunctional [symbol] | 182 [symbol] | (a2) | A-(7) | 24.3 | 24.3 | 48.5 | 24.3 | 24.3 | | 24.3 |
| | | containing substances(a2) | | | | | | | | | | | |
| | Component (A) + | Dispersion(M) in which | 0.5 [symbol] | 0.0 [symbol] | (B-1) | M-(2) | 50 | 50 | 50 | 50 | 50 | 50 | |
| | Component (B) | component(B) is | | | | | | | | | | | |
| | | dispersed in component(A) | | | | | | | | | | | |
| | Component (C) | Acid anhydride | | | (c1) | c1-(1) | 50 | | | | | | |
| | | | | | | c1-(2) | | 88 | 88 | 88 | 88 | 88 | 88 |
| | Component (D) | Curing accelerator | | | | D-(2) | 4 | 4 | 4 | 4 | 4 | 4 | 4 |
| | Type of component(A) | | | | | | A [symbol] a2 | A [symbol] a2 | A [symbol] a2 | A [symbol] a2 | A [symbol] a2 | A [symbol] | A [symbol] a2 |
| | Type of component(B) | | | | | | B-1 | B-1 | B-1 | B-1 | B-1 | B-1 | — |
| | Type of component(C) | | | | | | c1 | c1 | c1 | c1 | c1 | c1 | c1 |
| | Molar mass of acid anhydride group in component(C)/ | | | | | | 1.00 | 1.00 | 1.00 | 1.00 | 1.00 | 1.00 | 1.00 |
| | Molar mass of epoxy group in component(A) | | | | | | | | | | | | |
| | Amount of component(a2) in 100 parts by mass of component(A) (parts by mass) | | | | | | 24 parts | 24 parts | 40 parts | 25 parts | 26 parts | 0 parts | 24 parts |
| | Amount of component(B) with respect to 100 parts of component(A) (parts by mass) | | | | | | 20 parts | 20 parts | 20 parts | 21 parts | 21 parts | 20 parts | 0 parts |
| | Amount of component(C) with respect to 100 parts of component(A) (parts by mass) | | | | | | [symbol] parts | [symbol] parts | 89 parts | 90 parts | [symbol] parts | 88 parts | 20 parts |
| | Amount of component(D) with respect to 100 parts of component(A) (parts by mass) | | | | | | 4 parts | 4 parts | 4 parts | 4 parts | 4 parts | 4 parts | 4 parts |
| | Viscosity of curable resin composition | | P a s | | | | 0.6 | 0.7 | 0.2 | 0.5 | 0.3 | 2. [symbol] | 0.4 |
| [symbol] d | K1c | | MPa m [symbol] | | | | 1.96 | 2.37 | 2.48 | 2.42 | 2.24 | 1.77 | 0.7 [symbol] |
| [symbol] uct | G1c | | kJ/m [symbol] | | | | 1.84 | 2.72 | 2.78 | 2.82 | 2.10 | 1.47 | 0.18 |
| [symbol] position | Component (A) | BisphenolA epoxy resin | difunctional [symbol] | 189 [symbol] | (A) [symbol] | A-(2) | 75 | 75 | 60 | 55 | 55 | 100 | 55 |
| | | BisphenolF epoxy resin | difunctional [symbol] | 170 [symbol] | (A) [symbol] | A-(3) | | | | 18 | | 30 | 18 |
| | | Alicyclic epoxy resin | difunctional [symbol] | 130 [symbol] | (A) [symbol] | A-(1) | | | | | 13.8 | | |
| | | Monofunctional epoxy group- | monofunctional [symbol] | 182 [symbol] | (a2) | A-(7) | 24.3 | 24.3 | 48.5 | 24.3 | 24.3 | | 24.3 |
| | | containing substances(a2) | | | | | | | | | | | |

| | | | | | | | | | | |
|---|---|---|---|---|---|---|---|---|---|---|
| Component (C) | Acid anhydride | (c1) | c1-(1) | 88 | | | | | | |
| | | | c1-(2) | | 88 | 88 | 88 | 88 | 88 | 88 |

| | | | | | | | | | |
|---|---|---|---|---|---|---|---|---|---|
| Component (D) | Curing accelerator | D-(2) | 4 | 4 | 4 | 4 | 4 | 4 | 4 |

| Molar mass of a group in component(C)/ | | 1.00 | 1.00 | 1.00 | 1.00 | 1.00 | 1.00 | 1.00 |
|---|---|---|---|---|---|---|---|---|
| Molar mass of epoxy group in component(A) | | | | | | | | |
| T [symbol] g (M) | °C | 123 | 109 | 85 | 108 | 117 | 141 | 108 |
| E′ (M) | MPa | 15.1 | 12.9 | 5.5 | 12.4 | 12.3 | 22.9 | 12.4 |
| Tmin (M) | °C | 139 | 128 | 109 | 127 | 136 | 157 | 127 |

| | | | | | | | |
|---|---|---|---|---|---|---|---|
| [273 + Tmin (M)]/[E′ (M)] | 27 | 31 | 60 | 32 | 33 | 10 | 32 |

[symbol]

umber of epoxy functional groups of component(A) [symbol]
Epoxy equivalent weight of component(A) (g/eq) [symbol]
) Component(A) which is neither component(a1) nor component(a2)
(*) Contained amount of epoxy group with respect to total mass of shell layer of polymer particles which are component(B) (mmol/g)
(**) % by mass of chain transfer agent in monomer mixture of core layered polymer particles which are component(B) (%)

| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|---|
| [symbol] rable | Component (A) | BisphenolA epoxy resin | difunctional [symbol] | 189 [symbol] | (A) [symbol] | A-(2) | 60 | 40 | 20 | 50 | 70 | 57 | [symbol] 0 | 70 |
| [symbol] | | Polyfunctional epoxy group- | difunctional [symbol] | 480 [symbol] | (a1) | A-(6) | | | | 25.4 | | | | |
| [symbol] mposition | | containing substance(a1) | | | | | | | | | | | | |
| | | Monofunctional epoxy group- | monofunctional [symbol] | 182 [symbol] | (a2) | A-(7) | 9.0 | 25.9 | 48.2 | 9.8 | | 2.9 | 57.8 | 28.9 |
| | | containing substances(a2) | | | | | | | | | | | | |
| | Component (A) + | Dispersion(M) in | 0.5 [symbol] | 0.0 [symbol] | (B-1) | M-(2) | 50 | 50 | 50 | 50 | 50 | 50 | 50 | |
| | Component (B) | which component(B) | | | | | | | | | | | | |
| | | is dispersed in | | | | | | | | | | | | |
| | | component(A) | | | | | | | | | | | | |
| | Component (C) | Aromatic amide | | | (c2) | c2-(1) | 23.6 | 23.6 | 23.6 | 23.6 | 23.6 | 23.6 | 23.6 | 23.6 |
| | Type of component(A) | | | | | | A [symbol] a2 | A [symbol] a2 | A [symbol] a2 | A [symbol] a1, a2 | A [symbol] | A [symbol] a2 | A [symbol] a2 | A [symbol] a2 |
| | Type of component(B) | | | | | | B-1 | B-1 | B-1 | B-1 | B-1 | B-1 | B-1 | B-1 |
| | Type of component(C) | | | | | | c2 | c2 | c2 | c2 | c2 | c2 | c2 | c2 |
| | Molar mass of active hydrogen atom of amine in component(C)/ | | | | | | 1.00 | 1.00 | 1.00 | 1.00 | 1.00 | 1.00 | 1.00 | 1.00 |
| | Molar mass of epoxy group in component(A) | | | | | | | | | | | | | |
| | Amount of component (a1) in 100 parts by mass of component(A) (parts by mass) | | | | | | 0 parts | 0 parts | 0 parts | 22 parts | 0 parts | 0 parts | 0 parts | 0 parts |
| | Amount of component (a2) in 100 parts by mass of component(A) (parts by mass) | | | | | | 10 parts | 29 parts | 49 parts | [symbol] parts | 0 parts | 0 parts | 50 parts | 29 parts |
| | Amount of component (B) with respect to 100 parts of component(A) (parts by mass) | | | | | | 20 parts | 20 parts | 20 parts | [symbol] 7 parts | 20 parts | 20 parts | 20 parts | 0 parts |
| | Amount of component (C) with respect to 100 parts of component(A) (parts by mass) | | | | | | 24 parts | 24 parts | 24 parts | 21 parts | 24 parts | 24 parts | 24 parts | 24 parts |
| [symbol] ed | K1c | | MPa m [symbol] | | | | 1.42 | 2.34 | 1.58 | 1.60 | 1.00 | 1.14 | 0.20 or less | 0.79 |
| [symbol] oduct | G1c | | kJ/m [symbol] | | | | 0.89 | 2.93 | 1.97 | 1.20 | 0.43 | 0.58 | 0.10 or less | 0.14 |
| [symbol] position | Component (A) | BisphenolA epoxy resin | difunctional [symbol] | 189 [symbol] | (A) [symbol] | A-(2) | 90 | 70 | 50 | 60 | 100 | 97 | 40 | 70 |
| [symbol] ) | | Polyfunctional epoxy group- | difunctional [symbol] | 480 [symbol] | (a1) | A-(6) | | | | 25.4 | | | | |
| | | containing substance(a1) | | | | | | | | | | | | |
| | | Monofunctional epoxy group- | monofunctional [symbol] | 182 [symbol] | (a2) | A-(7) | 9.6 | 28.9 | 48.2 | 9.6 | | 2.9 | 57.8 | 28.9 |
| | | containing substances(a2) | | | | | | | | | | | | |

| | | | | | | | | | | | |
|---|---|---|---|---|---|---|---|---|---|---|---|
| Component (C) | Aromatic amide | (c2) | c2-(1) | 23.6 | 23.6 | 23.6 | 23.6 | 23.6 | 23.6 | 23.6 | 23.6 |

| Molar mass of active hydrogen atom of amine in component(C)/ | | 1.00 | 1.00 | 1.00 | 1.00 | 1.00 | 1.00 | 1.00 | 1.00 |
|---|---|---|---|---|---|---|---|---|---|
| Molar mass of epoxy group in component(A) | | | | | | | | | |
| Tg (M) | °C | 150 | 107 | 77 | 141 | 180 | 171 | 84 | 107 |
| E′ (M) | MPa | 19.3 | 8.1 | 1.4 | 18.7 | 27.0 | 24.8 | 0.03 | 8.1 |
| Tmin (M) | °C | 178 | 129 | 117 | 169 | 201 | 104 | 127 | 129 |

| | | | | | | | | |
|---|---|---|---|---|---|---|---|---|
| [273 + Tmin (M)]/[E′ (M)] | 23 | 50 | 278 | 28 | 18 | 19 | 13333 | 50 |

[symbol]

) Number of epoxy functional groups of component(A) [symbol]
+) Epoxy equivalent weight of component(A) (g/eq) [symbol]
++) Component(A) which is neither component(a1) nor component(a2)
(*) Contained amount of epoxy group with respect to total mass of shell layer of polymer particles which are component(B) (mmol/g)
(**) % by mass of chain transfer agent in monomer mixture of core layered polymer particles which are component(B) (%)

| [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|
| Curable | Component (A) | Bisphenol A epoxy resin | difunctional [symbol] | 189 [symbol] | (A) [symbol] | A-(2) | 40 | 40 | 40 | 70 | 70 | 70 |
| resin | | Monofunctional epoxy group- | monofunctional [symbol] | 182 [symbol] | (a2) | A-(7) | 28.9 | 28.9 | 28.9 | | | |
| composition | | containing substances (a2) | | | | | | | | | | |
| | Component (A) + | Dispersion (M) in | 0.0 [symbol] | 0.0 [symbol] | (B-1) | M-(2) | 50 | 50 | 50 | 50 | 50 | 50 |
| | Component (B) | which component (B) | | | | | | | | | | |
| | | is dispersed in | | | | | | | | | | |
| | | component (A) | | | | | | | | | | |
| | Component (C) | Alicyclic amine | | | (c3) | c3-(1) | 22.5 | | | 22.5 | | |
| | | | | | | c3-(2) | | 18.8 | | | 18.8 | |
| | | | | | | c3-(3) | | | 27.8 | | | 27.8 |
| | Type of component (A) | | | | | | A [symbol] a2 | A [symbol] a2 | A [symbol] a2 | A [symbol] | A [symbol] | A [symbol] |
| | Type of component (B) | | | | | | B-1 | B-1 | B-1 | B-1 | B-1 | B-1 |
| | Type of component (C) | | | | | | c3 | c3 | c3 | c3 | c3 | c3 |
| | Molar mass of active hydrogen atom of amine in component (C)/ | | | | | | 1.00 | 1.00 | 1.00 | 1.00 | 1.00 | 1.00 |
| | Molar mass of epoxy group in component (A) | | | | | | | | | | | |
| | Amount of component (a2) in 100 parts by mass of component (A) (parts by mass) | | | | | | 29 parts | 29 parts | 29 parts | 0 parts | 0 parts | 0 parts |
| | Amount of component (B) with respect to 100 parts of component (A) (parts by mass) | | | | | | 20 parts | 20 parts | 20 parts | 20 parts | 20 parts | 20 parts |
| | Amount of component (C) with respect to 100parts of component (A) (parts by mass) | | | | | | 23 parts | 19 parts | 28 parts | 23 parts | 19 parts | 28 parts |
| Cured | K1c | | MPa m [symbol] | | | | 2.56 | 2.40 | 2.71 | 1.78 | 1.65 | 1.47 |
| product | G1c | | kJ/m² | | | | 3.66 | 3.32 | 4.48 | 1.62 | 1.58 | 1.25 |
| Composition | Component (A) | Bisphenol A epoxy resin | difunctional [symbol] | 189 [symbol] | (A) [symbol] | A-(2) | 70 | 70 | 70 | 100 | 100 | 100 |
| (M) | | Monofunctional epoxy group- | monofunctional [symbol] | 182 [symbol] | (a2) | A-(7) | 28.9 | 28.9 | 28.9 | | | |
| | | containing substances (a2) | | | | | | | | | | |

| | | | | | | | | | |
|---|---|---|---|---|---|---|---|---|---|
| Component (C) | Alicyclic amine | (c3) | c3-(1) | 22.5 | | | 22.5 | | |
| | | | c3-(2) | | 18.8 | | | 18.8 | |
| | | | c3-(3) | | | 27.8 | | | 27.8 |

| Molar mass of active hydrogen atom of amine in component (C)/ | | 1.00 | 1.00 | 1.00 | 1.00 | 1.00 | 1.00 |
|---|---|---|---|---|---|---|---|
| Molar mass of epoxy group in component (A) | | | | | | | |
| T [symbol] g (M) | °C | 102 | 105 | 103 | 142 | 140 | 146 |
| E′ (M) | MPa | 8.9 | 9.9 | 9.5 | 20.6 | 22.4 | 24.2 |
| Tmin (M) | °C | 123 | 125 | 125 | 157 | 153 | 166 |

| | | | | | | |
|---|---|---|---|---|---|---|
| [273 + Tmin (M)]/[E′ (M)] | 44 | 40 | 42 | 21 | 19 | 18 |

(+) Number of epoxy functional groups of component(A)
(++) Epoxy equivalent weight of component(A) (g/eq)
(+++) Component(A) which is neither component(a1) nor component(a2)
(*) Contained amount of epoxy group with respect to total mass of shell layer of polymer particles which are component(B) (mmol/g)
(**) % by mass of chain transfer agent in monomer mixture of core layered polymer particles which are component(B) (%)

| [symbol] | [symbol] | [symbol] | [symbol] | [symbol] | [symbol] | [symbol] | [symbol] | [symbol] |
|---|---|---|---|---|---|---|---|---|
| [symbol] urable | Component (A) | Bisphenol A epoxy resin | difunctional ⁽*⁾ | 189 ⁽**⁾ | (A) [symbol] | A-(2) | 45 | 45 |
| resin | | Monofunctional epoxy group- | monofunctional ⁽*⁾ | 182 ⁽**⁾ | (a2) | A-(7) | 24.3 | 24.3 |
| [symbol] omposition | | containing substances (a2) | | | | | | |
| | Component (A) + | Dispersion (M) in | 0.0 ⁽*⁾ | 0.4 ⁽**⁾ | (B-2) | M-(4) | 50 | |
| | Component (B) | which component (B) | 0.6 ⁽*⁾ | 0.4 ⁽**⁾ | (B-3) | M-(5) | | 50 |
| | | is dispersed in | | | | | | |
| | | component (A) | | | | | | |
| | Component (C) | Acid anhydride | | | (c1) | c1-(2) | 88 | 88 |
| | Component (D) | Curing accelerator | | | | D-(2) | 4 | 4 |
| | Type of component (A) | | | | | | A [symbol] a2 | A [symbol] a2 |
| | Type of component (B) | | | | | | B-2 | B-3 |
| | Type of component (C) | | | | | | c1 | c1 |
| | Molar mass of acid anhydride group in component (C)/ | | | | | | 1.00 | 1.00 |
| | Molar mass of epoxy group in component (A) | | | | | | | |
| | Amount of component (a2) in 100 parts by mass of component (A) (parts by mass) | | | | | | 24 parts | 24 parts |
| | Amount of component (B) with respect to 100 parts of component (A) (parts by mass) | | | | | | 20 parts | 20 parts |
| | Amount of component (C) with respect to 100 parts of component (A) (parts by mass) | | | | | | 89 parts | 89 parts |
| | Amount of component (D) with respect to 100 parts of component (A) (parts by mass) | | | | | | 4 parts | 4 parts |
| [symbol] ured | K1c | | MPa m [symbol] | | | | 2.77 | 2.60 |
| product | G1c | | kJ/m² | | | | 2.77 | 2.27 |
| Composition | Component (A) | Bisphenol A epoxy resin | difunctional ⁽*⁾ | 189 ⁽**⁾ | (A) [symbol] | A-(2) | 75 | 75 |
| [symbol] M) | | Monofunctional epoxy group- | monofunctional ⁽*⁾ | 182 ⁽**⁾ | (a2) | A-(7) | 24.3 | 24.3 |
| | | containing substances(a2) | | | | | | |

| | | | | | |
|---|---|---|---|---|---|
| Component (C) | Acid anhydride | (c1) | c1-(2) | 88 | 88 |

| | | | | |
|---|---|---|---|---|
| Component (D) | Curing accelerator | D-(2) | 4 | 4 |

| Molar mass of acid anhydride group in component (C)/ | | 1.00 | 1.00 |
|---|---|---|---|
| Molar mass of epoxy group in component (A) | | | |
| T [symbol] g (M) | °C | 109 | 109 |
| E′ (M) | MPa | 11.6 | 12.1 |
| Tmin (M) | °C | 127 | 7 |

| | | |
|---|---|---|
| [273 + Tmin (M)]/[E′ (M)] | 34 | 33 |

[symbol]

+) Number of epoxy functional groups of component(A) [symbol]
++) Epoxy equivalent weight of component(A) (g/eq) [symbol]
+++) Component(A) which is neither component(a1) nor component(a2)
(*) Contained amount of epoxy group with respect to total mass of shell layer of polymer particles which are component(B) (mmol/g)
(**) % by mass of chain transfer agent in monomer mixture of core layered polymer particles which are component(B) (%)

| [symbol] | [symbol] | [symbol] | [symbol] | [symbol] | [symbol] | [symbol] | [symbol] |
|---|---|---|---|---|---|---|---|
| Curable | Component (A) | Bisphenol A epoxy resin | difunctional ⁽*⁾ | 189 ⁽**⁾ | (A) [symbol] | A-(2) | 30 |
| resin | | Glycidyl amine type epoxy resin | tetrafunctional ⁽*⁾ | 115 ⁽**⁾ | (A) [symbol] | A-(8) | 6 |
| composition | | Monofunctional epoxy group- | monofunctional ⁽*⁾ | 182 ⁽**⁾ | (a2) | A-(7) | 28.9 |
| | | containing substances (a2) | | | | | |
| | Component (A) + | Dispersion (M) in which | 0.5 ⁽*⁾ | 0.0 ⁽**⁾ | (B-1) | M-(2) | 50 |
| | Component (B) | component (B) is | | | | | |
| | | dispersed in component (A) | | | | | |
| | Component(C) | Aromatic amide | | | (c2) | c2-(1) | 23.6 |
| | Type of component (A) | | | | | | A [symbol] a2 |
| | Type of component (B) | | | | | | B-1 |
| | Type of component (C) | | | | | | c2 |
| | Molar mass of active hydrogen atom of amine in component (C)/Molar mass of epoxy group in component (A) | | | | | | 1.00 |
| | Amount of component (a1) in 100 parts by mass of component (A) (parts by mass) | | | | | | 0 parts |
| | Amount of component (a2) in 100 parts by mass of component (A) (parts by mass) | | | | | | 30 parts |
| | Amount of glycidyl amine type epoxy resin in 100 parts by mass of component (A) (parts by mass) | | | | | | 6 parts |
| | Amount of component (B) with respect to 100 parts of component (A) (parts by mass) | | | | | | 21 parts |
| | Amount of component (C) with respect to 100 parts of component (A) (parts by mass) | | | | | | 25 parts |
| Cured | K1c | | MPa m [symbol] | | | | 2.48 |
| product | G1c | | kJ/m² | | | | 3.35 |
| Composition | Component (A) | Bisphenol A epoxy resin | difunctional ⁽*⁾ | 189 ⁽**⁾ | (A) [symbol] | A-(2) | 60 |
| (M) | | Glycidyl amine type epoxy resin | tetrafunctional ⁽*⁾ | 115 ⁽**⁾ | (A) [symbol] | A-(8) | 2 |
| | | Monofunctional epoxy group- | monofunctional ⁽*⁾ | 182 ⁽**⁾ | (a2) | A-(7) | 28.9 |
| | | containing substances (a2) | | | | | |

| | | | | |
|---|---|---|---|---|
| Component (C) | Aromatic amide | (c2) | c2-(1) | 23.6 |

| Molar mass of active hydrogen atom of amine in component (C)/Molar mass of epoxy group in component (A) | | 1.00 |
|---|---|---|
| T [symbol] g (M) | °C | 108 |
| E′ (M) | MPa | 6.8 |
| Tmin (M) | °C | 129 |

| | |
|---|---|
| [273 + Tmin (M)]/[E′ (M)] | 59 |

(+) Number of epoxy functional groups of component(A)
(++) Epoxy equivalent weight of component(A) (g/eq)
(+++) Component(A) which is neither component(a1) nor component(a2)
(*) Contained amount of epoxy group with respect to total mass of shell layer of polymer particles which are component(B) (mmol/g)
(**) % by mass of chain transfer agent in monomer mixture of core layered polymer particles which are component(B) (%)

| [symbol] | [symbol] | [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|---|
| | Component (A) | Bisphenol A epoxy resin | difunctional ⁽*⁾ | 189 ⁽**⁾ | A-(2) | 70 | 70 | 70 | 70 | 70 | 70 | 70 | 100 | 70 |
| Curable | Component (A) + | Dispersion (M) in | 0.5 ⁽*⁾ | 0.0 [symbol] | M-(2) | 50 | 50 | 50 | 50 | 50 | 50 | 50 | — | 50 |
| resin | Component (B) | which component (B) | | | | | | | | | | | | |
| composition | | is dispersed in | | | | | | | | | | | | |
| | | component (A) | | | | | | | | | | | | |
| | Component (C) | Amime (c4) | | | c4-(1) | 8.6 | 17.2 | 25.8 | 34.5 | — | — | — | 25.6 | 8.0 |
| | | | | | c4-(2) | — | — | — | — | 10.3 | 20.7 | — | — | — |
| | | Amime (c5) | | | c5-(1) | 20.9 | 13.9 | 7.0 | — | 23.7 | 19.5 | 27.8 | 7.0 | — |
| | | Component (C) other than amine (c4) and amine (c5) | | | c-(1) | — | — | — | — | — | — | — | — | 8.0 |
| | Type of component (B) | | | | | B-1 | B-1 | B-1 | B-1 | B-1 | B-1 | B-1 | B-1 | B-1 |
| | Type of component (C) | | | | | c1, c2 | c1, c2 | c1, c2 | c1 | c1, c2 | c1, c2 | c2 | c1, c2 | c1, C [symbol] |
| | Amount of component (B) with respect to 100 parts of component (A) (parts by mass) | | | | | 20 parts | 20 parts | 20 parts | 20 parts | 20 parts | 20 parts | 20 parts | 0 parts | 20 parts |
| | Amount of component (C) with respect to 100 parts of component (A) (parts by mass) | | | | | 30 parts | 31 parts | 33 parts | 35 parts | 34 parts | 40 parts | 26 parts | 33 parts | 16 parts |
| | Amount of component (c1) in 100 parts of component (C) (parts by mass) | | | | | 29 parts | 55 parts | 79 parts | 100 parts | 30 parts | 51 parts | 0 parts | 79 parts | 50 parts |
| | Amount of component (c2) in 100 parts of component (C) (parts by mass) | | | | | 71 parts | 45 parts | 21 parts | 0 parts | 70 parts | 49 parts | 100 parts | 21 parts | 0 parts |
| | Average number of active hydrogen atoms in | | | | | 3.2 | 2.7 | 2.3 | 2.0 | 2.8 | 2.1 | 4.0 | 2.3 | 3.9 |
| | amino group of component (C) per molecule | | | | | | | | | | | | | |
| Cured | K1c | | MPa m [symbol] | | | 1.62 | 2.52 | 0.00 | 3.03 | 1.68 | 2.84 | 1.46 | 1.21 | 1.18 |
| product | G1c | | kJ/m² | | | 1.85 | 4.56 | 6.87 | 7.19 | 2.12 | 5.25 | 1.24 | 0.45 | 0.80 |
| Composition | Component (A) | Bisphenol A epoxy resin | difunctional ⁽*⁾ | 180 ⁽**⁾ | A-(2) | 100 | 100 | 100 | 100 | 100 | 100 | 100 | 100 | 100 |

| | | | | | | | | | | | | |
|---|---|---|---|---|---|---|---|---|---|---|---|---|
| (M) | Component (C) | Amime (c4) | c4-(1) | 8.6 | 17.2 | 25.8 | 34.5 | — | — | — | 25.8 | 8 |
| | | | c4-(2) | — | — | — | — | 10.3 | 20.7 | — | — | — |
| | | Amime (c5) | c5-(1) | 20.9 | 13.9 | 7.0 | — | 23.7 | 19.5 | 27.8 | 7.0 | — |
| | | Component (C) other than amine (c4) and amine (c5) | c-(1) | — | — | — | — | — | — | — | — | 8 |

| | | | | | | | | | | |
|---|---|---|---|---|---|---|---|---|---|---|
| T [symbol] g (M) | °C | 121 | 90 | 69 | 56 | 125 | 96 | 147 | 69 | 121 |
| E′ (M) | MPa | 16.3 | 8.7 | 4.4 | 2.2 | 12.1 | 3.6 | 20.2 | 4.4 | 27.1 |
| Tmin (M) | °C | 137 | 109 | 94 | 81 | 145 | 123 | 166 | 94 | 137 |

| | | | | | | | | | |
|---|---|---|---|---|---|---|---|---|---|
| [273 + Tmin (M)]/[E′ (M)] | 25 | 44 | 83 | 161 | 35 | 110 | 21 | 89 | 15 |

(+) Number of epoxy functional groups of component(A)
(++) Epoxy equivalent weight of component(A) (g/eq)
(+++) Component(C) other than amine(c1) and amine(c2)
(*) Contained amount of epoxy group with respect to total mass of shell layer of polymer particles which are component(B) (mmol/g)
(**) % by mass of chain transfer agent in monomer mixture of core layered polymer particles which are component(B) (%)

| [symbol] | [symbol] | [symbol] | [symbol] | [symbol] | [symbol] | [symbol] | [symbol] | [symbol] | [symbol] | [symbol] | [symbol] | [symbol] | [symbol] |
|---|---|---|---|---|---|---|---|---|---|---|---|---|---|
| | Component (A) | Bisphenol A epoxy resin | difunctional ⁽*⁾ | 180 ⁽**⁾ | (A) [symbol] | A-(2) | 70 | 70 | 70 | 70 | 70 | 70 | 70 |
| Curable | Component (A) + | Dispersion (M) in which | 0.5 ⁽*⁾ | 0.0 [symbol] | (B-1) | M-(2) | — | — | 50 | 50 | 50 | 50 | 50 |
| resin | Component (B) | component (B) is | 0.0 ⁽*⁾ | 0.4 [symbol] | (B-2) | M-(4) | 50 | — | — | — | — | — | — |
| composition | | dispersed in component (A) | 0.6 ⁽*⁾ | 0.4 [symbol] | (B-3) | M-(5) | — | 50 | — | — | — | — | — |
| | Component (C) | Amime (c4) | | | | c4-(1) | 17.2 | 17.2 | 17.2 | — | — | — | — |
| | | | | | | c4-(3) | — | — | — | 9.5 | 19.1 | — | — |
| | | | | | | c4-(4) | — | — | — | — | — | 7.7 | 15.4 |
| | | | | | | c4-(5) | — | — | — | — | — | — | — |
| | | | | | | c4-(6) | — | — | — | — | — | — | — |
| | | | | | | c4-(7) | — | — | — | — | — | — | — |
| | | Amime (c5) | | | | c5-(1) | 13.9 | 13.9 | — | 20.9 | 13.9 | 20.9 | 13.9 |
| | | Component (C) other than amine (c4) and amine (c5) | | | | c-(2) | — | — | 25.7 | — | — | — | — |
| | Type of component (B) | | | | | | B-2 | B-3 | B-1 | B-1 | B-1 | B-1 | B-1 |
| | Type of component (C) | | | | | | c1, c2 | c1, c2 | c1, C [symbol] | c1, c2 | c1, c2 | c1, c2 | c1, c2 |
| | Amount of component (B) with respect to 100 parts of component (A) (parts by mass) | | | | | | 20 parts | 20 parts | 20 parts | 20 parts | 20 parts | 20 parts | 20 parts |
| | Amount of component (C) with respect to 100 parts of component (A) (parts by mass) | | | | | | 31 parts | 31 parts | 43 parts | 30 parts | 33 parts | 29 parts | 29 parts |
| | Amount of component (c1) in 100 parts of component (C) (parts by mass) | | | | | | 55 parts | 55 parts | 40 parts | 31 parts | 58 parts | 27 parts | 53 parts |
| | Amount of component (c2) in 100 parts of component (C) (parts by mass) | | | | | | 45 parts | 45 parts | 60 parts | 69 parts | 42 parts | 73 parts | 47 parts |
| | Average number of active hydrogen atoms in | | | | | | 2.7 | 2.7 | 2.9 | 3.2 | 2.7 | 3.2 | 2.7 |
| | amino group of component (C) per molecule | | | | | | | | | | | | |
| Cured | K1c | | MPa m [symbol] | | | | 2.96 | 2.84 | 2.20 | 1.81 | 2.64 | 1.58 | 2.33 |
| [symbol] roduct | G1c | | kJ/m² | | | | 5.74 | 4.52 | 4.17 | 2.00 | 5.47 | 1.63 | 4.09 |
| Composition | Component (A) | Bisphenol A epoxy resin | difunctional ⁽*⁾ | 180 ⁽**⁾ | (A) [symbol] | A-(2) | 100 | 100 | 100 | 100 | 100 | 100 | 100 |

| | | | | | | | | | | |
|---|---|---|---|---|---|---|---|---|---|---|
| [symbol] M) | Component (C) | Amime (c4) | c4-(1) | 17.2 | 17.2 | 17.2 | — | — | — | — |
| | | | c4-(3) | — | — | — | 9.5 | 19.1 | — | — |
| | | | c4-(4) | — | — | — | — | — | 7.7 | 15.4 |
| | | | c4-(5) | — | — | — | — | — | — | — |
| | | | c4-(6) | — | — | — | — | — | — | — |
| | | | c4-(7) | — | — | — | — | — | — | — |
| | | Amime (c5) | c5-(1) | 13.9 | 13.9 | — | 20.9 | 13.9 | 20.9 | 13.9 |
| | | Component (C) other than amine (c4) and amine (c5) | c-(2) | — | — | 25.7 | — | — | — | — |

| | | | | | | | | |
|---|---|---|---|---|---|---|---|---|
| T [symbol] g (M) | °C | 90 | 90 | 79 | 123 | 89 | 131 | 101 |
| E′ (M) | MPa | 8.7 | 8.7 | 10.8 | 16.1 | 9.2 | 18.2 | 11.2 |
| Tmin (M) | °C | 109 | 109 | 97 | 140 | 108 | 147 | 119 |

| | | | | | | | |
|---|---|---|---|---|---|---|---|
| [273 + Tmin (M)]/[E′ (M)] | 44 | 44 | 34 | 25 | 41 | 23 | 35 |

(+) Number of epoxy functional groups of component(A)
(++) Epoxy equivalent weight of component(A) (g/eq)
(+++) Component(C) other than amine(c1) and amine(c2)
(*) Contained amount of epoxy group with respect to total mass of shell layer of polymer particles which are component(B) (mmol/g)
(**) % by mass of chain transfer agent in monomer mixture of core layered polymer particles which are component(B) (%)

| [symbol] | [symbol] | [symbol] | [symbol] | [symbol] | [symbol] | [symbol] | 14D | 15D | 16D | 17D | 18D | 19D | 4D |
|---|---|---|---|---|---|---|---|---|---|---|---|---|---|
| | Component (A) | Bisphenol A epoxy resin | difunctional ⁽*⁾ | 189 [symbol] **⁾ | (A) [symbol] | A-(2) | 70 | 70 | 70 | 70 | 70 | 70 | 70 |
| [symbol] | Component (A) + | Dispersion (M) in which | 0.5 ⁽*⁾ | 0.0 [symbol] **⁾ | (B-1) | M-(2) | 50 | 50 | 50 | 50 | 50 | 50 | 50 |
| [symbol] | Component (B) | component (B) | 0.0 ⁽*⁾ | 0.4 [symbol] **⁾ | (B-2) | M-(4) | — | — | — | — | — | — | — |
| [symbol] tion | | dispersed in component (A) | 0.6 ⁽*⁾ | 0.4 [symbol] **⁾ | (B-3) | M-(5) | — | — | — | — | — | — | — |
| | Component (C) | Amime (c4) | | | | c4-(1) | — | — | — | — | — | — | — |
| | | | | | | c4-(3) | — | — | — | — | — | — | — |
| | | | | | | c4-(4) | — | — | — | — | — | — | — |
| | | | | | | c4-(5) | 7.9 | 15.7 | — | — | — | — | — |
| | | | | | | c4-(6) | — | — | 8.0 | 15.9 | — | — | — |
| | | | | | | c4-(7) | — | — | — | — | 8.0 | 13.3 | — |
| | | Amime (c5) | | | | c5-(1) | 23.7 | 19.5 | 23.7 | 19.5 | 19.5 | 13.9 | — |
| | | Component (C) other than amine (c4) and amine (c5) | | | | c-(2) | — | — | — | — | — | — | 51.3 |
| | Type of component (B) | | | | | | B-1 | B-1 | B-1 | B-1 | B-1 | B-1 | B-1 |
| | Type of component (C) | | | | | | c1, c2 | c1, c2 | c1, c2 | c1, c2 | c1, c2 | c1, c2 | C [symbol] |
| | Amount of component (B) with respect to 100 parts of component (A) (parts by mass) | | | | | | 20 parts | 20 parts | 20 parts | 20 parts | 20 parts | 20 parts | 20 parts |
| | Amount of component (C) with respect to 100 parts of component (A) (parts by mass) | | | | | | 32 parts | 35 parts | 32 parts | 35 parts | 28 parts | 27 parts | 51 parts |
| | Amount of component (c1) in 100 parts of component (C) (parts by mass) | | | | | | 25 parts | 45 parts | 25 parts | 45 parts | 29 parts | 49 parts | 0 parts |
| | Amount of component (c2) in 100 parts of component (C) (parts by mass) | | | | | | 75 parts | 55 parts | 75 parts | 55 parts | 71 parts | 51 parts | 100 parts |
| | Average number of active hydrogen atoms in | | | | | | 2.8 | 2.1 | 2.8 | 2.1 | 3.1 | 2.7 | 5.0 |
| | amino group of component (C) per molecule | | | | | | | | | | | | |
| [symbol] | K1c | | MPa m [symbol] | | | | 1.72 | 2.29 | 2.46 | 2.79 | 1.71 | 2.01 | 2.16 |
| | G1c | | kJ/m² | | | | 1.58 | 3.09 | 3.85 | 5.90 | 1.70 | 2.43 | 0.83 |
| [symbol] ition | Component (A) | Bisphenol A epoxy resin | difunctional ⁽*⁾ | 180 ⁽**⁾ | (A) [symbol] | A-(2) | 100 | 100 | 100 | 100 | 100 | 100 | 100 |

| | | | | | | | | | | |
|---|---|---|---|---|---|---|---|---|---|---|
| [symbol] | Component (C) | Amime (c4) | c4-(1) | — | — | — | — | — | — | — |
| | | | c4-(3) | — | — | — | — | — | — | — |
| | | | c4-(4) | — | — | — | — | — | — | — |
| | | | c4-(5) | 7.9 | 15.7 | — | — | — | — | — |
| | | | c4-(6) | — | — | 8.6 | 15.9 | — | — | — |
| | | | c4-(7) | — | — | — | — | 8.0 | 13.3 | — |
| | | Amime (c5) | c5-(1) | 23.7 | 19.5 | 23.7 | 19.5 | 19.5 | 13.9 | — |
| | | Component (C) other than amine (c4) and amine (c5) | c-(2) | — | — | — | — | — | — | 51.3 |

| | | | | | | | | |
|---|---|---|---|---|---|---|---|---|
| T [symbol] g (M) | °C | 134 | 110 | 109 | 85 | 138 | 125 | 121 |
| E′ (M) | MPa | 14.0 | 7.5 | 8.5 | 1.8 | 16.2 | 12.5 | 33.7 |
| Tmin (M) | °C | 151 | 134 | 131 | 126 | 154 | 142 | 141 |

| | | | | | | | |
|---|---|---|---|---|---|---|---|
| [273 + Tmin (M)]/[E′ (M)] | 30 | 54 | 47 | 222 | 26 | 33 | 121 |

[symbol]

ber of epoxy functional groups of component(A) [symbol]
oxy equivalent weight of component(A) (g/eq) [symbol]
omponent(C) other than amine(c1) and amine(c2)
(*) Contained amount of epoxy group with respect to total mass of shell layer of polymer particles which are component(B) (mmol/g)
(**) % by mass of chain transfer agent in monomer mixture of core layered polymer particles which are component(B) (%) [symbol]
indicates data missing or illegible when filed

Examples 1A to 34A are curable resin compositions satisfying the (1), and are the curable resin compositions according to one or more embodiments of the present invention. Curable resin compositions of Examples 16A, 17A, and 30A to 32A also satisfy the (2). Examples 1B to 7B are curable resin compositions satisfying the (1), and are the curable resin compositions according to one or more embodiments of the present invention. Curable resin compositions of Examples 6B and 7B also satisfy the (2). Examples 1C to 15C are curable resin compositions satisfying the (2), and are the curable resin compositions according to one or more embodiments of the present invention. Examples 1D to 19D are curable resin compositions satisfying the (3), and are the curable resin compositions according to one or more embodiments of the present invention.

According to one or more embodiments of the present invention, it is possible to provide a novel curable resin composition that can provide a cured product with excellent toughness. The cured product obtained by curing the curable resin composition according to one or more embodiments of the present invention can be suitably used as, for example, structural members and/or outer panels of aircraft, spacecraft (space vehicles), automobiles, industrial machinery, railway vehicles, ships, and the like.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. A curable resin composition comprising:
the following component (A) and component (B), and
not comprising the following component (D) or further comprising the following component (D):
component (A): an epoxy group-containing substance containing at least one type selected from the group consisting of a bisphenol A epoxy resin, a bisphenol F epoxy resin, and an alicyclic epoxy resin;
component (B): polymer particles having a core-shell structure that includes a core layer and a shell layer;
component (D): a curing accelerator,
wherein the curable resin composition satisfies at least one of the following (1) to (3):
(1):
the curable resin composition further comprises the following component (C):
component (C): an acid anhydride (c1), an aromatic amine (c2), or an alicyclic amine (c3),
in 100 parts by mass of the component (A), a total contained amount of the bisphenol A epoxy resin, the bisphenol F epoxy resin, and the alicyclic epoxy resin is 60 parts by mass to 100 parts by mass,
a contained amount of the component (B) is 1 part by mass to 100 parts by mass with respect to 100 parts by mass of the component (A),
a contained amount of the component (C) is 5 parts by mass to 200 parts by mass with respect to 100 parts by mass of the component (A),
when the curable resin composition comprises the component (D), a contained amount of the component (D) is 0.1 parts by mass to 10.0 parts by mass with respect to 100 parts by mass of the component (A), and
a value X calculated by the following formula is:
1.05 to 5.50 when the component (C) is the acid anhydride (c1), and
1.30 to 9.00 when the component (C) is the aromatic amine (c2) or the alicyclic amine (c3):
X={[273+Tmin(M)]/[273+Tmin(Meq)]}×[E′(Meq)]/[E′(M)]; formula:
(2):
the curable resin composition further comprises the following component (C):
component (C): an epoxy curing agent containing at least one type selected from the group consisting of an acid anhydride (c1), an aromatic amine (c2), and an alicyclic amine (c3),
in 100 parts by mass of the component (A), a total contained amount of the bisphenol A epoxy resin, the bisphenol F epoxy resin, and the alicyclic epoxy resin is 5 parts by mass to 100 parts by mass,
a contained amount of the component (B) is 1 part by mass to 100 parts by mass with respect to 100 parts by mass of the component (A),
a contained amount of the component (C) is 10 parts by mass to 200 parts by mass with respect to 100 parts by mass of the component (A),
when the curable resin composition comprises the component (D), a contained amount of the component (D) is 0.1 parts by mass to 10.0 parts by mass with respect to 100 parts by mass of the component (A),
the component (A) satisfies any of the following (i), (ii), or (iii):
(i) the component (A) contains a polyfunctional epoxy group-containing substance (a1) having an epoxy equivalent weight of 300 g/eq or more and less than 3000 g/eq, and having two or more epoxy groups per molecule, and a contained amount of the polyfunctional epoxy group-containing substance (a1) in 100 parts by mass of the component (A) is 5 parts by mass to 100 parts by mass;
(ii) the component (A) contains a monofunctional epoxy group-containing substance (a2) having one epoxy group per molecule, and a contained amount of the monofunctional epoxy group-containing substance (a2) in 100 parts by mass of the component (A) is 5 parts by mass to 95 parts by mass;
(iii) the component (A) contains the polyfunctional epoxy group-containing substance (a1) and the monofunctional epoxy group-containing substance (a2), and a contained amount of the polyfunctional epoxy group-containing substance (a1) in 100 parts by mass of the component (A) is 5 parts by mass to 95 parts by mass, and a contained amount of the monofunctional epoxy group-containing substance (a2) in 100 parts by mass of the component (A) is 5 parts by mass to 95 parts by mass, and
a value Y calculated by the following formula is 22 to 400:
Y=[273+Tmin(M)]/[E′(M)]; formula:
(3):
the curable resin composition further comprises the following component (C):
component (C): an amine-based epoxy curing agent containing an amine (c4) with 1 or 2 active hydrogen atoms in an amino group per molecule;
in 100 parts by mass of the component (A), a total contained amount of the bisphenol A epoxy resin, the bisphenol F epoxy resin, and the alicyclic epoxy resin is 5 parts by mass to 100 parts by mass,
a contained amount of the component (B) is 1 part by mass to 100 parts by mass with respect to 100 parts by mass of the component (A),
a contained amount of the component (C) is 10 parts by mass to 200 parts by mass with respect to 100 parts by mass of the component (A),
when the curable resin composition comprises the component (D), a contained amount of the component (D) is 0.1 parts by mass to 20.0 parts by mass with respect to 100 parts by mass of the component (A),
a contained amount of the amine (c4) in the component (C) is 5% by mass to 100% by mass in 100% by mass of the component (C), and
a value Y calculated by the following formula is 22 to 400:
Y=[273+Tmin(M)]/[E′(M)], formula:
wherein:
in the formulas for the value X and the value Y,
a temperature at which a loss tangent is maximized, as determined by dynamic viscoelastic measurement under tensile mode and at a frequency of 1 Hz using a cured product (M) of a composition (M) as a sample, is defined as Ttg(M) (°C), and the E′(M) represents a minimum value of a storage modulus (E′) in a temperature range of [Ttg(M) (°C)] to [Ttg(M)+25 (°C)] of the cured product (M), and the Tmin(M) (°C) is a temperature (°C) at which a value of the E′(M) is obtained,
the composition (M) contains the component (A), the component (C), and the component (D), which are the same as the component (A), the component (C), and the component (D) contained in the curable resin composition,
respective contained amounts of the component (A), the component (C), and the component (D) in the composition (M) are the same as respective contained amounts of the component (A), the component (C), and the component (D) in the curable resin composition,
the cured product (M) is a cured product obtained by curing the composition (M) and showing a cure degree of 98% or more as measured by DSC measurement,
in the formula for the value X,
a temperature at which a loss tangent is maximized, as determined by dynamic viscoelastic measurement under tensile mode and at a frequency of 1 Hz using a cured product (Meq) of a composition (Meq) as a sample, is defined as Ttg(Meq) (°C), and the E′(Meq) represents a minimum value of a storage modulus (E′) in a temperature range of [Ttg(Meq) (°C)] to [Ttg(Meq)+25 (°C)] of the cured product (Meq), and the Tmin(Meq) (°C) is a temperature (°C) at which a value of the E′(Meq) is obtained,
the composition (Meq) contains the component (A), the component (C), and the component (D), which are the same as the component (A), the component (C), and the component (D) contained in the curable resin composition,
respective contained amounts of the component (A) and the component (D) in the composition (Meq) are the same as respective contained amounts of the component (A) and the component (D) in the curable resin composition,
when the component (C) in the composition (Meq) is the acid anhydride (c1), a contained amount of the component (C) in the composition (Meq) is such that a ratio of a molar mass of an acid anhydride group in the component (C) to a molar mass of an epoxy group in the component (A) contained in the composition (Meq) (molar mass of acid anhydride group in the component (C)/molar mass of the epoxy group in the component (A)) is 1,
when the component (C) in the composition (Meq) is the aromatic amine (c2) or the alicyclic amine (c3), a contained amount of the component (C) in the composition (Meq) is such that a ratio of a molar mass of active hydrogen atom of an amine in the component (C) to a molar mass of an epoxy group in the component (A) contained in the composition (Meq) (molar mass of active hydrogen atom of the amine in the component (C)/molar mass of the epoxy group in the component (A)) is 1, and
the cured product (Meq) is a cured product obtained by curing the composition (Meq) and showing a cure degree of 98% or more as measured by DSC measurement.

2. The curable resin composition according to claim 1, wherein the component (B) contains at least one type of polymer particles selected from the group consisting of the following polymer particles (B-1), polymer particles (B-2), and polymer particles (B-3):
the polymer particles (B-1):
polymer particles in which the shell layer has an epoxy group, and a contained amount of the epoxy group in the shell layer with respect to a total mass of the shell layer is 0.2 mmol/g to 5.0 mmol/g;
the polymer particles (B-2):
polymer particles in which the core layer is diene-based rubber obtained by polymerizing a monomer mixture containing (b1) a conjugated diene-based monomer in an amount of 50.00% by mass to 99.99% by mass, (b2) a vinyl-based monomer that is copolymerizable with the conjugated diene-based monomer, in an amount of 0.00% by mass to 49.99% by mass, and (b3) a chain transfer agent in an amount of 0.01% by mass to 3.00% by mass, where a total of the conjugated diene-based monomer (b1), the vinyl-based monomer (b2) that is copolymerizable with the conjugated diene-based monomer, and the chain transfer agent (b3) is 100% by mass,
the polymer particles (B-3):
polymer particles in which the core layer is diene-based rubber obtained by polymerizing a monomer mixture containing (b1) a conjugated diene-based monomer in an amount of 50.00% by mass to 99.99% by mass, (b2) a vinyl-based monomer that is copolymerizable with the conjugated diene-based monomer, in an amount of 0.00% by mass to 49.99% by mass, and (b3) a chain transfer agent in an amount of 0.01% by mass to 3.00% by mass, where a total of the conjugated diene-based monomer (bi), the vinyl-based monomer (b2) that is copolymerizable with the conjugated diene-based monomer, and the chain transfer agent (b3) is 100% by mass, and the shell layer has an epoxy group, and a contained amount of the epoxy group in the shell layer with respect to a total mass of the shell layer is 0.2 mmol/g to 5.0 mmol/g.

3. The curable resin composition according to claim 1, wherein the core layer of the component (B) is butadiene rubber and/or butadiene-styrene rubber.

4. The curable resin composition according to claim 1, wherein the shell layer contains at least one type of structural unit selected from the group consisting of an aromatic vinyl-based unit, a vinyl cyanide-based unit, and a (meth)acrylate-based unit.

5. The curable resin composition according to claim 1, wherein when the curable resin composition satisfies the (1),
the component (C) is the acid anhydride (c1), and the contained amount of the component (C) in the curable resin composition is such that a ratio of a molar mass of an acid anhydride group in the component (C) to a molar mass of an epoxy group in the component (A) contained in the curable resin composition (molar mass of acid anhydride group in the component (C)/molar mass of the epoxy group in the component (A)) is 0.35 to 0.87.

6. The curable resin composition according to claim 1, wherein, when the curable resin composition satisfies the (1),
the component (C) is the aromatic amine (c2) or the alicyclic amine (c3), and the contained amount of the component (C) in the curable resin composition is such that a ratio of a molar mass of active hydrogen atom of an amine in the component (C) to a molar mass of an epoxy group in the component (A) contained in the curable resin composition (molar mass of active hydrogen atom of the amine in the component (C)/molar mass of the epoxy group in the component (A)) is 0.67 to 0.87 or 1.10 to 2.40.

7. The curable resin composition according to claim 1, wherein, when the curable resin composition satisfies the (1),
the component (C) is the aromatic amine (c2) or the alicyclic amine (c3), and the contained amount of the component (C) in the curable resin composition is such that a ratio of a molar mass of active hydrogen atom of an amine in the component (C) to a molar mass of an epoxy group in the component (A) contained in the curable resin composition (molar mass of active hydrogen atom of the amine in the component (C)/molar mass of the epoxy group in the component (A)) is 0.67 to 0.87.

8. The curable resin composition according to claim 1, wherein, when the curable resin composition satisfies the (1) and/or (2),
the component (A) further contains a glycidyl amine type epoxy resin, and in 100 parts by mass of the component (A), a contained amount of the glycidyl amine type epoxy resin is 29 parts by mass or less.

9. The curable resin composition according to claim 1, wherein, when the curable resin composition satisfies the (1),
the component (A) satisfies any of the following (i), (ii) or (iii):
(i) the component (A) contains a polyfunctional epoxy group-containing substance (a1) having an epoxy equivalent weight of 300 g/eq or more and less than 3000 g/eq, and having two or more epoxy groups per molecule, and a contained amount of the polyfunctional epoxy group-containing substance (a1) in 100 parts by mass of the component (A) is 5 parts by mass to 100 parts by mass;
(ii) the component (A) contains a monofunctional epoxy group-containing substance (a2) having one epoxy group per molecule, and a contained amount of the monofunctional epoxy group-containing substance (a2) in 100 parts by mass of the component (A) is 5 parts by mass to 40 parts by mass;
(iii) the component (A) contains the polyfunctional epoxy group-containing substance (a1) and the monofunctional epoxy group-containing substance (a2), and a contained amount of the polyfunctional epoxy group-containing substance (a1) in 100 parts by mass of the component (A) is 5 parts by mass to 95 parts by mass, and a contained amount of the monofunctional epoxy group-containing substance (a2) in 100 parts by mass of the component (A) is 5 parts by mass to 40 parts by mass.

10. The curable resin composition according to claim 1, wherein, when the curable resin composition satisfies the (3),
a number of active hydrogen atoms in an amino group of the component (C) is on average 1.5 or more and less than 3.8 per molecule.

11. A cured product obtained by curing the curable resin composition according to claim 1.

12. A laminate comprising: at least two base materials; and an adhesive layer that is for bonding the at least two base materials and that is obtained by curing an adhesive agent containing the curable resin composition according to claim 1.

13. A fiber-reinforced composite material comprising:
the curable resin composition according to claim 1; and
a fiber.

14. A wheel comprising the fiber-reinforced composite material according to claim 13.

15. A high-pressure vessel comprising the fiber-reinforced composite material according to claim 13.
